(19) United States
(12) Patent Application Publication
(10) Pub. No.: US 2025/0315285 A1
(43) Pub. Date: Oct. 9, 2025

(54) PROVIDING ASSISTANCE WITH AN EVENT THAT OCCURS IN A THREE-DIMENSIONAL SCENE

(71) Applicant: Apple Inc., Cupertino, CA (US)

(72) Inventors: Thomas G. SALTER, San Francisco, CA (US); Sachin AGARWAL, Mountain View, CA (US); Michael R. ALGER, Mountain View, CA (US); Joshua J. FROST, Aptos, CA (US); Dimitris LADOPOULOS, Sunnyvale, CA (US); Jeffrey S. NORRIS, Saratoga, CA (US); Lee SPARKS, Lake Forest, CA (US); Ravikiran VADLAPUDI, San Jose, CA (US); Christopher I. WORD, San Francisco, CA (US); In Young YANG, Kirkland, WA (US)

(21) Appl. No.: 19/169,434

(22) Filed: Apr. 3, 2025

Related U.S. Application Data
(60) Provisional application No. 63/631,270, filed on Apr. 8, 2024.
(60) Provisional application No. 63/698,471, filed on Sep. 24, 2024.

(51) Int. Cl. G06F 9/451; G06F 3/01; G06F 40/35

(52) U.S. Cl. CPC G06F 9/453; G06F 3/013; G06F 40/35

(57) ABSTRACT

An example process includes: while a computer system is present within a first scene, detecting a first gaze of a user; after a determination of semantic information about the first scene based on the detected first gaze of the user and while the computer system is present within a second scene, detecting data corresponding to the second scene; and in response to detecting the data corresponding to the second scene: in accordance with a determination that an event that occurs in the second scene is detected based on the data corresponding to the second scene and that the event satisfies a set of one or more event criteria, performing a set of one or more actions that correspond to assisting the user with the event, where a first action of the set of one or more actions is based on the semantic information about the first scene.

### CROSS-REFERENCE TO RELATED APPLICATIONS

This application claims priority to U.S. Patent Application No. 63/631,270, entitled “PROVIDING ASSISTANCE WITH AN EVENT THAT OCCURS IN A THREE-DIMENSIONAL SCENE,” filed on Apr. 8, 2024, and to U.S. Patent Application No. 63/698,471, entitled “PROVIDING ASSISTANCE WITH AN EVENT THAT OCCURS IN A THREE-DIMENSIONAL SCENE,” filed on Sep. 24, 2024. The entire contents of each of these applications are hereby incorporated by reference in their entireties.

### TECHNICAL FIELD

The present disclosure relates generally to computer systems configured to assist a user with tasks related to a three-dimensional scene in which the user and/or their avatar is present.

### BACKGROUND

The development of computer systems for interacting with and/or providing three-dimensional scenes has expanded significantly in recent years. Example three-dimensional scenes (e.g., environments) include physical scenes and extended reality scenes.

### SUMMARY

Example methods are disclosed herein. An example method includes: at a computer system that is in communication with one or more sensor devices: while the computer system is present within a first scene, detecting a first gaze of a user of the computer system; after a determination of semantic information about the first scene based on the detected first gaze of the user and while the computer system is present within a second scene, detecting, via the one or more sensor devices, data corresponding to the second scene; and in response to detecting, via the one or more sensor devices, the data corresponding to the second scene: in accordance with a determination that an event that occurs in the second scene is detected based on the data corresponding to the second scene and that the event satisfies a set of one or more event criteria, performing a set of one or more actions that correspond to assisting the user with the event, wherein a first action of the set of one or more actions is based on the semantic information about the first scene.

Example non-transitory computer-readable storage media are disclosed herein. An example non-transitory computer-readable storage medium stores one or more programs. The one or more programs are configured to be executed by one or more processors of a computer system that is in communication with one or more sensor devices. The one or more programs include instructions for: while the computer system is present within a first scene, detecting a first gaze of a user of the computer system; after a determination of semantic information about the first scene based on the detected first gaze of the user and while the computer system is present within a second scene, detecting, via the one or more sensor devices, data corresponding to the second scene; and in response to detecting, via the one or more sensor devices, the data corresponding to the second scene: in accordance with a determination that an event that occurs in the second scene is detected based on the data corresponding to the second scene and that the event satisfies a set of one or more event criteria, performing a set of one or more actions that correspond to assisting the user with the event, wherein a first action of the set of one or more actions is based on the semantic information about the first scene.

Example computer systems are disclosed herein. An example computer system is configured to communicate with one or more sensor devices. The computer system comprises: one or more processors; and memory storing one or more programs configured to be executed by the one or more processors, the one or more programs including instructions for: while the computer system is present within a first scene, detecting a first gaze of a user of the computer system; after a determination of semantic information about the first scene based on the detected first gaze of the user and while the computer system is present within a second scene, detecting, via the one or more sensor devices, data corresponding to the second scene; and in response to detecting, via the one or more sensor devices, the data corresponding to the second scene: in accordance with a determination that an event that occurs in the second scene is detected based on the data corresponding to the second scene and that the event satisfies a set of one or more event criteria, performing a set of one or more actions that correspond to assisting the user with the event, wherein a first action of the set of one or more actions is based on the semantic information about the first scene.

An example computer system is configured to communicate with one or more sensor devices. The computer system comprises: means, while the computer system is present within a first scene, for detecting a first gaze of a user of the computer system; means, after a determination of semantic information about the first scene based on the detected first gaze of the user and while the computer system is present within a second scene, for detecting, via the one or more sensor devices, data corresponding to the second scene; and means, in response to detecting, via the one or more sensor devices, the data corresponding to the second scene, for: in accordance with a determination that an event that occurs in the second scene is detected based on the data corresponding to the second scene and that the event satisfies a set of one or more event criteria, performing a set of one or more actions that correspond to assisting the user with the event, wherein a first action of the set of one or more actions is based on the semantic information about the first scene.

Performing an action to assist a user with an event based on the semantic

information and if certain conditions are met may allow a computer system to provide timely, accurate, and relevant assistance to the user. For example, as detailed herein, the computer system can intelligently provide relevant and accurate information and/or instructions to help a user handle an event that occurs in a current scene based on information determined from a previous scene. Accordingly, the techniques discussed herein may improve the efficiency, accuracy, and/or safety of a user's interactions with a scene that the user (or their avatar) is present within. In this manner, the user-computer interface is improved (e.g., by accurately providing relevant information and/or instruction to the user, by reducing the number of user inputs the computer system may otherwise receive for the user to manually obtain such information and/or instruction, and by reducing the number of user inputs otherwise required to correct incorrect actions performed by the computer system), which additionally reduces power usage and improves battery life of the computer system by enabling the user to use the computer system more quickly and efficiently.

Example methods are disclosed herein. An example method includes: at a computer system that is in communication with one or more sensor devices: detecting, via the one or more sensor devices, first data; and in response to detecting, via the one or more sensor devices, the first data and after a state of a three-dimensional (3D) scene associated with the computer system is determined based on the first data: in accordance with a determination that a computer-executable plan is generated and in accordance with a determination that the computer-executable plan satisfies a first set of criteria, wherein the computer-executable plan is generated based on: the state of the 3D scene; first action data that corresponds to a first set of instructions that are executable by the computer system; and goal data that represents a goal state of the 3D scene, and wherein the computer-executable plan corresponds to a selected subset of the first set of instructions that are executable by the computer system: executing the computer-executable plan, including executing at least a portion of the selected subset of the first set of instructions that are executable by the computer system.

Example non-transitory computer-readable storage media are disclosed herein. An example non-transitory computer-readable storage medium stores one or more programs. The one or more programs are configured to be executed by one or more processors of a computer system that is in communication with one or more sensor devices. The one or more programs include instructions for: detecting, via the one or more sensor devices, first data; and in response to detecting, via the one or more sensor devices, the first data and after a state of a three-dimensional (3D) scene associated with the computer system is determined based on the first data: in accordance with a determination that a computer-executable plan is generated and in accordance with a determination that the computer-executable plan satisfies a first set of criteria, wherein the computer-executable plan is generated based on: the state of the 3D scene; first action data that corresponds to a first set of instructions that are executable by the computer system; and goal data that represents a goal state of the 3D scene, and wherein the computer-executable plan corresponds to a selected subset of the first set of instructions that are executable by the computer system: executing the computer-executable plan, including executing at least a portion of the selected subset of the first set of instructions that are executable by the computer system.

Example computer systems are disclosed herein. An example computer system is configured to communicate with one or more sensor devices. The computer system comprises: one or more processors; and memory storing one or more programs configured to be executed by the one or more processors, the one or more programs including instructions for: detecting, via the one or more sensor devices, first data; and in response to detecting, via the one or more sensor devices, the first data and after a state of a three-dimensional (3D) scene associated with the computer system is determined based on the first data: in accordance with a determination that a computer-executable plan is generated and in accordance with a determination that the computer-executable plan satisfies a first set of criteria, wherein the computer-executable plan is generated based on: the state of the 3D scene; first action data that corresponds to a first set of instructions that are executable by the computer system; and goal data that represents a goal state of the 3D scene, and wherein the computer-executable plan corresponds to a selected subset of the first set of instructions that are executable by the computer system: executing the computer-executable plan, including executing at least a portion of the selected subset of the first set of instructions that are executable by the computer system.

An example computer system is configured to communicate with one or more sensor devices. The computer system comprises: means for detecting, via the one or more sensor devices, first data; and means, in response to detecting, via the one or more sensor devices, the first data and after a state of a three-dimensional (3D) scene associated with the computer system is determined based on the first data, for: in accordance with a determination that a computer-executable plan is generated and in accordance with a determination that the computer-executable plan satisfies a first set of criteria, wherein the computer-executable plan is generated based on: the state of the 3D scene; first action data that corresponds to a first set of instructions that are executable by the computer system; and goal data that represents a goal state of the 3D scene, and wherein the computer-executable plan corresponds to a selected subset of the first set of instructions that are executable by the computer system: executing the computer-executable plan, including executing at least a portion of the selected subset of the first set of instructions that are executable by the computer system.

Executing the computer-executable plan when certain conditions are met allows the computer system to accurately and efficiently assist a user with various tasks related to a 3D scene in which the user (or their avatar) is present. In this manner, the user-computer interface is improved (e.g., by increasing the safety of a user's interactions with a 3D scene, by accurately providing relevant information and/or instruction to the user, by reducing the number of user inputs the computer system may otherwise receive for the user to manually obtain such information and/or instruction, and by reducing the number of user inputs otherwise required to correct incorrect actions performed by the computer system), which additionally reduces power usage and improves battery life of the computer system by enabling the user to use the computer system more quickly and efficiently.

Example methods are disclosed herein. An example method includes: at a computer system that is in communication with one or more sensor devices: detecting, via the one or more sensor devices, first data; and in response to detecting, via the one or more sensor devices, the first data and after a first state of a three-dimensional (3D) scene associated with the computer system is determined based on the first data: in accordance with a determination that the determined first state of the 3D scene does not match a predicted state of the 3D scene, changing a parameter of a sensor device that is in communication with the computer system.

Example non-transitory computer-readable storage media are disclosed herein. An example non-transitory computer-readable storage medium stores one or more programs. The one or more programs are configured to be executed by one or more processors of a computer system that is in communication with one or more sensor devices. The one or more programs include instructions for: detecting, via the one or more sensor devices, first data; and in response to detecting, via the one or more sensor devices, the first data and after a first state of a three-dimensional (3D) scene associated with the computer system is determined based on the first data: in accordance with a determination that the determined first state of the 3D scene does not match a predicted state of the 3D scene, changing a parameter of a sensor device that is in communication with the computer system.

Example computer systems are disclosed herein. An example computer system is configured to communicate with one or more sensor devices. The computer system comprises: one or more processors; and memory storing one or more programs configured to be executed by the one or more processors, the one or more programs including instructions for: detecting, via the one or more sensor devices, first data; and in response to detecting, via the one or more sensor devices, the first data and after a first state of a three-dimensional (3D) scene associated with the computer system is determined based on the first data: in accordance with a determination that the determined first state of the 3D scene does not match a predicted state of the 3D scene, changing a parameter of a sensor device that is in communication with the computer system.

An example computer system is configured to communicate with one or more sensor devices. The computer system comprises: means for detecting, via the one or more sensor devices, first data; and means, in response to detecting, via the one or more sensor devices, the first data and after a first state of a three-dimensional (3D) scene associated with the computer system is determined based on the first data, for: in accordance with a determination that the determined first state of the 3D scene does not match a predicted state of the 3D scene, changing a parameter of a sensor device that is in communication with the computer system.

Changing a parameter of a sensor device when a determined state of a 3D scene does not match a predicted state of the 3D scene may allow the computer system to more accurately monitor and/or adapt the execution of a computer-executable plan that is generated to assist a user with respect to the 3D scene. Changing a parameter of a sensor device when the determined state of the 3D scene does not match the predicted state of the 3D scene may also allow the computer system to more accurately adapt to unexpected events that occur within the 3D scene, e.g., by generating a new computer-executable plan to assist the user with the unexpected event. In this manner, the user-computer interface is improved (e.g., by increasing the safety of a user interactions with a 3D scene, by accurately providing relevant information and/or instruction to the user, by reducing the number of user inputs the computer system may otherwise receive for the user to manually obtain such information and/or instruction, and by reducing the number of user inputs otherwise required to correct incorrect actions performed by the computer system), which additionally reduces power usage and improves battery life of the computer system by enabling the user to use the computer system more quickly and efficiently.

In some examples, the computer system is a desktop computer with an associated display. In some examples, the computer system is a portable device (e.g., a notebook computer, tablet computer, or handheld device such as a smartphone). In some examples, the computer system is a personal electronic device (e.g., a wearable electronic device, such as a watch or a head-mounted device). In some examples, the computer system has a touchpad. In some examples, the computer system has one or more cameras. In some examples, the computer system has a display generation component (e.g., a display device such as a head-mounted display, a display, a projector, a touch-sensitive display (also known as a “touch screen” or “touch-screen display”), or other device or component that presents visual content to a user, for example on or in the display generation component itself or produced from the display generation component and visible elsewhere). In some examples, the computer system does not have a display generation component and does not present visual content to a user. In some examples, the computer system has a touch-sensitive display (also known as a “touch screen” or “touch-screen display”). In some examples, the computer system has one or more eye-tracking components. In some examples, the computer system has one or more hand-tracking components. In some examples, the computer system has one or more output devices, the output devices including one or more tactile output generators and/or one or more audio output devices. In some examples, the computer system has one or more processors, memory, and one or more modules, programs or sets of instructions stored in the memory for performing various functions described herein. In some examples, the user interacts with the computer system through a stylus and/or finger contacts and gestures on the touch-sensitive surface, movement of the user's eyes and hand in space or the user's body as captured by cameras and other movement sensors, and/or voice inputs as captured by one or more audio input devices. Executable instructions for performing these functions are, optionally, included in a transitory and/or non-transitory computer-readable storage medium or other computer program product configured for execution by one or more processors.

Note that the various examples described above can be combined with any other examples described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described examples, reference should be made to the Detailed Description below, in conjunction with the following drawings in which like reference numerals refer to corresponding parts throughout the figures.

FIG. 1 is a block diagram illustrating an operating environment of a computer system for interacting with three-dimensional scenes, according to some examples.

FIG. 2 is a block diagram of a user-facing component of the computer system, according to some examples.

FIG. 3 is a block diagram of a controller of the computer system, according to some examples.

FIG. 4 illustrates an architecture for a foundation model, according to some examples.

FIG. 5 illustrates a block diagram of an event assistance unit of the controller, according to some examples.

FIGS. 6A-6J, 7A-7B, 8A-8B, and 9A-9G illustrate a device performing actions to assist the user with various different events that occur in three-dimensional scenes, according to some examples.

FIG. 10 is a flow diagram of a method for providing assistance with an event that occurs in a three-dimensional scene, according to some examples.

FIG. 11A illustrates a block diagram of a planning unit of the controller, according to some examples.

FIGS. 11B-11D illustrate various operations performed by the planning unit, according to some examples.

FIG. 12 illustrates a process for monitoring and adapting the execution of a plan, according to some examples.

FIGS. 13A-13B, 14A-14C, and 15A-15B illustrate the execution of various different plans that are generated to assist a user with respect to a 3D scene, according to some examples.

FIG. 16 is a flow diagram of a method for executing a plan to assist a user with respect to a 3D scene, according to some examples.

FIG. 17 is a flow diagram of a method for changing a parameter of a sensor device, according to some examples.

### DETAILED DESCRIPTION

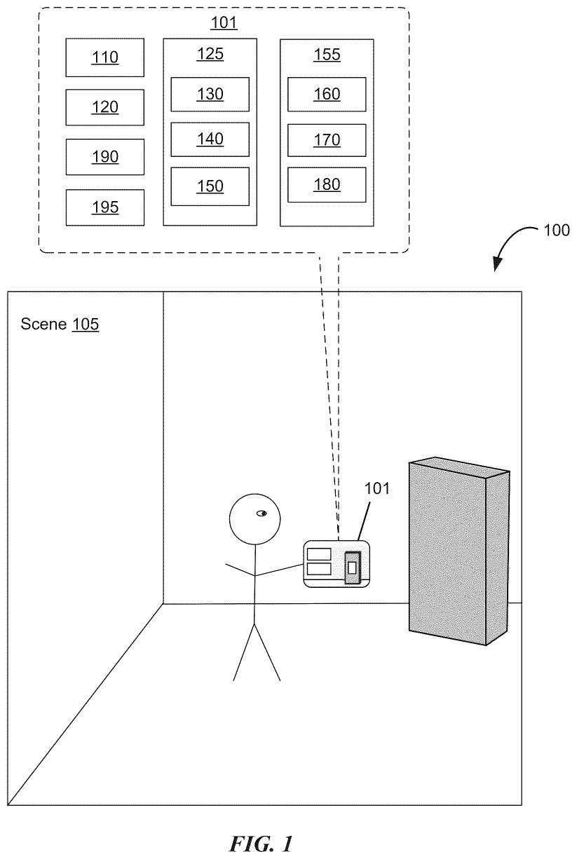

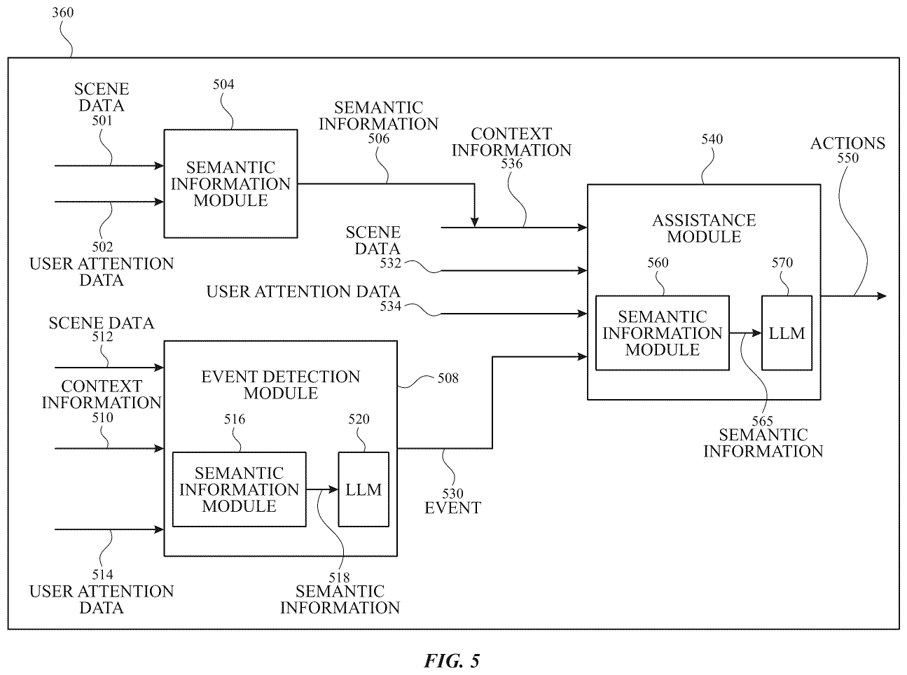

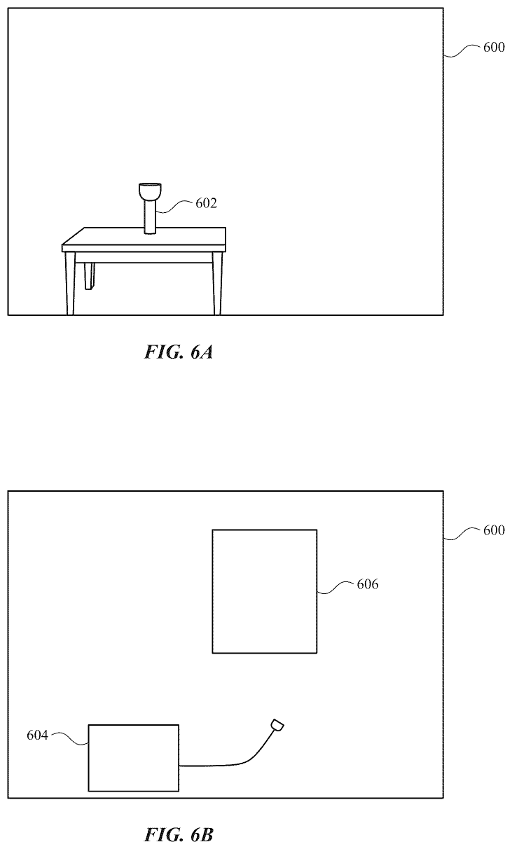

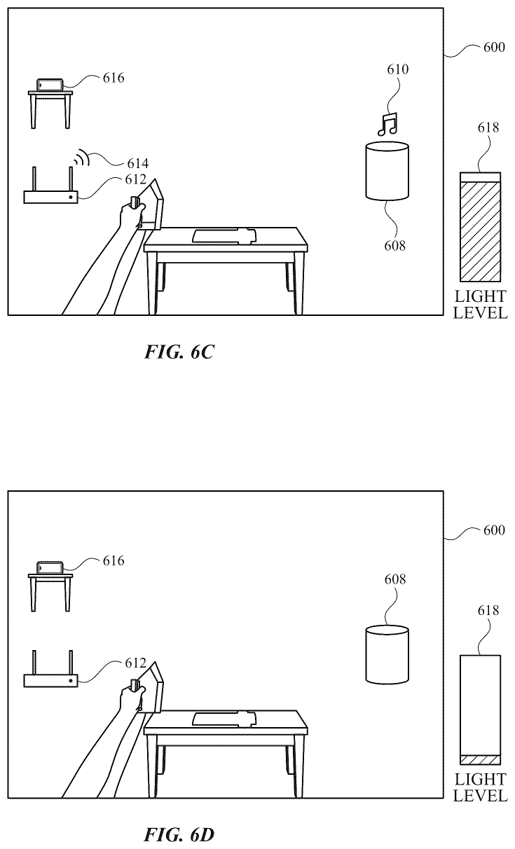

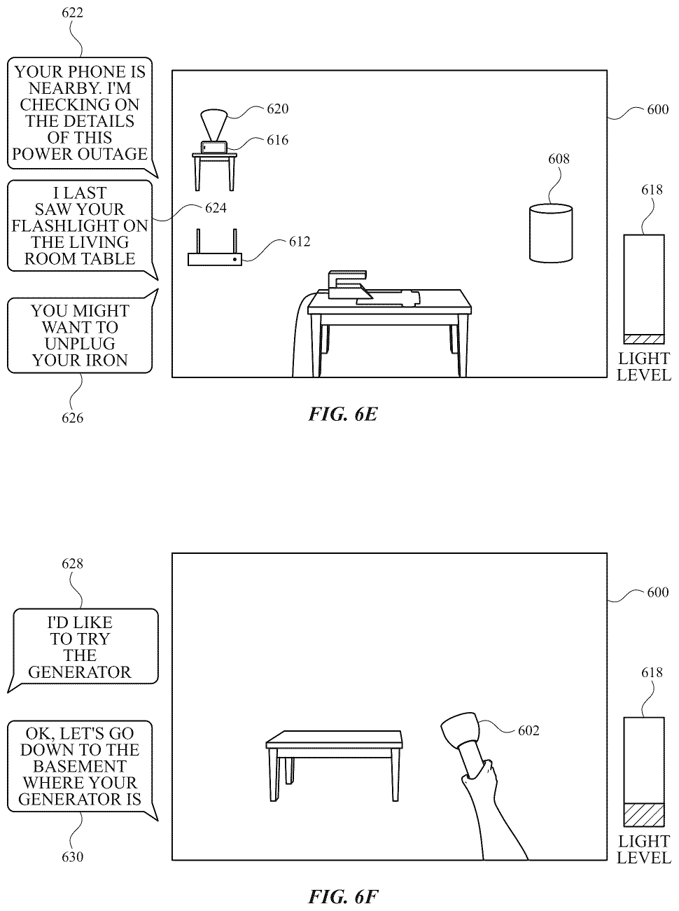

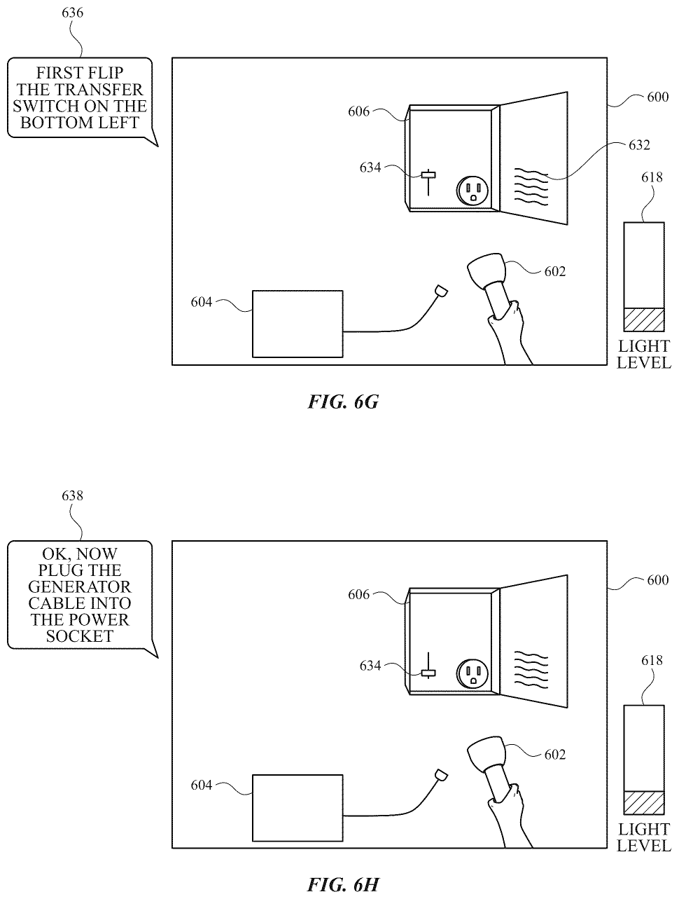

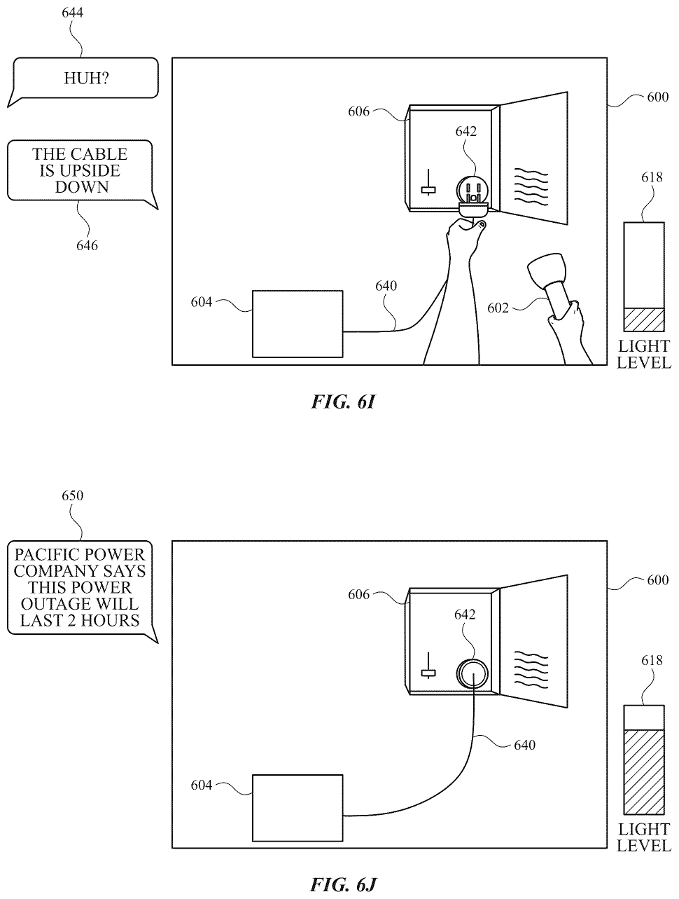

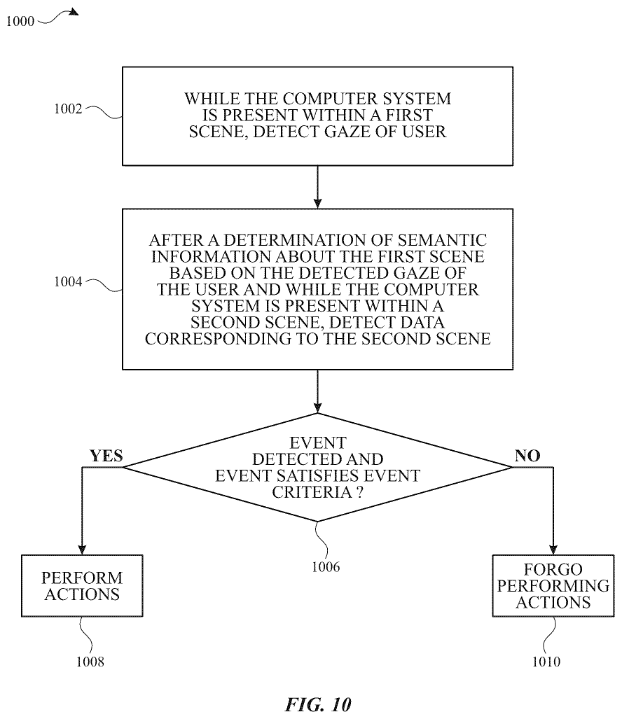

FIGS. 1-4 provide a description of example computer systems and techniques for interacting with three dimensional scenes. FIG. 5 illustrates components of a system that is configured to detect events that occur in three-dimensional scenes and to generate actions to assist the user with the detected events. FIGS. 6A-6J, 7A-7B, 8A-8B, and 9A-9G illustrate example actions performed by a device to assist the user with various different events. FIG. 10 is a flow diagram of a method for providing assistance with an event that occurs in a three-dimensional scene. FIGS. 5, 6A-6J, 7A-7B, 8A-8B, and 9A-9G are used to illustrate the processes in FIG. 10.

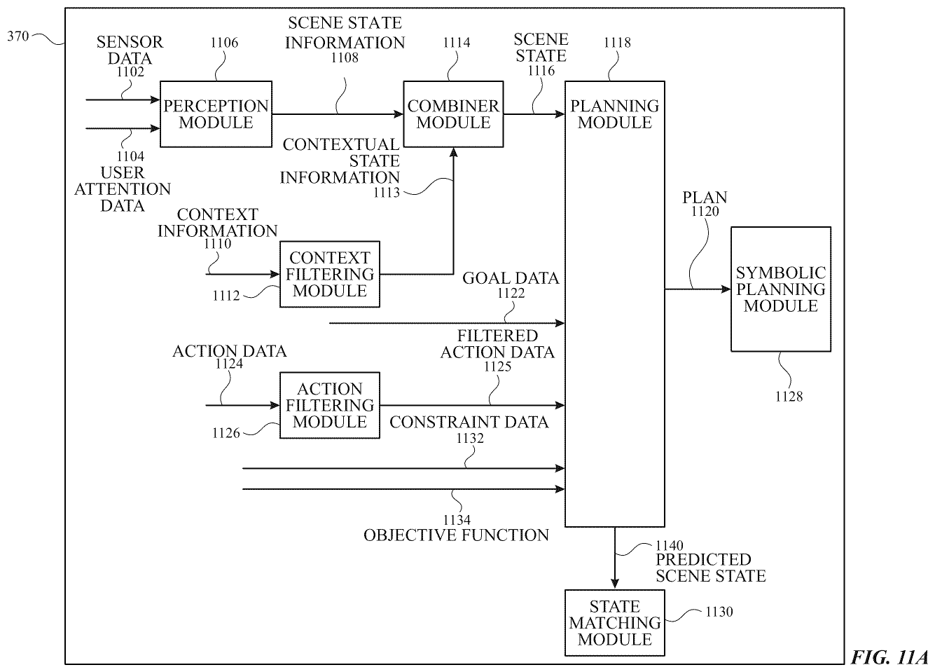

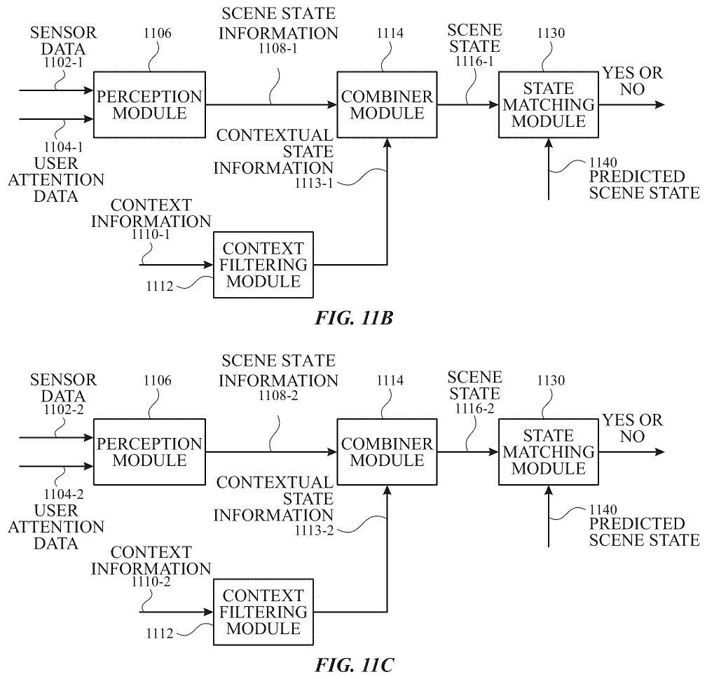

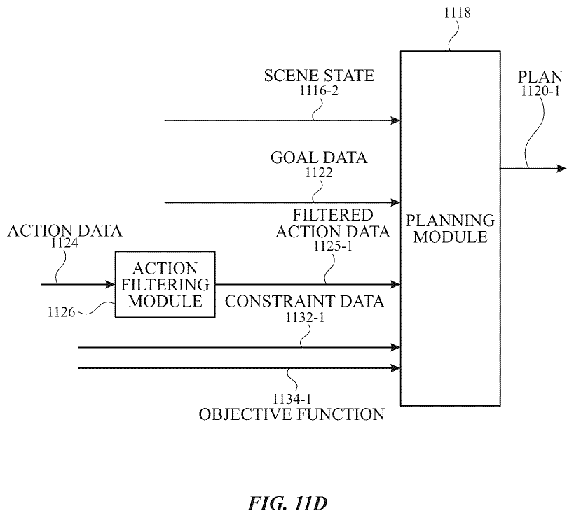

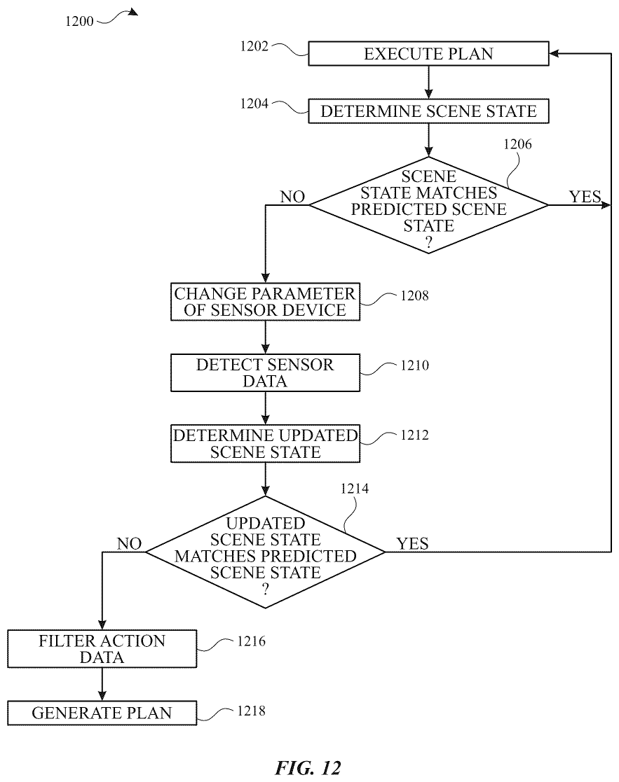

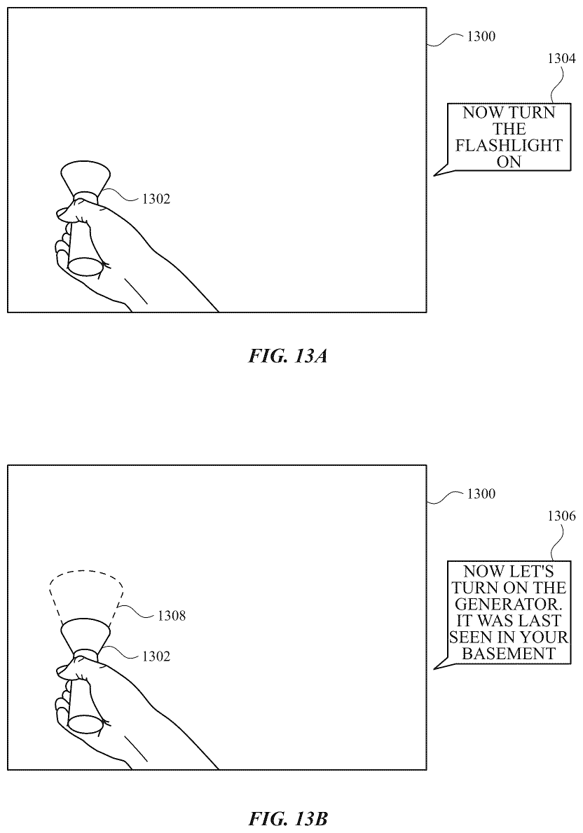

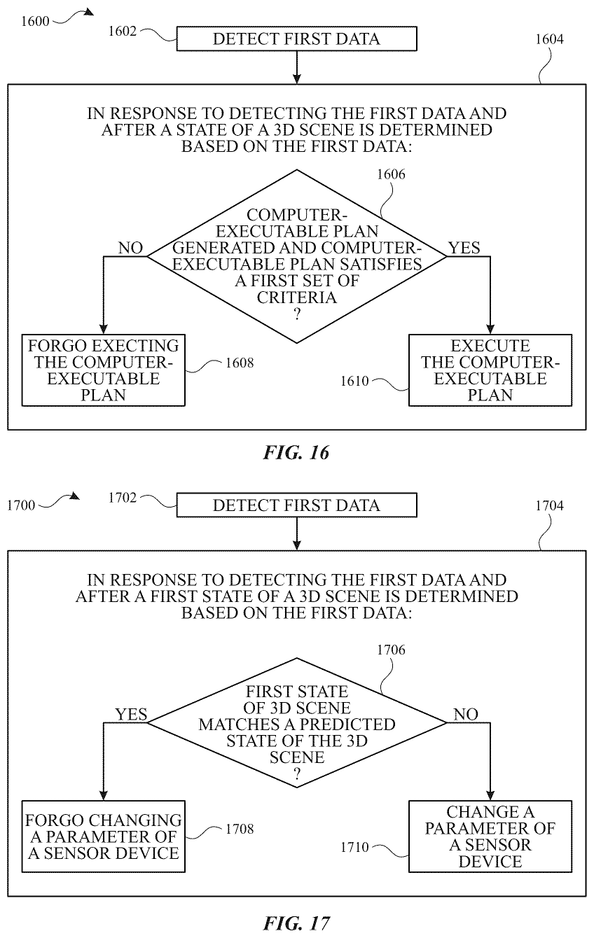

FIG. 11A illustrates a system that is configured to generate a computer-executable plan to assist a user with respect to a 3D scene. FIGS. 11B-11D illustrate various operations performed by the system of FIG. 11A. FIG. 12 illustrates a process for monitoring an adapting the execution of the computer-executable plan. FIGS. 13A-13B, 14A-14C, and 15A-15B illustrate the execution of various different computer-executable plans. FIG. 16 is a flow diagram of a method for executing a computer-executable plan to assist the user with respect to a 3D scene. FIG. 17 is a flow diagram of a method for changing a parameter of a sensor device. FIGS. 11A-11D, 12, 13A-13B, 14A-14C, and 15A-15B are used to illustrate the processes in FIGS. 16 and 17.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer-readable medium claims where the system or computer-readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer-readable storage medium can repeat the steps of a method as many times as are needed to ensure that all of the contingent steps have been performed.

FIG. 1 is a block diagram illustrating an operating environment of computer system 101 for interacting with three-dimensional scenes, according to some examples. In FIG. 1, a user interacts with three-dimensional scene 105 via operating environment 100 that includes computer system 101. In some examples, computer system 101 includes controller 110 (e.g., processors of a portable electronic device or a remote server), user-facing component 120, one or more input devices 125 (e.g., eye tracking device 130, hand tracking device 140, and/or other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, audio sensors, etc.), and one or more peripheral devices 195 (e.g., home appliances, wearable devices, etc.). In some examples, one or more of input devices 125, output devices 155, sensors 190, and peripheral devices 195 are integrated with user-facing component 120 (e.g., in a head-mounted device or a handheld device).

While pertinent features of the operating environment 100 are shown in FIG. 1, those of ordinary skill in the art will appreciate from the present disclosure that various other features have not been illustrated for the sake of brevity and so as not to obscure more pertinent aspects of the examples disclosed herein.

Hardware: There are many different types of electronic systems that enable a person to sense and/or interact with three-dimensional scenes. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may include speakers and/or other audio output devices integrated into the head-mounted system for providing audio output. A head-mounted system may have one or more speaker(s) and an integrated opaque display. Alternatively, a head-mounted system may be configured to accept an external opaque display (e.g., a smartphone). Alternatively, a head-mounted system may be configured to operate without displaying content, e.g., so that the head-mounted system provides output to a user via tactile and/or auditory means. The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one example, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

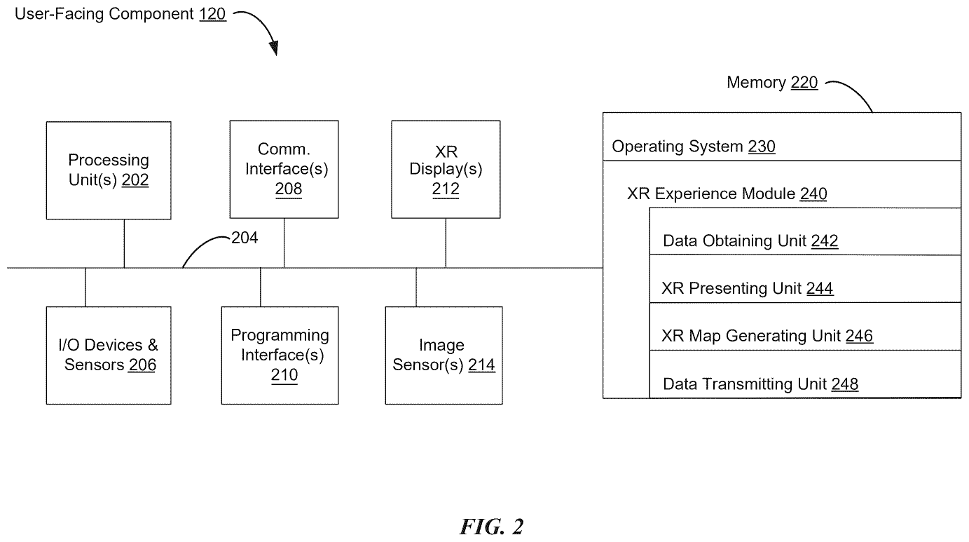

In some examples, user-facing component 120 is configured to provide a visual component of a three-dimensional scene. In some examples, user-facing component 120 includes a suitable combination of software, firmware, and/or hardware. User-facing component 120 is described in greater detail below with respect to FIG. 2. In some examples, the functionalities of controller 110 are provided by and/or combined with user-facing component 120. In some examples, user-facing component 120 provides an extended reality (XR) experience to the user while the user is virtually and/or physically present within scene 105.

In some examples, user-facing component 120 is worn on a part of the user's body (e.g., on his/her head, on his/her hand, etc.). In some examples, user-facing component 120 includes one or more XR displays provided to display the XR content. In some examples, user-facing component 120 encloses the field-of-view of the user. In some examples, user-facing component 120 is a handheld device (such as a smartphone or tablet) configured to present XR content, and the user holds the device with a display directed towards the field-of-view of the user and a camera directed towards the scene 105. In some examples, the handheld device is optionally placed within an enclosure that is worn on the head of the user. In some examples, the handheld device is optionally placed on a support (e.g., a tripod) in front of the user. In some examples, user-facing component 120 is an XR chamber, enclosure, or room configured to present XR content in which the user does not wear or hold user-facing component 120. Many user interfaces described with reference to one type of hardware for displaying XR content (e.g., a handheld device or a device on a tripod) could be implemented on another type of hardware for displaying XR content (e.g., a head-mounted device (HMD) or other wearable computing device). For example, a user interface showing interactions with XR content triggered based on interactions that happen in a space in front of a handheld or tripod-mounted device could similarly be implemented with an HMD where the interactions happen in a space in front of the HMD and the responses of the XR content are displayed via the HMD. Similarly, a user interface showing interactions with XR content triggered based on movement of a handheld or tripod-mounted device relative to the physical environment (e.g., scene 105 or a part of the user's body (e.g., the user's eye(s), head, or hand)) could similarly be implemented with an HMD where the movement is caused by movement of the HMD relative to the physical environment (e.g., scene 105 or a part of the user's body (e.g., the user's eye(s), head, or hand)).

FIG. 2 is a block diagram of user-facing component 120, according to some examples. While certain specific features are illustrated, those skilled in the art will appreciate from the present disclosure that various other features have not been illustrated for the sake of brevity, and so as not to obscure more pertinent aspects of the examples disclosed herein. Moreover, FIG. 2 is intended more as a functional description of the various features that could be present in a particular implementation, as opposed to a structural schematic of the examples described herein. As recognized by those of ordinary skill in the art, components shown separately could be combined and some components could be separated. For example, some functional modules shown separately in FIG. 2 could be implemented in a single module and the various functions of single functional blocks could be implemented by one or more functional blocks in various examples. The actual number of modules and the division of particular functions and how features are allocated among them will vary from one implementation to another and, in some examples, depends in part on the particular combination of hardware, software, and/or firmware chosen for a particular implementation.

In some examples, user-facing component 120 (e.g., HMD) includes one or more processing units 202 (e.g., microprocessors, ASICs, FPGAs, GPUs, CPUs, processing cores, and/or the like), one or more input/output (I/O) devices and sensors 206, one or more communication interfaces 208 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 210, one or more XR displays 212, one or more optional interior-and/or exterior-facing image sensors 214, a memory 220, and one or more communication buses 204 for interconnecting these and various other components.

In some examples, one or more communication buses 204 include circuitry that interconnects and controls communications between system components. In some examples, one or more I/O devices and sensors 206 include at least one of an inertial measurement unit (IMU), an accelerometer, a gyroscope, a thermometer, one or more biometric sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some examples, one or more XR displays 212 are configured to provide an XR experience to the user. In some examples, one or more XR displays 212 correspond to holographic, digital light processing (DLP), liquid-crystal display (LCD), liquid-crystal on silicon (LCoS), organic light-emitting field-effect transistor (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some examples, one or more XR displays 212 correspond to diffractive, reflective, polarized, holographic, etc. waveguide displays. For example, user-facing component 120 (e.g., HMD) includes a single XR display. In another example, user-facing component 120 includes an XR display for each eye of the user. In some examples, one or more XR displays 212 are capable of presenting XR content. In some examples, one or more XR displays 212 are omitted from user-facing component 120. For example, user-facing component 120 does not include any component that is configured to display content (or does not include any component that is configured to display XR content) and user-facing component 120 provides output via audio and/or haptic output types.

In some examples, one or more image sensors 214 are configured to obtain image data that corresponds to at least a portion of the face of the user that includes the eyes of the user (and may be referred to as an eye-tracking camera). In some examples, one or more image sensors 214 are configured to obtain image data that corresponds to at least a portion of the user's hand(s) and, optionally, arm(s) of the user (and may be referred to as a hand-tracking camera). In some examples, one or more image sensors 214 are configured to be forward-facing to obtain image data that corresponds to the scene as would be viewed by the user if user-facing component 120 (e.g., HMD) was not present (and may be referred to as a scene camera). One or more optional image sensors 214 can include one or more RGB cameras (e.g., with a complementary metal-oxide-semiconductor (CMOS) image sensor or a charge-coupled device (CCD) image sensor), one or more infrared (IR) cameras, one or more event-based cameras, and/or the like.

Memory 220 includes high-speed random-access memory, such as DRAM, SRAM, DDR RAM, or other random-access solid-state memory devices. In some examples, memory 220 includes non-volatile memory, such as one or more magnetic disk storage devices, optical disk storage devices, flash memory devices, or other non-volatile solid-state storage devices. Memory 220 optionally includes one or more storage devices remotely located from the one or more processing units 202. Memory 220 comprises a non-transitory computer-readable storage medium. In some examples, memory 220 or the non-transitory computer-readable storage medium of memory 220 stores the following programs, modules and data structures, or a subset thereof, including optional operating system 230 and XR experience module 240.

Operating system 230 includes instructions for handling various basic system services and for performing hardware dependent tasks. In some examples, XR experience module 240 is configured to present XR content to the user via one or more XR displays 212 or one or more speakers. To that end, in various examples, XR experience module 240 includes data obtaining unit 242, XR presenting unit 244, XR map generating unit 246, and data transmitting unit 248.

In some examples, data obtaining unit 242 is configured to obtain data (e.g., presentation data, interaction data, sensor data, location data, etc.) from at least controller 110 of FIG. 1. To that end, in various examples, data obtaining unit 242 includes instructions and/or logic therefor, and heuristics and metadata therefor.

In some examples, XR presenting unit 244 is configured to present XR content via one or more XR displays 212 or one or more speakers. To that end, in various examples, XR presenting unit 244 includes instructions and/or logic therefor, and heuristics and metadata therefor.

In some examples, XR map generating unit 246 is configured to generate an XR map (e.g., a 3D map of the extended reality scene or a map of the physical environment into which computer-generated objects can be placed) based on media content data. To that end, in various examples, XR map generating unit 246 includes instructions and/or logic therefor, and heuristics and metadata therefor.

In some examples, the data transmitting unit 248 is configured to transmit data (e.g., presentation data, location data, sensor data, etc.) to at least controller 110, and optionally one or more of input devices 125, output devices 155, sensors 190, and/or peripheral devices 195. To that end, in various examples, data transmitting unit 248 includes instructions and/or logic therefor, and heuristics and metadata therefor.

Although data obtaining unit 242, XR presenting unit 244, XR map generating unit 246, and data transmitting unit 248 are shown as residing on a single device (e.g., user-facing component 120 of FIG. 1), in other examples, any combination of data obtaining unit 242, XR presenting unit 244, XR map generating unit 246, and data transmitting unit 248 may reside on separate computing devices.

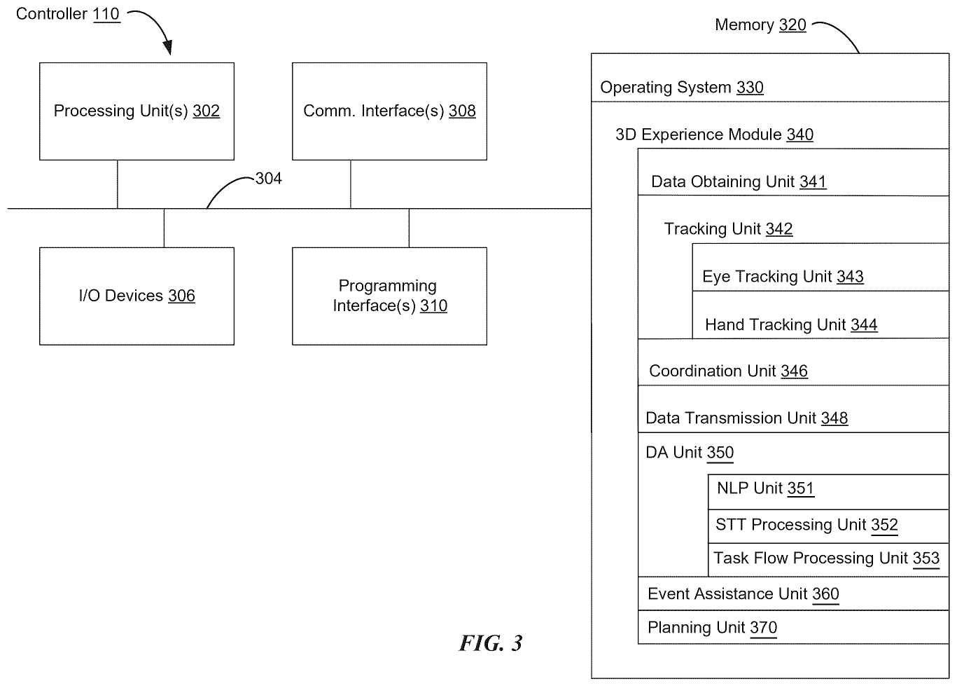

Returning to FIG. 1, controller 110 is configured to manage and coordinate a user's experience with respect to a three-dimensional scene. In some examples, controller 110 includes a suitable combination of software, firmware, and/or hardware. Controller 110 is described in greater detail below with respect to FIG. 3.

In some examples, controller 110 is a computing device that is local or remote relative to scene 105 (e.g., a physical environment). For example, controller 110 is a local server located within scene 105. In another example, controller 110 is a remote server located outside of scene 105 (e.g., a cloud server, central server, etc.). In some examples, controller 110 is communicatively coupled with the component(s) of computer system 101 that are configured to provide output to the user (e.g., output devices 155 and/or user-facing component 120) via one or more wired or wireless communication channels (e.g., BLUETOOTH, IEEE 802.11x, IEEE 802.16x, IEEE 802.3x, etc.). In some examples, controller 110 is included within the enclosure (e.g., a physical housing) of the component(s) of computer system 101 that are configured to provide output to the user (e.g., user-facing component 120) or shares the same physical enclosure or support structure with the component(s) of computer system 101 that are configured to provide output to the user.

In some examples, the various components and functions of controller 110 described below with respect to FIGS. 5, 6A-6J, 7A-7B, 8A-8B, 9A-9G, 10, 11A-11D, 12, 13A-13B, 14A-14C, 15A-15B, 16 and 17 are distributed across multiple devices. For example, a first set of the components of controller 110 (and their associated functions) are implemented on a server system remote to scene 105 while a second set of the components of controller 110 (and their associated functions) are local to scene 105. For example, the second set of components are implemented within a portable electronic device (e.g., a wearable device such as an HMD) that is present within scene 105. It will be appreciated that the particular manner in which the various components and functions of controller 110 are distributed across various devices can vary based on different implementations of the examples described herein.

FIG. 3 is a block diagram of a controller 110, according to some examples. While certain specific features are illustrated, those skilled in the art will appreciate from the present disclosure that various other features have not been illustrated for the sake of brevity, and so as not to obscure more pertinent aspects of the examples disclosed herein. Moreover, FIG. 3 is intended more as a functional description of the various features that may be present in a particular implementation, as opposed to a structural schematic of the examples described herein. As recognized by those of ordinary skill in the art, components shown separately could be combined and some components could be separated. For example, some functional modules shown separately in FIG. 3 could be implemented in a single module and the various functions of single functional blocks could be implemented by one or more functional blocks in various examples. The actual number of modules and the division of particular functions and how features are allocated among them will vary from one implementation to another and, in some examples, depends in part on the particular combination of hardware, software, and/or firmware chosen for a particular implementation.

In some examples, controller 110 includes one or more processing units 302 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 306, one or more communication interfaces 308 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 310, memory 320, and one or more communication buses 304 for interconnecting these and various other components.

In some examples, one or more communication buses 304 include circuitry that interconnects and controls communications between system components. In some examples, one or more I/O devices 306 include at least one of a keyboard, a mouse, a touchpad, a joystick, one or more microphones, one or more speakers, one or more image sensors, one or more displays, and/or the like.

Memory 320 includes high-speed random-access memory, such as dynamic random-access memory (DRAM), static random-access memory (SRAM), double-data-rate random-access memory (DDR RAM), or other random-access solid-state memory devices. In some examples, memory 320 includes non-volatile memory, such as one or more magnetic disk storage devices, optical disk storage devices, flash memory devices, or other non-volatile solid-state storage devices. Memory 320 optionally includes one or more storage devices remotely located from the one or more processing units 302. Memory 320 comprises a non-transitory computer-readable storage medium. In some examples, memory 320 or the non-transitory computer-readable storage medium of memory 320 stores the following programs, modules and data structures, or a subset thereof, including an optional operating system 330 and three-dimensional (3D) experience module 340.

Operating system 330 includes instructions for handling various basic system services and for performing hardware-dependent tasks.

In some examples, three-dimensional (3D) experience module 340 is configured to manage and coordinate the user experience provided by computer system 101 with respect to a three-dimensional scene. For example, 3D experience module 340 is configured to obtain data corresponding to the three-dimensional scene (e.g., data generated by computer system 101 and/or data from data obtaining unit 341 discussed below) to cause computer system 101 to perform actions for the user (e.g., provide suggestions, display content, etc.) based on the data. To that end, in various examples, 3D experience module 340 includes data obtaining unit 341, tracking unit 342, coordination unit 346, data transmitting unit 348, digital assistant (DA) unit 350, event assistance unit 360, and planning unit 370.

In some examples, data obtaining unit 341 is configured to obtain data (e.g., presentation data, interaction data, sensor data, location data, etc.) from one or more of user-facing component 120, input devices 125, output devices 155, sensors 190, and peripheral devices 195. To that end, in various examples, data obtaining unit 341 includes instructions and/or logic therefor, and heuristics and metadata therefor.

In some examples, tracking unit 342 is configured to map scene 105 and to track the position/location of the user (and/or of a portable device being held or worn by the user). To that end, in various examples, tracking unit 342 includes instructions and/or logic therefor, and heuristics and metadata therefor.

In some examples, tracking unit 342 includes eye tracking unit 343. Eye tracking unit 343 includes instructions and/or logic for tracking the position and movement of the user's gaze (or more broadly, the user's eyes, face, or head) using data obtained from eye tracking device 130. In some examples, eye tracking unit 343 tracks the position and movement of the user's gaze relative to a physical environment, relative to the user (e.g., the user's hand, face, or head), relative to a device worn or held by the user, and/or relative to content displayed by user-facing component 120.

Eye tracking device 130 is controlled by eye tracking unit 343 and includes various hardware and/or software components configured to perform eye tracking techniques. For example, eye tracking device 130 includes at least one eye tracking camera (e.g., infrared (IR) or near-IR (NIR) cameras) and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards mirrors that reflect IR or NIR light from the eyes to the eye tracking cameras. Eye tracking device 130 optionally captures images of the user's eyes (e.g., as a video stream captured at 60-120 frames per second), analyzes the images to generate eye tracking information, and communicates the eye tracking information to eye tracking unit 343. In some examples, two eyes of the user are separately tracked by respective eye tracking cameras and illumination sources. In some examples, only one eye of the user is tracked by a respective eye tracking camera and illumination sources.

In some examples, tracking unit 342 includes hand tracking unit 344. Hand tracking unit 344 includes instructions and/or logic for tracking, using hand tracking data obtained from hand tracking device 140, the position of one or more portions of the user's hands and/or motions of one or more portions of the user's hands. Hand tracking unit 344 tracks the position and/or motion relative to scene 105, relative to the user (e.g., the user's head, face, or eyes), relative to a device worn or held by the user, relative to content displayed by user-facing component 120, and/or relative to a coordinate system defined relative to the user's hand. In some examples, hand tracking unit 344 analyzes the hand tracking data to identify a hand gesture (e.g., a gesture that optionally does not contact any component of computer system 101, such as a grabbing gesture, a pinching gesture, or a pointing gesture) and/or to identify content (e.g., physical content or virtual content) corresponding to the hand gesture, e.g., content selected by the hand gesture.

Hand tracking device 140 is controlled by hand tracking unit 344 and includes various hardware and/or software components configured to perform hand tracking and hand gesture recognition techniques. For example, hand tracking device 140 includes one or more image sensors (e.g., one or more IR cameras, 3D cameras, depth cameras, and/or color cameras, etc.) that capture three-dimensional information (e.g., a depth map) that represents a hand of a human user. The one or more image sensors capture the hand images with sufficient resolution to distinguish the fingers and their respective positions. In some examples, the one or more image sensors project a pattern of spots onto an environment that includes the hand and capture an image of the projected pattern. In some examples, the one or more image sensors capture a temporal sequence of the hand tracking data (e.g., captured three-dimensional information and/or captured images of the projected pattern) and hand tracking device 140 communicates the temporal sequence of the hand tracking data to hand tracking unit 344 for further analysis, e.g., to identify hand gestures, hand poses, and/or hand movements.

In some examples, hand tracking device 140 includes one or more hardware input devices configured to be worn and/or held by (or be otherwise attached to) one or more respective hands of the user. In such examples, hand tracking unit 344 tracks the position, pose, and/or motion of a user's hand based on tracking the position, pose, and/or motion of the respective hardware input device. Hand tracking unit 344 tracks the position, pose, and/or motion of the respective hardware input device optically (e.g., via one or more image sensors) and/or based on data obtained from sensor(s) (e.g., accelerometer(s), magnetometer(s), gyroscope(s), inertial measurement unit(s), and the like) contained within the hardware input device. In some examples, the hardware input device includes one or more physical controls (e.g., button(s), touch sensitive surface(s), pressure sensitive surface(s), knob(s), joystick(s), and the like). In some examples, instead of, or in addition to, performing a particular function in response to detecting a respective type of hand gesture, computer system 101 analogously performs the particular function in response to a user input that selects a respective physical control of the hardware input device. For example, computer system 101 interprets a pinching hand gesture input as a selection of an in-focus element and/or interprets selection of a physical button of the hardware device as a selection of the in-focus element.

In some examples, coordination unit 346 is configured to manage and coordinate the experience provided to the user via user-facing component 120, one or more output devices 155, and/or one or more peripheral devices 195. To that end, in various examples, coordination unit 346 includes instructions and/or logic therefor, and heuristics and metadata therefor.

In some examples, data transmitting unit 348 is configured to transmit data (e.g., presentation data, location data, etc.) to user-facing component 120, one or more input devices 125, output devices 155, sensors 190, and/or peripheral devices 195. To that end, in various examples, the data transmitting unit 348 includes instructions and/or logic therefor, and heuristics and metadata therefor.

Digital assistant (DA) unit 350 includes instructions and/or logic for providing DA functionality to computer system 101. DA unit 350 therefore provides a user of computer system 101 with DA functionality while they and/or their avatar are present in a three-dimensional scene. For example, the DA performs various tasks related to the three-dimensional scene, either proactively or upon request from the user. In some examples, DA unit 350 performs at least some of: converting speech input into text (e.g., using speech-to-text (STT) processing unit 352); identifying a user's intent expressed in a natural language input received from the user; actively eliciting and obtaining information needed to fully satisfy the user's intent (e.g., by disambiguating terms in the natural language input and/or by obtaining information from data obtaining unit 341); determining a task flow for fulfilling the identified intent; and executing the task flow to fulfill the identified intent.

In some examples, DA unit 350 includes natural language processing (NLP) unit 351 configured to identify the user intent. NLP unit 351 takes the n-best candidate text representation(s) (word sequence(s) or token sequence(s)) generated by STT processing unit 352 and attempts to associate each of the candidate text representations with one or more “actionable intents” recognized by the DA. An “actionable intent” (or “user intent”) represents a task that can be performed by the DA and has an associated task flow implemented in task flow processing unit 353. The associated task flow is a series of programmed actions and steps that the DA takes in order to perform the task. The scope of a DA's capabilities is, in some examples, dependent on the number and variety of task flows that are implemented in task flow processing unit 353, or in other words, on the number and variety of “actionable intents” the DA recognizes.

In some examples, once NLP unit 351 identifies an actionable intent based on the user request, NLP unit 351 causes task flow processing unit 353 to perform the actions required to satisfy the user request. For example, task flow processing unit 353 executes the task flow corresponding to the identified actionable intent to perform a task to satisfy the user request. In some examples, performing the task includes causing computer system 101 to provide output (e.g., graphical, audio, and/or haptic output) indicating the performed task.

In some examples, 3D experience module 340 accesses one or more artificial intelligence (AI) models that are configured to perform various functions described herein. The AI model(s) are at least partially implemented on controller 110 (e.g., locally on a single device, or in a distributed manner) and/or controller 110 communicates with one or more external services that provide access to the AI model(s). In some examples, one or more components and functions of DA unit 350 event assistance unit 360, and/or planning unit 370 are implemented using the AI model(s). For example, speech-to-text processing unit 352 and natural language processing unit 351 implement separate respective AI models to facilitate and/or perform speech recognition and natural language processing, respectively. Event assistance unit 360 is discussed in greater detail below with respect to FIG. 5 and planning unit 370 is discussed in greater detail below with respect to FIGS. 11A-11D.

In some examples, the AI model(s) are based on (e.g., are, or are constructed from) one or more foundation models. Generally, a foundation model is a deep learning neural network that is trained based on a large training dataset and that can adapt to perform a specific function. Accordingly, a foundation model aggregates information learned from a large (and optionally, multimodal) dataset and can adapt to (e.g., be fine-tuned to) perform various downstream tasks that the foundation model may not have been originally designed to perform. Examples of such tasks include language translation, speech recognition, natural language processing, sentiment analysis, computer vision tasks (e.g., object recognition and scene understanding), question answering, image generation, audio generation, and generation of computer-executable instructions. Foundation models can accept a single type of input (e.g., text data) or accept multimodal input, such as two or more of text data, image data, video data, audio data, sensor data, and the like. In some examples, a foundation model is prompted to perform a particular task by providing it with a natural language description of the task. Example foundation models include the GPT-n series of models (e.g., GPT-1, GPT-2, GPT-3, and GPT-4), DALL-E, and CLIP from Open AI, Inc., Florence and Florence-2 from Microsoft Corporation, BERT from Google LLC, and LLaMA, LLAMA-2, and LLAMA-3 from Meta Platforms, Inc.

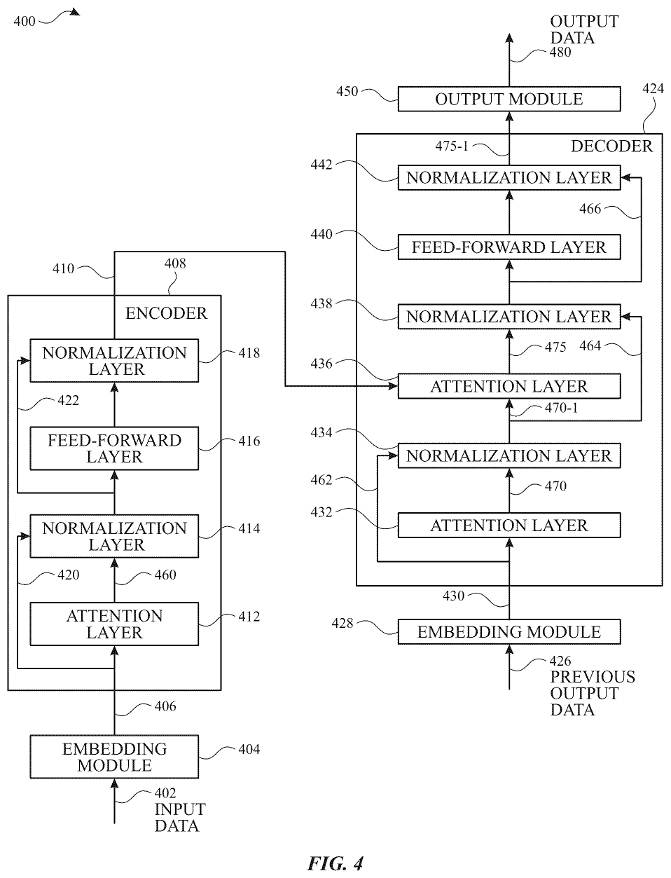

FIG. 4 illustrates architecture 400 for a foundation model, according to some examples. Architecture 400 is merely exemplary and various modifications to architecture 400 are possible. Accordingly, the components of architecture 400 (and their associated functions) can be combined, the order of the components (and their associated functions) can be changed, components of architecture 400 can be removed, and other components can be added to architecture 400. Further, while architecture 400 is transformer-based, one of skill in the art will understand that architecture 400 can additionally or alternatively implement other types of machine learning models, such as convolutional neural network (CNN)-based models and recurrent neural network (RNN)-based models.

Architecture 400 is configured to process input data 402 to generate output data 480 that corresponds to a desired task. Input data 402 includes one or more types of data, e.g., text data, image data, video data, audio data, sensor (e.g., motion sensor, biometric sensor, temperature sensor, and the like) data, computer-executable instructions, structured data (e.g., in the form of an XML file, a JSON file, or another file type), and the like. In some examples, input data 402 includes data from data obtaining unit 341. Output data 480 includes one or more types of data that depend on the task to be performed. For example, output data 480 includes one or more of: text data, image data, audio data, and computer-executable instructions. It will be appreciated that the above-described input and output data types are merely exemplary and that architecture 400 can be configured to accept various types of data as input and generate various types of data as output. Such data types can vary based on the particular function the foundation model is configured to perform.

Architecture 400 includes embedding module 404, encoder 408, embedding module 428, decoder 424, and output module 450, the functions of which are now discussed below.

Embedding module 404 is configured to accept input data 402 and parse input data 402 into one or more token sequences. Embedding module 404 is further configured to determine an embedding (e.g., a vector representation) of each token that represents each token in embedding space, e.g., so that similar tokens have a closer distance in embedding space and dissimilar tokens have a further distance. In some examples, embedding module 404 includes a positional encoder configured to encode positional information into the embeddings. The respective positional information for an embedding indicates the embedding's relative position in the sequence. Embedding module 404 is configured to output embedding data 406 of the input data by aggregating the embeddings for the tokens of input data 402.

Encoder 408 is configured to map embedding data 406 into encoder representation 410. Encoder representation 410 represents contextual information for each token that indicates learned information about how each token relates to (e.g., attends to) each other token. Encoder 408 includes attention layer 412, feed forward layer 416, normalization layers 414 and 418, and residual connections 420 and 422. In some examples, attention layer 412 applies a self-attention mechanism on embedding data 406 to calculate an attention representation (e.g., in the form of a matrix) of the relationship of each token to each other token in the sequence. In some examples, attention layer 412 is multi-headed to calculate multiple different attention representations of the relationship of each token to each other token, where each different representation indicates a different learned property of the token sequence. Attention layer 412 is configured to aggregate the attention representations to output attention data 460 indicating the cross-relationships between the tokens from input data 402. In some examples, attention layer 412 further masks attention data 460 to suppress data representing the relationships between select tokens. Encoder 408 then passes (optionally masked) attention data 460 through normalization layer 414, feed-forward layer 416, and normalization layer 418 to generate encoder representation 410. Residual connections 420 and 422 can help stabilize and shorten the training and/or inference process by respectively allowing the output of embedding module 404 (i.e., embedding data 406) to directly pass to normalization layer 414 and allowing the output of normalization layer 414 to directly pass to normalization layer 418.

While FIG. 4 illustrates that architecture 400 includes a single encoder 408, in other examples, architecture 400 includes multiple stacked encoders configured to output encoder representation 410. Each of the stacked encoders can generate different attention data, which may allow architecture 400 to learn different types of cross-relationships between the tokens and generate output data 410 data based on a more complete set of learned relationships.

Decoder 424 is configured to accept encoder representation 410 and previous output embedding 430 as input to generate output data 480. Embedding module 428 is configured to generate previous output embedding 430. Embedding module 428 is similar to embedding module 404. Specifically, embedding module 428 tokenizes previous output data 426 (e.g., output data 480 that was generated by the previous iteration), determines embeddings for each token, and optionally encodes positional information into each embedding to generate previous output embedding 430.

Decoder 424 includes attention layers 432 and 436, normalization layers 434, 438, and 442, feed-forward layer 440, and residual connections 462, 464, and 466. Attention layer 432 is configured to output attention data 470 indicating the cross-relationships between the tokens from previous output data 426. Attention layer 432 is similar to attention layer 412. For example, attention layer 432 applies a multi-headed self-attention mechanism on previous output embedding 430 and optionally masks attention data 470 to suppress data representing the relationships between select tokens (e.g., the relationship(s) between a token and future token(s)) so architecture 400 does not consider future tokens as context when generating output data 480. Decoder 424 then passes (optionally masked) attention data 470 through normalization layer 434 to generate normalized attention data 470-1.

Attention layer 436 accepts encoder representation 410 and normalized attention data 470-1 as input to generate encoder-decoder attention data 475. Encoder-decoder attention data 475 correlates input data 402 to previous output data 426 by representing the relationship between the output of encoder 408 and the previous output of decoder 424. Attention layer 436 allows decoder 424 to increase the weight of the portions of encoder representation 410 that are learned as more relevant to generating output data 480. In some examples, attention layer 436 applies a multi-headed attention mechanism to encoder representation 410 and to normalized attention data 470-1 to generate encoder-decoder attention data 475. In some examples, attention layer 436 further masks encoder-decoder attention data 475 to suppress the cross-relationships between select tokens.

Decoder 424 then passes (optionally masked) encoder-decoder attention data 475 through normalization layer 438, feed-forward layer 440, and normalization layer 442 to generate further processed encoder-decoder attention data 475-1. Normalization layer 442 then provides further-processed encoder-decoder attention data 475-1 to output module 450. Similar to residual connections 420 and 422, residual connections 462, 464, and 466 may stabilize and shorten the training and/or inference process by allowing the output of a corresponding component to directly pass as input to a corresponding component.

While FIG. 4 illustrates that architecture 400 includes a single decoder 424, in other examples, architecture 400 includes multiple stacked decoders each configured to learn/generate different types of encoder-decoder attention data 475. This allows architecture 400 to learn different types of cross-relationships between the tokens from input data 402 and the tokens from output data 480, which may allow architecture 400 to generate output data 480 based on a more complete set of learned relationships.

Output module 450 is configured to generate output data 480 from further-processed encoder-decoder attention data 475-1. For example, output module 450 includes one or more linear layers that apply a learned linear transformation to further-processed encoder-decoder attention data 475-1 and a softmax layer that generates a probability distribution over the possible classes (e.g., words or symbols) of the output tokens based on the linear transformation data. Output module 450 then selects (e.g., predicts) an element of output data 480 based on the probability distribution. Architecture 400 then passes output data 480 as previous input data 426 to embedding module 428 to begin another iteration of the training and/or inference process for architecture 400.

It will be appreciated that various different AI models can be constructed based on the components of architecture 400. For example, some large language models (LLMs) (e.g., GPT-2 and GPT-3) are decoder-only (e.g., include one or more instances of decoder 424 and do not include encoder 408), some LLMs (e.g., BERT) are encoder-only (include one or more instances of encoder 408 and do not include decoder 424), and other foundation models (e.g., Florence-2) are encoder-decoder (e.g., include one or more instances of encoder 408 and include one or more instances of decoder 424). Further, it will be appreciated that the foundation models constructed based on the components of architecture 400 can be fine-tuned based on reinforcement learning techniques and training data specific to a particular task for optimization for the particular task, e.g., extracting relevant semantic information from image and/or video data, generating code, generating music, providing suggestions relevant to a specific user, and the like.

Returning to FIG. 3, event assistance unit 360 is configured to detect an event that occurs in a three-dimensional scene and to cause computer system 101 to perform a set of actions to assist the user with the event. Event assistance unit 360 is now described in detail below with respect to FIGS. 5, 6A-6J, 7A-7B, 8A-8B, and 9A-9G.

FIG. 5 illustrates a block diagram of event assistance unit 360, according to some examples. FIG. 5 is merely exemplary and various modifications to event assistance unit 360 are possible. Accordingly, the components of event assistance unit 360 (and their associated functions) can be combined, the order of the components (and their associated functions) can be changed, components of event assistance unit 360 can be removed, and other components can be added to event assistance unit 360.

Event assistance unit 360 includes semantic information module 504, event detection module 508, and assistance module 540. In some examples, the components and functions of event assistance unit 360 are implemented based on the techniques described above with respect to FIG. 4. For example, each of semantic information module 504, event detection module 508, and assistance module 540 implement one or more respective AI-based models that are configured to concurrently process their respective input(s) to generate their respective output, i.e., semantic information 506, event 530, and set of actions 550. The respective AI-based model(s) are optionally constructed based on a foundation model that has been fine-tuned for the respective task.

Semantic information module 504 is configured to determine semantic information 506 about a three-dimensional scene (e.g., a physical scene or an extended reality scene) based on at least scene data 501 corresponding to the scene. Scene data 501 (and similarly scene data 512 and scene data 532) includes data detected and/or generated with respect to a particular scene. For example, scene data 501 includes at least some of: an image of the scene, a video of the scene, audio data for audio present in the scene (e.g., audio spoken by the user and/or audio from other sources within the scene), display data for displayed components of the scene, motion data that describes the motion of a user and/or a device present in the scene, light data describing the lighting level of the scene, temperature data describing the temperature of the scene, and the like. Accordingly, in some examples, scene data 501 includes at least some of the data obtained by data obtaining unit 341. In some examples, computer system 101 obtains at least a portion of scene data 501 for a particular scene while the user (and/or at least a portion of computer system 101) are present within the particular scene. In some examples, computer system 101 generates at least a portion of scene data 501 for a virtual reality scene within which an avatar of the user is present.

In some examples, semantic information module 504 further determines semantic information 506 about a scene based on user attention data 502. User attention data 502 (and similarly user attention data 514, 534, and 1104 (FIG. 11A)) includes information about the portion of a respective scene that the user is considered to pay attention to. In some examples, the user is considered to pay attention to a portion of the respective scene based on detection of the user's gaze at the portion of the respective scene. Accordingly, in some examples, user attention data 502 (and similarly user attention data 514, 534, and 1104) includes gaze data, e.g., from eye tracking unit 343. The gaze data includes information about a user's gaze with respect to the scene, such as the portion(s) of the scene the user gazes at, the respective duration of the user's gaze at various portion(s) of the scene, gaze direction, and/or gaze depth. In some examples, the user is considered to pay attention to a portion of the respective scene based on the portion being in the field of view of the user. Accordingly, in some examples, user attention data 502 (and similarly user attention data 514, 534, and 1104) includes directional and/or positional information that defines the portion of the respective scene that is within the user's field of view. In some examples, the user is considered to pay attention to a portion of the respective scene based on the portion being in front of the user. Accordingly, in some examples, user attention data 502 (and similarly user attention data 514, 534, and 1104) includes directional and/or positional information that defines the portion of the respective scene that is considered to be in front of the user (e.g., a predefined subset of the user's field of view of the respective scene). Thus, in examples where computer system 101 has limited or no gaze tracking capability (e.g., does not include eye tracking unit 343 and/or eye tracking device 130), computer system 101 can still detect the user's attention based on directional and/or positional information that defines the user's field of view, or that defines the portion of the user's field of view that is considered to be in front of the user.

In some examples, semantic information module 504 processes user attention data 502 in conjunction with scene data 501 to determine semantic information 506 about the scene. For example, semantic information module 504 determines semantic information 506 for the portion of the scene that the user pays attention to (e.g., to identify objects that are gazed at) (e.g., without determining semantic information for the portion of the scene that the user does not pay attention to), defines an area/volume of the scene based on the user's attention and determines semantic information 506 for the defined area/volume (e.g., to identify objects within that area or volume), and/or applies greater processing resources to determine semantic information 506 for the portion of the scene that the user pays attention to, e.g., as compared to the portion of the scene that the user does not pay attention to.

Semantic information 506 (and similarly semantic information 518 and 565) about a scene includes various information for describing the scene. For example, semantic information 506 corresponds to a visual understanding (that is optionally user attention-based) of the scene. In some examples, semantic information 506 includes a natural language description of the scene e.g., “a peaceful morning at an alpine lake,” “a fire in the kitchen and the user is gazing at the fire extinguisher,” “a loud and busy city with pedestrians and cars,” “the living room of a user's house with a flashlight on the center table,” or “bottles of various liquors in the user's field of view.” In some examples, semantic information 506 includes an identity of an object (e.g., a physical or virtual object) present within the scene. In some examples, semantic information 506 includes a state of the object, e.g., that describes a value for a parameter of the object (e.g., type, brand, version, temperature, volume, elevation, orientation, power status, speed, battery level, and/or appearance). In some examples, semantic information 506 includes a location of the object, e.g., the geographic location of the object and/or the location of the object relative to one or more other objects in the scene.

In some examples, semantic information module 504 causes computer system 101 to initiate a semantic information enrollment process to obtain semantic information 506. In some examples, the semantic information enrollment process occurs at least partially on the user device (e.g., user-facing component 120) that provides output(s) to assist the user with a detected event. During an example semantic information enrollment process, the user device (e.g., an HMD) provides outputs to prompt the user to move the user device to obtain scene data 501 for a particular location. As one example, the HMD prompts a user to move around a space (e.g., their house) while wearing the HMD so that image sensors of the HMD can capture scene data 501 for the space. As another example, the HMD prompts the user to move around while wearing the HMD and to gaze at items of particular importance for semantic information module 504 to determine semantic information 506 about such items.

Event detection module 508 is configured to detect event 530 that occurs in a scene and determine if event 530 satisfies a set of one or more event criteria. If event 530 satisfies the set of event criteria, event detection module 508 causes assistance module 540 to generate set of actions 550 to assist the user with event 530. Accordingly, event assistance unit 360 can consider detected events that satisfy the set of event criteria as sufficiently relevant for computer system 101 to provide assistance to the user. Example events that can satisfy the set of one or more event criteria include emergency events (e.g., a power outage, a fire, an earthquake, a medical emergency, and the like) and events that correspond to assistance with a physical task, e.g., cooking a recipe, making a cocktail, going camping, or taking care of a plant or an animal.

Various example event criteria (e.g., conditions based on which event assistance unit 360 evaluates the relevance of detected event 530) are now discussed. In some examples, an event criterion is satisfied when a score for event 530 exceeds a threshold score. For example, event detection module 508 is trained to score events based on predicted relevance to the user and to cause computer system 101 to only provide assistance for events having a sufficiently high score. In some examples, an event criterion is satisfied when scene data 512 indicates a threshold amount of change to the corresponding scene. For example, event detection module 508 is trained to consider an amount by which a scene changes (e.g., in audio content and/or in visual content) and to determine the score of event 530 based on the amount of change, e.g., such that an increased amount of change in the scene positively biases the score for event 530 detected within the scene. In some examples, an event criterion is satisfied when a task corresponding to event 530 is new to a user. For example, context information 510 indicates the task(s) that are new and/or already familiar to a user and event detection module 508 is trained to consider context information 510 when scoring event 530, e.g., so that the score for an event corresponding to a new task is positively biased. In this manner, computer system 101 may perform actions to assist the user with unfamiliar tasks, such as making a recipe for the first time, going camping for the first time, setting up a tent for the first time, and the like. In some examples, an event criterion is satisfied when the user device receives a user input (e.g., a natural language input) that requests for assistance with event 530.

In some examples, event detection module 508 detects event 530 proactively. In some examples, the set of generated actions to assist with event 530 are performed proactively. For example, event 530 is detected and/or the set of actions are performed without requiring computer system 101 to receive natural language input that describes event 530 and without requiring computer system 101 to receive other user input that explicitly indicates event 530 (e.g., other input that requests for assistance with event 530 and that is received via a user interface of computer system 101). In other examples, event 530 is detected and the set of actions are performed responsive to receiving a user input that requests for assistance with event 530.

In some examples, if event 530 is proactively detected, event detection module 508 causes the user device to provide an output (e.g., audio and/or displayed output) that prompts the user to confirm whether they want assistance with event 530. In some examples, event detection module 508 causes the user device to provide such output if event 530 has a score that exceeds a threshold score. In response to the user device receiving a user input that corresponds to confirming assistance (e.g., “yes please”), event detection module 508 causes assistance module 540 to generate set of actions 550 to assist the user with event 530. Accordingly, in some examples, an event criterion is satisfied when the user device receives such confirmatory user input. The set of individual event criterion each required to be satisfied for event 530 to satisfy the set of event criteria can vary across different implementations of the examples discussed herein (meaning that the set of event criteria can include any one of, or any combination of, the above-discussed criteria.).

Event detection module 508 performs its functions based on processing at least some of scene data 512, context information 510, and user attention data 514. In some examples, scene data 512 and scene data 501 correspond to different scenes. For example, scene data 512 corresponds to a scene in which event 530 occurs and scene data 501 corresponds to a scene before event 530 occurs. Similar to user attention data 502, user attention data 514 includes information about a user's attention with respect to the scene of scene data 512.

Context information 510 is associated with the scene in which event 530 occurs and can provide information relevant to detection of event 530. In some examples, context information 510 indicates a state of an external device, e.g., a device external to the user device. In some examples, the state of the external device is defined by value(s) of respective parameter(s) of the external device, e.g., power status, connectivity status, volume, temperature, brightness, and the like. In some examples, context information 510 incudes information received from a service external to the user device, such as an information service that the user is subscribed to and/or that can send information to the user device, e.g., a weather information service, a sports information service, an emergency notification service, and the like. In some examples, context information 510 includes information received from an external device, such as a text message, an email message, a phone call, a voicemail, and the like.

In some examples, context information 510 includes the user's personal information. In some examples, the personal information is obtained based on user interaction with a user device, e.g., user interaction with software applications. Example personal information includes a user's contacts data (e.g., the contact information of the user and/or of other users), email data, message data, calendar data, phone data (e.g., call logs and voicemails), location data, reminders data, photos, videos, health information, workout information, financial information, web search history, navigation history, media data (e.g., songs and audiobooks), information related to a user's home (e.g., the states of the user's home appliances and home security systems and/or home security system access information), notes and/or journal entries, and the like.

In some examples, event assistance unit 360 selects context information 510 from the context information available to computer system 101 based on recency. For example, context information 510 is obtained (e.g., received and/or determined) at the time of the scene of scene data 512 or is obtained within a predetermined duration (e.g., 30 seconds, 1 minute, 5 minutes, 30 minutes, or 1 hour) before the time of the scene. In some examples, event detection module 508 is configured to process context information 510 into a format (e.g., a natural language format) that is suitable for processing by LLM 520, discussed below. By way of example, if context information 510 indicates that the user device no longer detects a Wi-Fi signal from a home Wi-Fi router, the processed context information 510 is “home Wi-Fi signal lost.” As another example, if context information 510 includes a text message from a user's friend that says “have fun camping for the first time,” the processed context information 510 is “going camping for the first time.”

In some examples, event detection module 508 implements semantic information module 516 and large language model (LLM) 520 to detect event 530. Semantic information module 516 is similar or identical to semantic information module 504. That is, consistent with the techniques discussed above with respect to semantic information module 504, semantic information module 516 is configured to determine semantic information 518 about a scene based on scene data 512 (e.g., image and/or video data), and optionally, based on user attention data 514. Similar to semantic information 506, semantic information 518 includes information that describes the scene of scene data 512. For example, semantic information 518 includes a natural language description of the scene that optionally accounts for the user's attention, e.g., “the user is ironing a shirt and suddenly stopped ironing when the lights went out” or “the user is in a campsite and is gazing at instructions for how to set up a tent.”

LLM 520 is configured to detect event 530 based on semantic information 518 and, optionally, based on processed context information 510. For example, event detection module 508 constructs a natural language prompt that includes semantic information 518 and processed context information 510 and provides the prompt to LLM 520. As one example, based on the natural language prompt “detect an event based on the following information: (1) the user is ironing a shirt and suddenly stopped ironing when the lights went out and (2) home Wi-Fi signal lost,” LLM 520 outputs the predicted event 530 of a power outage. As another example, based on the natural language prompt “detect an event based on the following information: (1) the user is in a campsite and is gazing at instructions for how to set up a tent and (2) going camping for the first time,” LLM 520 outputs the predicted event 530 of help with setting up a tent.

The above-described components of event detection module 508 are merely exemplary, and other architectures of event detection module 508 are possible. For example, event detection module 508 can implement various other types of AI-based techniques (e.g., based on the architecture described above with respect to FIG. 4) to process scene data 512, optionally in conjunction with context information 510 and/or user attention data 514, to detect event 530 and determine if event 530 satisfies event criteria.

Assistance module 540 is configured to generate set of actions 550 to assist the user with event 530 (that satisfies the event criteria) based on at least some of event 530 (e.g., a data representation of event 530), scene data 532, user attention data 534, and context information 536. Assistance module 540 is further configured to cause computer system 101 to perform (e.g., execute) set of actions 550. In some examples, assistance module 540 scores each action of set of actions 550 based on predicted relevance to assisting the user with event 530 and causes computer system 101 to selectively perform the top-scored (e.g., n-best) actions and/or to selectively perform action(s) having respective score(s) above a threshold score.

In some examples, scene data 532 and scene data 512 correspond to different scenes. For example, scene data 512 corresponds to a scene in which the detected event is initiated and scene data 532 corresponds to a current scene after the detected event is initiated. In this manner, assistance module 540 may generate suggested assistive actions for the event based on the current scene the user or their avatar is present within. Similar to user attention data 502 and user attention data 514, user attention data 534 includes information about a user's attention with respect to the current scene of scene data 532.

Context information 536 can provide further information relevant to generating (e.g., predicting) set of actions 550 to assist the user with event 530. In some examples, context information 536 includes the user's personal information, as discussed above with respect to context information 510. In some examples, context information 536 includes semantic information 506 (as shown) and/or includes semantic information 518. Accordingly, assistance module 540 can generate actions to assist a user with an event occurring in a current scene based on semantic information 506 and/or 518 determined for a previous scene. In some examples, event assistance unit 360 selects context information 536 based on recency. For example, semantic information 506 and/or 518 (based on which set of actions 550 are generated) are for scenes that have times within a threshold duration (e.g., 30 seconds, 1 minute, 1 hour, or 1 day) before the current time when assistance module 540 generates set of actions 550. As another example, the user's personal information used to generate set of actions 550 is obtained (e.g., detected, received, and/or determined) within a threshold duration (e.g., 30 seconds, 1 minute, 1 hour, or 1 day) before the current time.

Assistance module 540 can generate various types of actions to assist the user with event 530. In some examples, the generated set of actions 550 are in the form of computer-executable instructions to perform each respective action. FIGS. 6A-6J, 7A-7B, 8A-8B, and 9A-9G below illustrate examples of different actions that can be performed for different events. An example action includes controlling the user device and/or an external device, e.g., by turning the device on or off, setting the device to a particular value, or otherwise causing the device to perform an operation. Another example action includes providing (e.g., via displayed, haptic, and/or audio output) a suggestion related to event 530, such as an instruction to assist the user with completing a task related to event 530. Another example action includes providing a notification (e.g., in displayed, haptic, and/or audio format) associated with event 530. Another example action includes monitoring the status of an object, e.g., detecting image data for the object, analyzing the image data to determine a status (e.g., health) of the object, and optionally providing an output based on the determined status of the object. Another example action includes providing an output that indicates the location of an object, such as an object identified by semantic information 506 and/or 518.

In some examples, assistance module 540 is configured to cause computer system 101 to provide step-by-step suggestions related to event 530. For example, a generated suggestion is for a first (e.g., initial) step of a task and assistance module 540 generates another suggestion for a next step of the task upon determining, based on scene data 532, that the user has completed the first step. If assistance module 540 determines that the user has not completed the first step, assistance module 540 generates a suggestion to assist the user with completing the first step, without computer system 101 providing the suggestion for the next step. As a specific example, if event 530 is helping to make a particular cocktail, the user device first prompts the user to complete a first step of gathering the ingredients and does not prompt the user to complete a following step of mixing the ingredients until the scene data 532 (e.g., image and/or video data) is processed to determine that the user has gathered the correct ingredients.

In some examples, assistance module 540 is configured to provide a suggestion to correct a user action that is determined as incorrect with respect to event 530. For example, assistance module 540 is configured to determine, based on scene data 532 and event 530, that a detected user action is incorrect and generate a corrective suggestion in response. As a specific example, if event 530 is helping to make a particular cocktail, and the user device detects that the user grabbed the wrong kind of liquor for the cocktail, the user device notifies the user of the error and prompts them to grab the correct liquor.

In some examples, assistance module 540 implements one or more AI-based systems (e.g., based on the architecture described above with respect to FIG. 4) that are configured to concurrently process event 530, scene data 532, user attention data 534, and/or context information 536 to generate set of actions 550. For example, similar to event detection module 508, assistance module 540 implements semantic information module 560 and LLM 570. As detailed below, based on event 530, scene data 532, user attention data 534, and/or context information 536, assistance module 540 constructs a natural language prompt to LLM 570 that requests to generate set of actions 550.

Similar to semantic information module 516, semantic information module 560 is configured to process scene data 532, optionally in conjunction with user attention data 534, to determine (optionally, user attention-based) semantic information 565 that describes the scene of scene data 532. As a specific example, if a power outage event occurs, resulting in the user being present within the scene of a dark room, semantic information 565 is the natural language description “the user's attention is directed to a dark room.”

In some examples, assistance module 540 is further configured to process context information 536 and event 530 into a format (e.g., natural language format) that is suitable for processing by LLM 570. For example, the formatted information for context information 536 that indicates the last detected location of the user's flashlight and for event 530 of a power outage includes the text “the user's flashlight was last seen on the kitchen table” and “power outage,” respectively. In some examples, assistance module 540 constructs a prompt to LLM 570 by combining the formatted information and semantic information 565. Assistance module 540 then instructs LLM 570 to generate set of actions 550 based on the prompt. For example, to assist the user with power outage event 530, assistance module 540 constructs the prompt “generate actions to assist the user based on the following information: (1) a power outage; (2) the user's flashlight was last seen on the kitchen table; and (3) the user's attention is directed to a dark room.” Based on the prompt, LLM 570 generates the predicted actions of turning on the flashlight of the user's smartphone, informing the user where their flashlight was last seen, and to query an information service (e.g., the internet) about the status of the power outage.

In some examples, the state of the AI system (e.g., as defined by the values for the parameters of the AI system) changes to represent the detection of event 530. More specifically, before the AI system receives event 530 as input, the AI system has an initial state and the processing of event 530 causes the AI system to change to an updated state to account for event 530. In some examples, while the AI system has the updated state, the AI system continues to generate set of actions 550 that are predicted as relevant to event 530. In this manner, the AI system can continue to generate relevant actions as scene data 532, user attention data 534, and/or context information 536 are updated, e.g., refreshed to account for the current scene.

In some examples, event detection module 508 detects a sub-event of event 530 and determines that the sub-event satisfies sub-event criteria, e.g., in a manner analogous to that described above with respect to event 530. Generally, the sub-event relates to the primary goal associated with event 530 and represents a task associated with the primary goal. For example, if event 530 is a power outage, a sub-event includes turning on a personal generator system. As another example, if event 530 is assistance with making cocktails, a sub-event includes suggesting a particular cocktail recipe. In some examples, the updated state of the AI system changes to represent both event 530 and a sub-event of event 530. Specifically, while the AI system has the updated state to represent event 530, assistance module 540 receives a data representation of the sub-event (that satisfies the sub-event criteria) from event detection module 508. In response, the AI system processes the sub-event to change to a further updated state to account for both event 530 and the sub-event. This can allow assistance module 540 to generate set of actions 550 relevant to assistance with the sub-event while also generating actions 550 to assist with the primary goal of event 530. This can prevent the user device from undesirably forgoing to assist the user with main event 530 once the user device begins to assist the user with the sub-event. As a specific example, if event 530 is a power outage, while the user device provides outputs to assist the user with the sub-event of turning on a personal generator system, the user device also provides a notification from a power company about the status of the power outage.

In some examples, event detection module 508 detects an event (an “end event”) that is an end of a previously detected event 530. Event detection module 508 detects the end event according to the same techniques discussed above for detecting the previously detected event 530. For example, event detection module 508 detects the end of a power outage based on scene data 512 indicating that lights in a user's house are back on and based on context information 510 including a text message from a power company that the power is restored and based on context information 510 indicating that a Wi-Fi signal from a home wireless router is now detected. In some examples, in response to detecting the end event and determining that the end event satisfies the event criteria, event detection module 508 causes assistance module 540 to generate a set of actions 550 to assist the user with the end event. In this manner, computer system 101 can provide assistance both when an event initiates and when the event ends. Assistance module 540 generates set of actions 550 to assist the user with the end event according to the same techniques discussed above for generating set of actions 550 to assist the user with previously detected event 530. For example, for the end of the power outage event, assistance module 540 generates the action of reminding the user to turn off their generator, e.g., based on previous semantic information 506 that indicates the user turned on their generator during the power outage.

The above-described components of assistance module 540 are merely exemplary, and other architectures of assistance module 540 are possible. For example, assistance module 540 can implement various other types of AI-based techniques (e.g., based on the architecture described above with respect to FIG. 4) to process context information 536, scene data 532, user attention data 534, and/or event 530 to generate actions 550.

FIGS. 6A-6J, 7A-7B, 8A-8B, and 9A-9G illustrate device 600 performing actions to assist the user with various different events that occur in three-dimensional scenes, according to some examples. The events are detected and the actions are generated according to the techniques discussed-above with respect to FIG. 5.

FIGS. 6A-6J, 7A-7B, 8A-8B, and 9A-9G illustrate a user's view of respective three-dimensional scenes. In some examples, device 600 provides at least a portion of the scenes of FIGS. 6A-6J, 7A-7B, 8A-8B, and 9A-9G. For example, the scenes are XR scenes that include at least some virtual elements generated by device 600. In other examples, the scenes are physical scenes.

Device 600 implements at least some of the components of computer system 101. For example, device 600 includes one or more sensors configured to detect data corresponding to the respective scenes (e.g., scene data 501, scene data 512, and/or scene data 532). In some examples, device 600 is an HMD (e.g., an XR headset or smart glasses) and FIGS. 6A-6J, 7A-7B, 8A-8B, and 9A-9G illustrate the user's view of the respective scenes via the HMD. For example, FIGS. 6A-6J, 7A-7B, 8A-8B, and 9A-9G illustrate physical scenes viewed via pass-through video, physical scenes viewed via direct optical see-through, or virtual scenes viewed via one or more displays of the HMD. In other examples, device 600 is another type of device, such as a smart watch, a smart phone, a pair of headphones or earbuds, a tablet device, a laptop computer, or a projection-based device.

The examples of FIGS. 6A-6J, 7A-7B, 8A-8B, and 9A-9G illustrate that the user and device 600 are present within the respective scenes of 6A-6J, 7A-7B, 8A-8B, and 9A-9G. For example, the scenes are physical or extended reality scenes and the user and device 600 are physically present within the scenes. In other examples, an avatar of the user is present within the scenes. For example, when the scenes are virtual reality scenes, the avatar of the user is present within the virtual reality scenes.

FIGS. 6A-6J illustrate device 600 performing actions to assist a user with a power outage event.

In FIG. 6A, the user is present within a scene that corresponds to the living room of the user's house. Device 600 detects scene data for the scene and user attention data indicating that the user gazes at flashlight 602. Based on the detected data, semantic information module 504 determines semantic information indicating that flashlight 602 is located on the living room table.

In FIG. 6B, the user is present within a scene that corresponds to the basement of the user's house. The basement includes generator 604 and circuit breaker box 606. Device 600 detects scene data for the scene and user attention data indicating that the user gazes at generator 604. Based on the detected data, semantic information module 504 determines semantic information indicating the brand and/or type of generator 604 and that generator 604 is located in the basement of the user's house.

In FIG. 6C, the user is present within a scene that corresponds to a bedroom of the user's house. The scene of FIG. 6C occurs at a later time than the scenes of FIGS. 6A and 6B. The scene of FIG. 6C includes external device 608 that is currently playing music (as indicated by music indicator 610), wireless router 612 that broadcasts a Wi-Fi signal (as indicated by Wi-Fi signal indicator 614) to device 600, and smartphone 616. In the scene, the user is ironing clothes while dancing to the music from external device 608. The scene has high ambient light level 618 because the bedroom light is on. Music indicator 610, Wi-Fi signal indicator 614, and ambient light level 618 are for illustrative purposes only and are not objects that the user views in the scene. Device 600 detects scene data for the scene of FIG. 6C. The scene data indicates (1) a relatively high ambient light level, (2) a relatively high motion level of device 600 (e.g., because the user is wearing device 600 while dancing), (3) a relatively high audio level of the scene, and (4) that the user is ironing clothes.

In FIG. 6D, a power outage event occurs. Due to the power outage, in the scene of FIG. 6D, wireless router 612 ceases to broadcast a Wi-Fi signal (as indicated by lack of Wi-Fi signal indicator 614), external device 608 ceases playing music (as indicated by lack of music indicator 610), ambient light level 618 is low, and the user stops ironing clothes and dancing to music. Device 600 detects scene data for the scene of FIG. 6D. Based on the scene data, event detection module 508 detects the power outage event and determines that the power outage event satisfies the set of event criteria. For example, event detection module 508 detects the power outage based on scene data indicating (1) that the ambient light level changed from high to low, (2) that device 600's motion level decreased (because the user stopped dancing), (3) that the audio level of scene 610 decreased, and (4) the user stopped ironing. In some examples, event detection module 508 further detects the power outage based on context information, e.g., based on ceasing to detect a Wi-Fi signal from wireless router 612 and/or based on receiving a text message from a power company that informs the user about the power outage.

In FIG. 6E, device 600 performs a set of actions generated by assistance module 540 to assist the user with the power outage. Specifically, device 600 causes the flashlight of smartphone 616 to turn on, as indicated by light indicator 620. Device 600 further provides audio output 622 “Your phone is nearby. I'm checking on the details of this power outage.” Device 600 further provides audio output 624 “I last saw your flashlight on the living room table.” Device 600 provides audio output 624 based on semantic information about the previous scene of FIG. 6A, e.g., semantic information that indicates the location of flashlight 602. Device 600 further provides audio output 626 “You might want to unplug your iron.” Device 600 provides audio output 626 based on semantic information that indicates the user was ironing (semantic information about the previous scene of FIG. 6E).

In FIG. 6F, the user has moved to their living room, grabbed flashlight 602, and turned it on. Thus, ambient light level 618 increases. In FIG. 6F, device 600 receives the user's speech input 628 “I'd like to try the generator.” Based on speech input 628, event detection module 508 detects the event of assisting the user with powering their house using generator 604 (e.g., a sub-event of the power outage event) and determines that the event satisfies the set of event criteria. In response, in FIGS. 6F-6J, assistance module 540 generates a set of actions to assist the user with powering their house using generator 604 and device 600 performs the set of actions. Specifically, in FIG. 6F, device 600 provides audio output 630 “Ok, let's go down to the basement where your generator is.” Device 600 provides audio output 630 based on semantic information about the previous scene of FIG. 6B (semantic information that indicates the location of generator 610).

In FIG. 6G, the user has moved to their basement while relying on flashlight 602 for light and has opened circuit breaker box 606. Circuit breaker box 606 includes written information 632 specifying that transfer switch 634 is in the bottom left corner of circuit breaker box 606. In FIG. 6G, device 600 detects scene data that represents circuit breaker box 606 and device 600 further detects user attention data indicating that the user gazes at circuit breaker box 606. Based on the scene data and the user attention data, device 600 provides audio output 636 “first flip the transfer switch on the bottom left.” In some examples, audio output 636 is further based on semantic information that indicates the type of generator 604 (semantic information about the scene of FIG. 6B). For example, based on the semantic information, assistance module 540 infers that the particular type of generator 604 requires the user to flip transfer switch 634 before connecting generator 604 to circuit breaker box 606.

In FIG. 6H, the user has flipped transfer switch 634. Device 600 detects scene data that indicates transfer switch 634 has been flipped. Based on the scene data (e.g., indicating the user has successfully completed a step for powering the house using generator 604), device 600 provides audio output 638 “Ok, now plug the generator cable into the power socket” that corresponds to a next step for powering the house using generator 604.

In FIG. 6I, the user attempts to plug generator cable 640 into power socket 642, but generator cable 640 is upside-down so it does not plug in. The user further provides speech input 644 “Huh?” indicating their confusion. Device 600 detects scene data (e.g., image data and audio data) that includes speech input 644 and that indicates the user is trying to plug in the wrong end of generator cable 642. Based on the scene data, device 600 provides audio output 646 “The cable is upside down” to correct the user's action.

In FIG. 6J, the user has successfully plugged generator cable 640 into power socket 642 and started generator 604. Accordingly, the lights turn on, as indicated by the increase in ambient light level 618. Device 600 further provides audio output 650 “Pacific power company says this power outage will last two hours” to notify the user about the status of the detected power outage event.

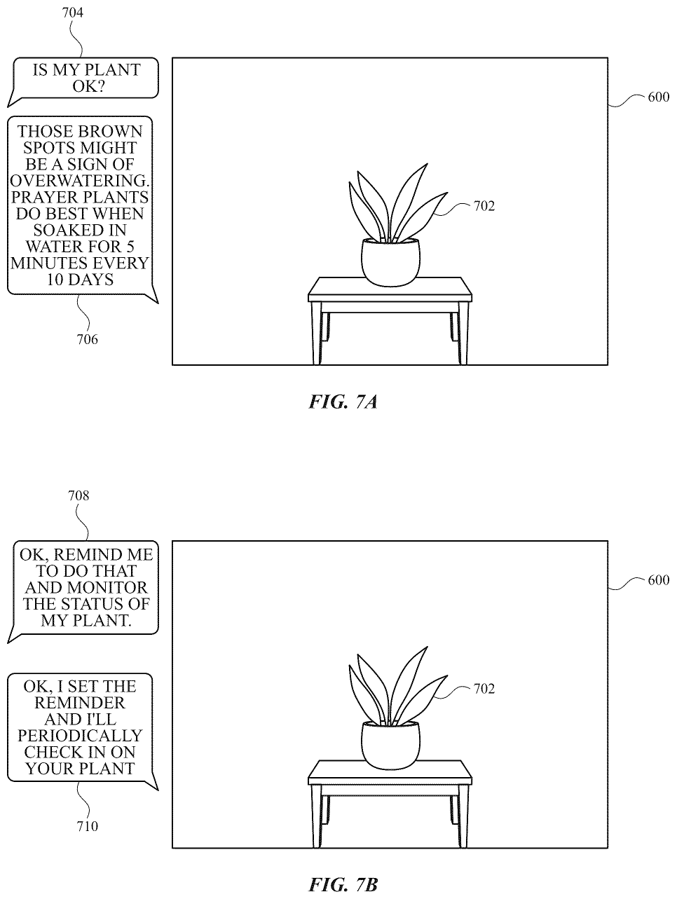

FIGS. 7A-7B illustrate device 600 performing actions to assist the user with the event of taking care of a plant.

In FIG. 7A, the user is present within a scene that includes houseplant 702. In FIG. 7A, the user provides speech input 704 “is my plant ok?” while they gaze at houseplant 702. Device 600 detects scene data that includes speech input 704 and that includes an image of houseplant 702. Device 600 further detects user attention data indicating that the user gazes at houseplant 702 while they speak at least a portion of speech input 704. Based on the scene data and the user attention data, event detection module 508 detects the event of providing information about a prayer plant (the specific type of houseplant 702) and determines that the event satisfies event criteria. As part of detecting the event, event detection module 508 determines, based on the scene data and/or the user attention data, semantic information identifying houseplant 702 as a prayer plant.

In FIG. 7A, device 600 performs an action generated by assistance module 540 for assisting the user with the detected event. Specifically, device 600 provides audio output 706 “Those brown spots might be a sign of overwatering. Prayer plants do best when soaked in water for 5 minutes every 10 days.” Assistance module 540 generates the action of providing audio output 706 based on the event and scene data indicating that houseplant 702 has brown spots.

In FIG. 7B, after device 600 provides audio output 706, the user provides speech input 708 “ok remind me to do that and monitor the status of my plant.” Based on speech input 708, event detection module 508 detects the corresponding event and determines that the event satisfies event criteria. Event detection module 508 thus causes assistance module 540 to generate the actions of (1) setting a reminder to soak the prayer plant in water every ten days and (2) to monitor the status of the prayer plant. In FIG. 7B, device 600 performs the generated actions. For example, device 600 sets the reminder and provides audio output 710 “ok, I set the reminder and I'll periodically check in on your plant.” Assistance module 540 generates the action to set the reminder based on semantic information indicating that houseplant 702 is a prayer plant (semantic information about the scene of FIG. 7A). Device 600 also starts to monitor the status of houseplant 702. For example, device 600 periodically captures image data of houseplant 702 (e.g., as the user walks near houseplant 702 during their daily activities) and if houseplant 702 is determined to be unhealthy based on the image data, device 600 outputs a corresponding notification.

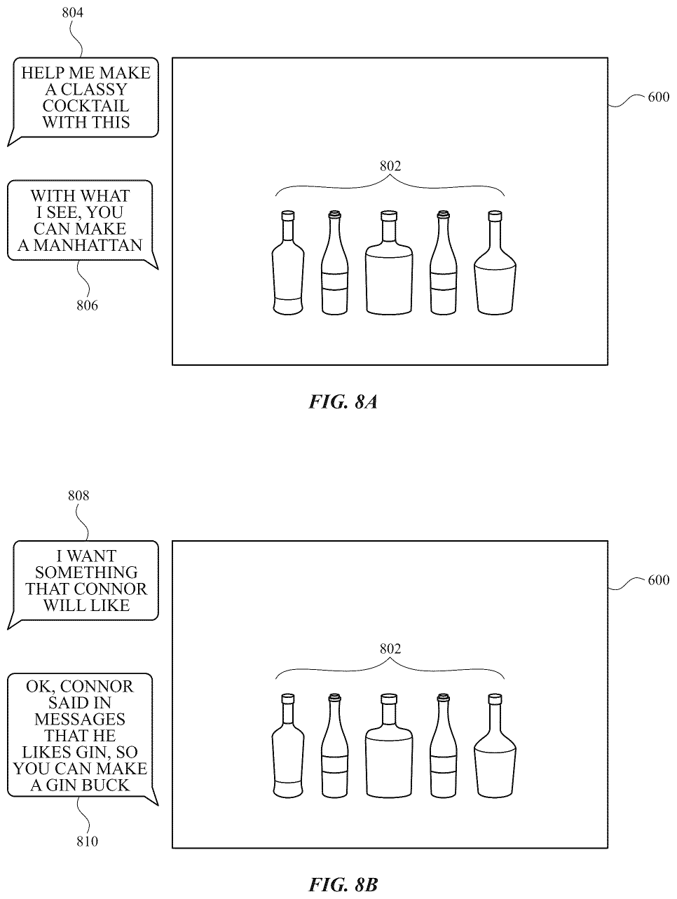

FIGS. 8A-8B illustrate device 600 performing actions to assist the user with the event of making a cocktail.

In FIG. 8A, the user is present within a scene that includes liquor bottles 802. The user provides speech input 804 “help me make a classy cocktail with this.” Device 600 detects scene data that includes speech input 804 and that includes an image of liquor bottles 802. Device 600 further detects user attention data indicating the user gazes at liquor bottles 802 while they speak at least a portion of speech input 804. Based on the scene data and the user attention data, event detection module 508 detects the event of helping the user make a cocktail with the types of liquor the user has and determines that the event satisfies event criteria. As part of detecting the event, event detection module 508 determines, based on the scene data and/or the user attention data, semantic information that identifies the respective types of liquor bottles 802 (e.g., gin, whisky, vodka, red vermouth, and bitters). In FIG. 8A, assistance module 540 generates an action to assist the user with the event and device 600 performs the action. Specifically, device 600 provides audio output 806 “with what I see, you can make a Manhattan.”

In FIG. 8B, after device 600 provides audio output 806, the user provides speech input 808 “I want something that Connor will like.” Based on speech input 808, event detection module 508 detects the event of helping the user make a cocktail that Connor will enjoy and determines that the event satisfies event criteria. Assistance module 540 generates the action of suggesting to make the Gin Buck cocktail based on the event and context information (e.g., a message from Connor saying that he likes gin and semantic information that identifies the respective types of liquor bottles 802 (semantic information about the scene of FIG. 8A)). Device 600 performs the action by providing audio output 810 “Ok, Connor said in messages that he likes gin, so you can make a Gin Buck.”

If device 600 receives an affirmative user reply to audio output 810, device 600 performs a set of actions that are generated by assistance module 540 to assist the user with making a Gin Buck. For example, device 600 instructs the user to make a Gin Buck in a step-by-step manner (e.g., by providing instructions for a next step if determined, based on scene data, that a previous step is complete) and provides output to correct a user if determined, based on scene data, that the user performs an incorrect step for making a Gin Buck (e.g., if the user grabs a bottle of whisky instead of a bottle of gin).

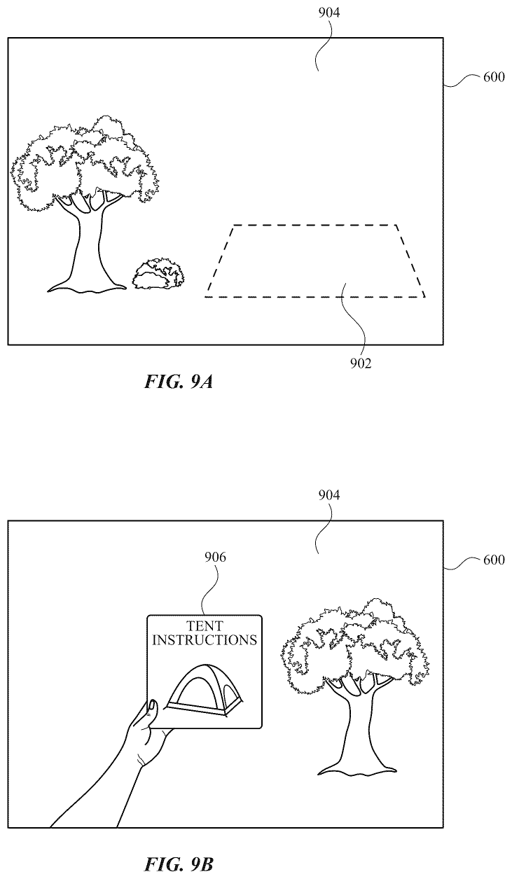

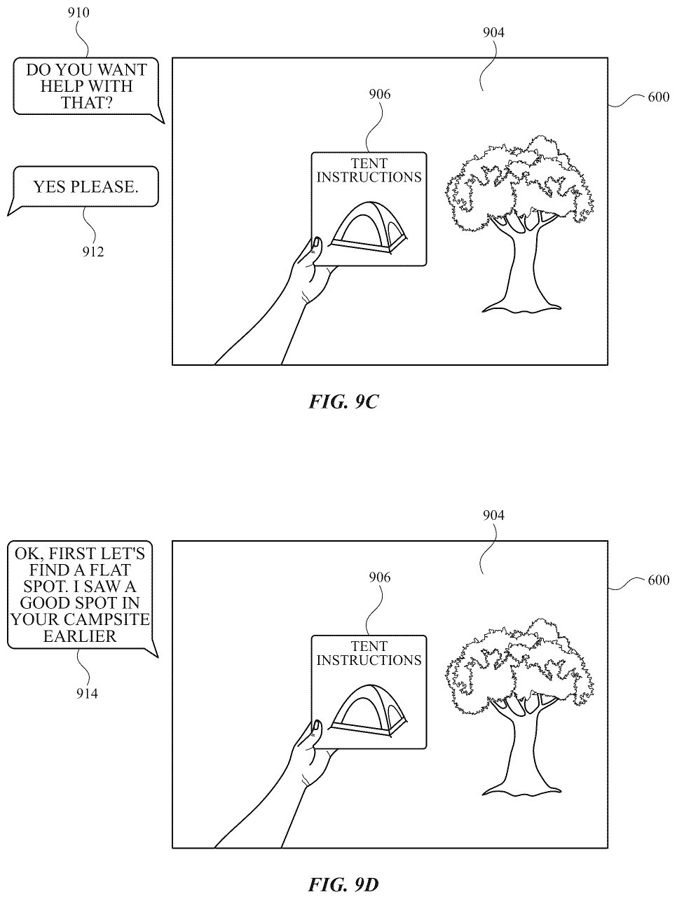

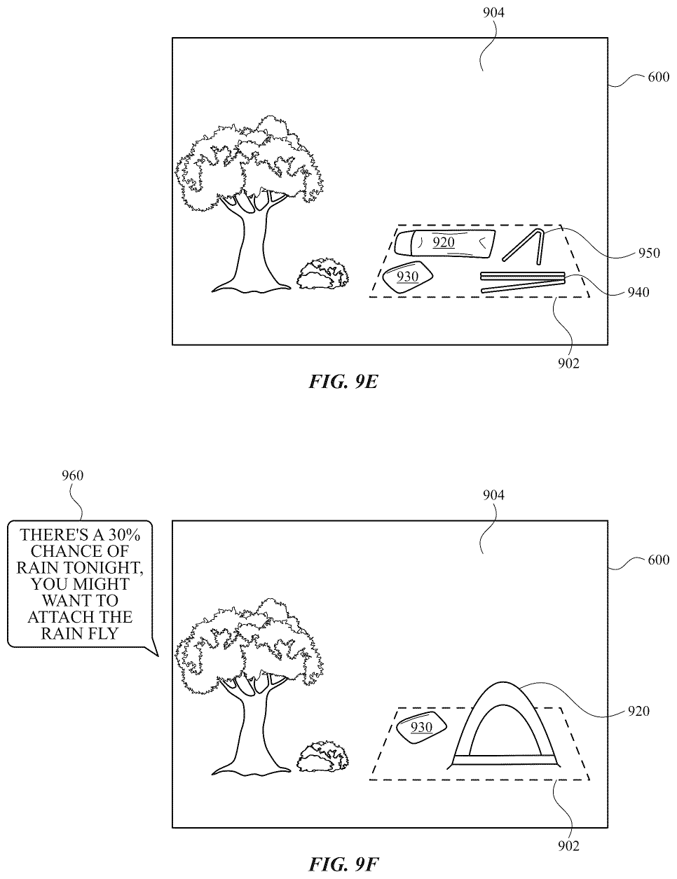

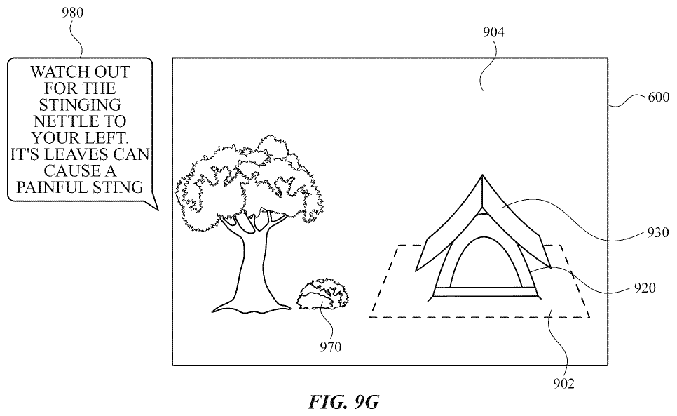

FIGS. 9A-9G illustrate device 600 performing actions to assist the user with the event of setting up a tent.

In FIG. 9A, the user is present within a scene that includes campsite 904 that has a relatively flat region 902. Device 600 detects scene data for the scene and user attention data indicating that the user gazes at flat region 902. Based on the scene data and the user attention data, semantic information module 504 determines semantic information indicating that campsite 904 has flat region 902, e.g., determines the natural language description “a campsite with a flat spot.”

FIG. 9B illustrates a scene that occurs after the scene of FIG. 9A. In FIG. 9B, the user holds up instructions 906 for setting up a tent and gazes at instructions 906. Device 600 detects scene data that indicates the user is holding up instructions 906 while in a campsite. Device 600 further detects user attention data indicating that the user gazes at instructions 906. Event detection module 508 detects the event of helping the user set up tent 920 (FIG. 9E) based on the scene data, the user attention data, and context information. The context information (e.g., messages between the user and their friend and/or entries from the user's personal journal) indicates that the user is going camping for the first time.

In FIG. 9C, because event detection module 508 proactively detects the event (as device 600 did not receive input from the user that explicitly asks for help with setting up tent 920), device 600 provides audio output 910 “do you want help with that?”. In FIG. 9C, device 600 receives the user's speech input 912 “yes please.” Based on confirmatory speech input 912, event detection module 508 determines that the event of helping the user set up tent 920 satisfies the set of event criteria and thus causes assistance module 540 to generate a set of actions to assist the user with the event.

In FIG. 9D, device 600 performs an action generated by assistance module 540 for helping the user set up tent 920. Specifically, device 600 provides audio output 914 “ok, first let's find a flat spot. I saw a good spot in your campsite earlier.” Audio output 914 is based on the event and semantic information indicating that campsite 904 includes flat region 902 (semantic information about the scene of FIG. 9A).

In FIG. 9E, the user has placed tent 920, rain fly 930, long tent poles 940, and short tent poles 950 on flat region 902. Device 600 then provides instructions for helping the user set up tent 920. In some examples, the instructions are step-by-step based on scene data, e.g., meaning that device 600 does not provide an instruction for a next step until scene data is processed (optionally in conjunction with user attention data) to determine that the user has successfully completed a previously instructed step. In some examples, the instructions correct an incorrect user action with respect to the event. For example, if device 600 determines based on scene data (and optionally user attention data) that the user is incorrectly attempting to thread short tent poles 950 though tent clips intended for long tent poles 940, device 600 provides an audio output to correct the action.

In FIG. 9F, the user has set up tent 920 based on instructions from device 600. However, the user has not yet attached rain fly 930 to tent 920. Based on the event of helping the user set up tent 920, context information that indicates it is the user's first time going camping, and scene data that indicates that rain fly 930 is not attached to tent 920, assistance module 540 generates the action of checking the weather information and instructing the user to attach rain fly 930 if the weather information indicates a chance of rain. Device 600 performs the action to provide audio output 960 “There's a 30% chance of rain tonight, you might want to attach the rain fly.”

In FIG. 9G, the user has attached rain fly 930 to tent 920. Device 600 detects scene data that indicates stinging nettle plant 970 is near the left side of tent 920. Based on the scene data, the event of helping the user set up tent 920, and context information indicating that it is the user's first time going camping, assistance module 540 generates the action of warning the user about the stinging nettle plant. Device 600 thus provides audio output 970 “watch out for the stinging nettle to your left. The leaves can cause a painful sting.”

Additional descriptions regarding FIGS. 6A-6J, 7A-7B, 8A-8B, and 9A-9G are provided below in reference to method 1000 described with respect to FIG. 10.

FIG. 10 is a flow diagram of a method 1000 for providing assistance with an event that occurs in a three-dimensional scene, according to some examples. In some examples, method 1000 is performed at a computer system (e.g., computer system 101 in FIG. 1 and/or device 600) that is in communication with one or more sensor devices (e.g., image sensors, light sensors, depth sensors, tactile sensors, orientation sensors, proximity sensors, temperature sensors, location sensors, motion sensors, velocity sensors, audio sensors, and/or biometric sensors). In some examples, method 1000 is governed by instructions that are stored in a non-transitory (or transitory) computer-readable storage medium and that are executed by one or more processors of a computer system, such as the one or more processors 302 of computer system 101 (e.g., controller 110 in FIG. 1). In some examples, the operations of method 1000 are distributed across multiple computer systems, e.g., a computer system and a separate server system. Some operations in method 1000 are, optionally, combined, the orders of some operations are, optionally, changed, and some operations are, optionally, omitted.

At block 1002, while the computer system is present within a first scene (e.g., a physical scene or an XR scene) (e.g., the scene of any one of FIGS. 6A-6J, 7A-7B, 8A-8B, and 9A-9G) a first gaze of the user of the computer system is detected (e.g., by detecting user attention data 502). In some examples, instead of the computer system being present within the first scene, if the first scene is a virtual reality scene, the user and/or avatar of the user is/are present within the first scene while the first gaze is detected.

At block 1004, after a determination of semantic information (e.g., 506) about the first scene (e.g., by semantic information module 504) based on the detected first gaze of the user and while the computer system is present within a second scene (e.g., the scene of any one of FIGS. 6A-6J, 7A-7B, 8A-8B, and 9A-9G), data corresponding to the second scene (e.g., scene data 512) is detected via the one or more sensor devices. In other examples, data corresponding to the second scene is not detected, but is generated by the computer system. For example, the computer system generates audio data and/or display data for a virtual reality scene. Accordingly, in some examples, the computer system is not required to be in communication with the one or more sensor devices that detect data corresponding to the second scene.

At block 1006, it is determined (e.g., by event detection module 508), whether an event (e.g., event 530) that occurs in the second scene is detected based on the data corresponding to the second scene. At block 1006, it is further determined (e.g., by event detection module 508) whether the event satisfies a set of one or more event criteria.

At block 1008, in response to (or after) detecting, via the one or more sensor devices, the data corresponding to the second scene (e.g., scene data 512): in accordance with a determination that an event that occurs in the second scene is detected based on the data corresponding to the second scene and that the event satisfies a set of one or more event criteria, the computer system performs a set of one or more actions that correspond to assisting the user with the event (e.g., actions 550 generated by assistance module 540) (e.g., the actions illustrated by any one of FIGS. 6E-6J, 7A-7B, 8A-8B, and 9D-9G), where a first action of the set of one or more actions is based on the semantic information (e.g., 506 and/or 518) about the first scene.

At block 1010, in response to (or after) detecting, via the one or more sensor devices, the data corresponding to the second scene: in accordance with a determination that an event that occurs in the second scene is not detected based on the data corresponding to the second scene and/or that the event does not satisfy the set of one or more event criteria, the computer system forgoes performing the set of one or more actions that correspond to assisting the user with the event.

In some examples, instead of blocks 1004-1010, method 1000 includes: after a determination of semantic information (e.g., 506) about the first scene based on the detected gaze of the user and while the user of the computer system (and/or their avatar) is present within a second scene (e.g., the scene of any one of FIGS. 6A-6J, 7A-7B, 8A-8B, and 9A-9G): in accordance with a determination (e.g., by event detection module 508) that an event (e.g., 530) occurs in the second scene and that the event satisfies a set of one or more event criteria, performing a set of one or more actions that correspond to assisting the user with the event (e.g., actions 550 generated by assistance module 540) (e.g., the actions illustrated by any one of FIGS. 6E-6J, 7A-7B, 8A-8B, and 9D-9G), where a first action of the set of one or more actions is based on the semantic information about the first scene.

In some examples, the first scene and the second scene are at a same location. In some examples, the first scene and the second scene are at the same location at different times.

In some examples, the first scene is different from the second scene. For example, the first scene and the second scene are at different locations.

In some examples, the semantic information (e.g., 506) about the first scene includes a description of the first scene, an identity of a first object (e.g., 602 and/or 604) that is present in the first scene, a state of the first object, and/or a location of the first object.

In some examples, the set of one or more event criteria include a first criterion that is satisfied when the data corresponding to the second scene indicate a threshold amount of change to the second scene.

In some examples, set of one or more event criteria include a second criterion that is satisfied when a task corresponding to the event is new to the user of the computer system.

In some examples, the one or more sensor devices include an image sensor; the data corresponding to the second scene include image data detected via the image sensor; and the event that occurs in the second scene is detected based on information corresponding to understanding of the second scene (e.g., 518) that is determined based on the image data detected via the image sensor.

In some examples, detecting, via the one or more sensor devices, the data corresponding to the second scene includes detecting a second gaze of the user (e.g., detecting user attention data 514); and the information corresponding to understanding of the second scene is further determined based on the detected second gaze of the user.

In some examples, the one or more sensor devices include an audio sensor; the data corresponding to the second scene include audio data detected via the audio sensor (e.g., speech inputs 628, 704, 708, 804, and/or 808); and the event that occurs in the second scene is detected based on the audio data.

In some examples, the event that occurs in the second scene is further detected based on context information (e.g., 510) associated with the second scene. In some examples, the context information associated with the second scene includes information that indicates a state of a first device (e.g., 608 and/or 612) external to the computer system. In some examples, the context information associated with the second scene includes information that is received from a second device external to the computer system and/or information that is received from a service external to the computer system. In some examples, the context information associated with the second scene includes personal information of the user of the computer system.

In some examples, the event (e.g., 530) that occurs in the second scene is detected by: processing the data corresponding to the second scene (e.g., 512) to obtain a semantic description of the second scene (e.g., 518); and inputting a representation of the semantic description of the second scene into a large language model (e.g., LLM 520), where the large language model outputs a representation of the event based on the representation of the semantic description of the second scene.

In some examples, the event (e.g., 530) that occurs in the second scene is detected without requiring the computer system to receive natural language input that describes the event and the set of one or more actions (e.g., 550) is performed without requiring the computer system to receive the natural language input that describes the event (e.g., as illustrated in FIGS. 6E and 9C).

In some examples, performing the set of one or more actions that correspond to assisting the user with the event includes controlling a third device (e.g., 616) external to the computer system.

In some examples, performing the set of one or more actions that correspond to assisting the user with the event includes providing a first suggestion (e.g., an instruction) related to the event (e.g., as illustrated in FIGS. 6E-61, 7A, 8A-8B, and 9D-9G).

In some examples, method 1000 further includes: while the computer system is present within a third scene (e.g., the scene of any one of FIGS. 6A-6J, 7A-7B, 8A-8B, and 9A-9G) (and optionally, after the event that occurs in the second scene is detected): detecting, via the one or more sensor devices, image data corresponding to the third scene (e.g., detecting scene data 532); detecting a third gaze of the user (e.g., detecting user attention data 534); and providing a second suggestion (e.g., audio output 636) related to the event, where the second suggestion is determined based on the image data corresponding to the third scene and the third gaze of the user (e.g., as illustrated in FIG. 6G).

In some examples, the second suggestion related to the event (e.g., audio output 636 in FIG. 6G) corresponds to a first step for assisting the user with the event. In some examples, method 100 further includes: in accordance with a determination, based on the image data corresponding to the third scene, that the user has completed the first step, providing a third suggestion related to the event (e.g., audio output 638 in FIG. 6H), where the third suggestion corresponds to a next step for assisting the user with the event; and in accordance with a determination, based on the image data corresponding to the third scene, that the user has not completed the first step, forgoing providing the third suggestion related to the event.

In some examples, method 1000 further includes after the event (e.g., 530) that satisfies the set of one or more event criteria is detected, detecting, via the one or more sensor devices, data corresponding to an action performed by the user of the computer system (e.g., as illustrated in FIG. 6I) (e.g., detecting scene data 532); and in accordance with a determination that the action performed by the user of the computer system is incorrect with respect to the event, providing a fourth suggestion (e.g., audio output 646 in FIG. 6I) that corresponds to a correction of the action performed by the user of the computer system.

In some examples, performing the set of one or more actions that correspond to assisting the user with the event includes providing a notification (e.g., audio output 650 and/or 980) associated with the event.

In some examples, performing the set of one or more actions that correspond to assisting the user with the event includes monitoring a status of a second object (e.g., 702) that is present within the second scene (e.g., as described with respect to FIG. 7B).

In some examples, performing the first action includes providing an output (e.g., 624) that indicates the location of a third object (e.g., 602), wherein the semantic information about the first scene (e.g., the scene of FIG. 6A) identifies the third object.

In some examples, method 100 further includes: before the occurrence of the event that satisfies the set of one or more event criteria in the second scene: initiating a semantic information enrollment process (e.g., an object enrollment process), where the semantic information about the first scene (e.g., 506 and/or 518) is obtained during the semantic information enrollment process.

In some examples, before the event (e.g., 530) that occurs in the second scene and that satisfies the set of one or more event criteria is detected, an artificial intelligence system (e.g., LLM 570) configured to generate the set of one or more actions (e.g., 550) that correspond to assisting the user with the event has first state; and in accordance with a determination that the event that occurs in the second scene is detected based on the data corresponding to the second scene and that the event satisfies the set of one or more event criteria, the artificial intelligence system changes to have a second state that represents the event, where the second state is different from the first state.

In some examples, method 1000 further includes: after the event that occurs in the second scene and that satisfies the set of one or more event criteria is detected: while the computer system is present within a fourth scene (e.g., the scene of any one of FIGS. 6A-6J, 7A-7B, 8A-8B, and 9A-9G), detecting, via the one or more sensor devices, data corresponding to the fourth scene (e.g., 512); and in response to detecting, via the one or more sensor devices, the data corresponding to the fourth scene: in accordance with a determination (e.g., by event detection module 508) that a sub-event of the event is detected (e.g., as illustrated in FIG. 6F) based on the data corresponding to the fourth scene and that the sub-event satisfies a set of one or more sub-event criteria, performing a set of one or more actions (e.g., 550) that correspond to assisting the user with the sub-event (e.g., as illustrated by FIGS. 6F-6I).

In some examples, before the sub-event that satisfies the set of one or more sub-event criteria is detected (and in some examples, after the event that occurs in the second scene and that satisfies the set of one or more event criteria is detected), the artificial intelligence system has the second state that represents the event; and in accordance with a determination that the sub-event is detected based on the data corresponding to the fourth scene and that the sub-event satisfies the set of one or more sub-event criteria, the artificial intelligence system changes to have a third state that represents the event and the sub-event, where the third state is different from the first state and the second state.

In some examples, the event that occurs in the second scene and that satisfies the set of one or more event criteria includes an emergency event. In some examples, the event that occurs in the second scene and that satisfies the set of one or more event criteria corresponds to assistance with a physical task.

FIG. 11A illustrates a block diagram of planning unit 370 (FIG. 3) of controller 110, according to some examples. Planning unit 370 is configured to generate computer-executable plan 1120 to assist a user with respect to a 3D scene. FIG. 11A is merely exemplary and various modifications to planning unit 370 are possible. Accordingly, the components of planning unit 370 (and their associated functions) can be combined, the order of the components (and their associated functions) can be changed, components of planning unit 370 can be removed, and other components can be added to planning unit 370. Planning unit 370 is now discussed with respect to FIGS. 11A-11D, 12, 13A-13B, 14A-14C, and 15A-15B.

Planning unit 370 includes perception module 1106, context filtering module 1112, and combiner module 1114. Modules 1106, 1112, and 1114 are configured to operate in conjunction to determine scene state 1116 based on at least some of sensor data 1102, user attention data 1104, and context information 1110.

Planning unit 370 further includes planning module 1118. Planning module 1118 is configured to generate computer-executable plan 1120 based on at least some of: scene state 1116, goal data 1122, action data 1124, constraint data 1132, and objective function 1134.

Scene state 1116 includes information about the 3D scene, information about a user (or their avatar) who is present within the 3D scene, and/or information about an electronic device associated with the 3D scene (e.g., device 1300 in FIGS. 13A-13B, 14A-14C, and 15A-15B below, computer system 101, and/or another electronic device). In some examples, scene state 1116 includes a description of such information. The description is in natural language format (e.g., a list of predicted facts about the 3D scene), in a structured data format (e.g., JSON or XML), or in a combination thereof.

Goal data 1122 represents a goal (e.g., a desired outcome) for the 3D scene. As detailed below, the execution of plan 1120 can assist the user with achieving the goal for the 3D scene. In other words, plan 1120 is configured to assist the user with transitioning scene state 1116 to at least one goal state in which the goal is satisfied (e.g., at least one of potentially multiple different goal states in which the goal is respectively satisfied). In some examples, similar to scene state 1116, goal data 1122 includes a description of the goal and/or of the goal state(s), e.g., in natural language format, in a structured data format, or in a combination thereof. In some examples, goal data 1122 represents a constraint on plan 1120, e.g., a requirement that plan 1120 is generated to transition scene state 1116 into at least one of the goal state(s).

In some examples, the goal (and/or the goal state(s)) correspond to assisting the user with an event that is detected within the 3D scene. The event is detected according to the techniques discussed above with respect to event detection module 508 (FIG. 5). More specifically, event detection module 508 detects the event based on sensor data 1102, context information 1110, and/or user attention data 1104 (that respectively correspond to scene data 512, context information 510, and user attention data 514 of FIG. 5). In some examples, the event is detected proactively based on sensor data 1102. In some examples, the event is detected based on a natural language input (e.g., a user request for assistance) included in sensor data 1102. In the example of FIGS. 6A-6J above, the goal state(s) is/are state(s) in which power is restored to a user's home. In the example of FIGS. 9A-9G above, the goal state(s) is/are state(s) in which a user has successfully set up their tent.

In some examples, the goal is to maintain scene state 1116. When the goal is to maintain scene state 1116, planning module 1118 does not generate plan 1120, or generated plan 1120 corresponds to instructions for computer system 101 to continue default operation and to forgo executing instructions to attempt to change scene state 1116. In some examples, the goal is to maintain scene state 1116 when event detection module 508 does not detect an event that satisfies the event criteria discussed with respect to FIG. 5, e.g., does not detect an event that is sufficiently relevant to assist the user with.

Scene state 1116 is comprised of scene state information 1108 and optionally, contextual state information 1113. Scene state information 1108 is determined based on sensor data 1102 and optionally, based on user attention data 1104. Contextual state information 1113 is selected from context information 1110 and includes additional information, described below, that can be relevant to generation of plan 1120.

Perception module 1106 is configured to determine scene state information 1108 based on at least sensor data 1102. Sensor data 1102 includes data detected (e.g., captured) via one or more sensor devices, such as image data captured via image sensor(s) (e.g., RGB camera(s), infrared camera(s), and/or depth camera(s)), audio data captured via audio sensor(s) (e.g., microphone(s)), and/or motion data captured via motion sensor(s) (e.g., accelerometer(s), gyroscope(s), and/or IMU(s)). In some examples, a user wears or holds a user device (e.g., user-facing component 120) that includes the image sensor(s), the audio sensor(s), and/or the motion sensor(s).

If sensor data 1102 includes image data, perception module 1106 performs computer vision tasks (e.g., object recognition, scene understanding, motion tracking, and the like) on the image data to determine scene state information 1108. If sensor data 1102 includes audio data, perception module 1106 performs natural language processing and/or audio classification on the audio data to determine scene state information 1108. And if sensor data 1102 includes motion data, perception module 1106 processes the motion data to predict an activity (e.g., being still, running, walking, biking, swimming, stretching, dancing, and the like) performed by the user (e.g., the user who holds or wears the user device) to determine scene state information 1108.

In some examples, perception module 1106 determines scene state information 1108 based on image data and user attention data 1104. Like user attention data 502, 514, or 534 (FIG. 5), user attention data 1104 includes information about the portion of the 3D scene that the user is considered to pay attention to. In some examples, perception module 1106 performs computer vision tasks on the portion of the image data that depicts the portion of the 3D scene that the user pays attention to (e.g., to identify objects that are gazed at). In some examples, perception module 1106 defines an area/volume of the 3D scene based on the user's attention and performs computer vision tasks on image data that depicts the defined area/volume (e.g., to identify objects within that area or volume). In some examples, perception module 1106 applies greater processing resources when performing computer vision tasks on image data that depicts the portion of the 3D scene that the user pays attention to (e.g., as compared to the portion of the 3D scene that the user does not pay attention to).

As one example of determining scene state information 1108, consider that a user is sitting in silence in a living room while gazing at a window. Accordingly, perception module 1106 receives (1) image data that depicts a window in a living room, (2) user attention data indicating that the user gazes at the window, (3) audio data indicating a lack of speech and a relatively low ambient sound level, and (4) motion data indicating a relatively low level of user motion. Perception module 1106 thus determines the following scene state information 1108:
The user is in a living room.
The user is standing still or sitting still.
The user is gazing at the window of the living room.
The living room is quiet.

As another example of determining scene state information 1108, consider that a power outage event occurs while the user is listening to music, dancing, and ironing clothes, e.g., as illustrated in FIGS. 6C-6D. Due to the power outage, the user stops dancing and the music stops. Accordingly, perception module 1106 receives (1) image data depicting that the user is ironing clothes in a living room and that the lights turn off, (3) motion data indicating that the user was dancing and then stopped dancing, and (4) audio data indicating that music was playing and then stopped playing. Perception module 1106 thus determines the following scene state information 1108:
The user is ironing clothes in a living room.
The lights in the living room have turned off.
The user was dancing but then stopped dancing.
Music was playing and then stopped playing.

In some examples, context information 1110 includes a current date and/or a current time.

In some examples, context information 1110 includes the user's personal information. The personal information allows planning module 1118 to generate plan 1120 that assists the user in a personalized manner. In some examples, the personal information includes the personal information discussed above with respect to FIG. 5, e.g., contacts data (e.g., the contact information of the user and/or of other users), email data, message data, calendar data, phone data (e.g., call logs and voicemails), location data, reminders data, photos, videos, health information, workout information, financial information, web search history, navigation history, media data (e.g., songs and audiobooks), information related to a user's home (e.g., the states of the user's home appliances and home security systems and/or home security system access information), information about the user's daily routine, journal entries, notes, the respective locations of items in the user's home, items the user typically keeps in their home, the user's favorite items, whether the user has unread notifications, the number of unread notifications, information (e.g., an instruction) that was previously provided to the user, and/or the respective times associated with aforementioned information.

In some examples, context information 1110 includes state information about a state of an electronic device (e.g., computer system 101, device 1300, or another device). A state of an electronic device is defined by value(s) of respective parameters of the device, e.g., on or off, location, connectivity status, battery level, volume, temperature, display brightness, CPU usage, memory usage, whether a setting is activated, and the like.

Context filtering module 1112 is configured to filter (e.g., select a portion of) context information 1110 to determine contextual state information 1113. In some examples, context filtering module 1112 filters context information 1110 based on scene state information 1108 and/or based on goal data 1122. In some examples, context filtering module 1112 implements an AI model (e.g., an LLM) that is configured to filter context information 1110. The AI model is based on (e.g., is, or is constructed from) a foundation model, as discussed above with respect to FIG. 4. In some examples, context filtering module 1112 generates a prompt for the AI model to select a portion of context information 1110 given scene state information 1108 and/or goal data 1122. An example prompt is “select a portion of this context information [A] that may be relevant to assisting the user with the goal of [X], given that the scene is described by [Y],” where [A] represents context information 1110, [X] represents goal data 1122, and [Y] represents scene state information 1108. Context filtering module 1112 can allow planning module 1118 to more accurately and efficiently generate plan 1120 by reducing the amount of context information 1110 based upon which plan 1120 can be generated.

Continuing with the power outage example above, context filtering module 1112 determines the following contextual state information 1113 to be potentially relevant to restoring power to the user's home:
It is 10:30 PM.
The user's smartphone is nearby the user.
The flashlight of the smartphone is turned off.
The user received a text message from a power company saying that a power outage will last two hours.
The user typically keeps a handheld flashlight in a drawer in their dining room.
The user typically keeps a gas lamp in a drawer in their garage.
The user typically keeps a generator in their basement.

Combiner module 1114 is configured to combine contextual state information 1113 with scene state information 1108 to determine scene state 1116. For example, continuing with the power outage example above, combiner module 1114 determines the following scene state 1116:
The user is ironing clothes in a living room.
The lights in the living room have turned off.
The user was dancing but then stopped dancing.
Music was playing and then stopped playing.
It is 10:30 PM.
The user's smartphone is nearby the user.
The flashlight of the smartphone is turned off.
The user received a text message from a power company saying that a power outage will last two hours.
The user typically keeps a handheld flashlight in a drawer in their dining room.
The user typically keeps a gas lamp in their garage.
The user typically keeps a generator in their basement.

Context filtering module 1112 is an optional component of planning unit 370. Thus, in some examples, planning unit 370 does not filter context information 1110 and combiner module 1114 combines scene state information 1108 directly with context information 1110 (e.g., unfiltered contextual state information) to determine scene state 1116.

Action data 1124 corresponds to set of instructions that computer system 101 can execute and plan 1120 corresponds to a selected subset (e.g., portion) of the set of instructions. The set of instructions include instructions that, when executed, cause computer system 101 to perform a wide variety of different actions. In some examples, action data 1124 includes respective descriptions (e.g., names) of the different actions and/or includes the computer-executable instructions corresponding to the different actions. Examples of the different actions include instructing the user to perform a task, outputting information to a user, launching an application, causing a particular application to perform a particular function, initiating an API call, controlling a device external to computer system 101, initiating a search for information on the Internet, initiating a search for information stored locally on computer system 101, capturing data using a sensor, changing a parameter of a sensor, changing a setting of computer system 101, changing a connectivity status (e.g., Wi-Fi connectivity, BLUETOOTH connectivity, and/or cellular connectivity) of computer system 101, deleting data from computer system 101, transmitting data to an external computer system, determining information about a user, determining information about the 3D scene (e.g., by performing computer vision tasks, audio classification, or natural language processing), waiting for a condition associated with the 3D scene to be satisfied, determining if a condition associated with the 3D scene is satisfied, performing an action once a condition associated with the 3D scene is satisfied, performing an action once a condition associated with the 3D scene is not satisfied, continuing to operate in a default manner, and the like. In some examples, the set of instructions correspond to all actions computer system 101 can perform, so planning module 1118 can select from all possible actions to generate plan 1120. In some examples, the set of instructions exclude instructions for performing certain actions (e.g., performing financial transactions, deleting data, logging into certain user accounts, and the like) to prevent computer system 101 from incorrectly performing actions that may have a relatively high level of negative user impact when executing plan 1120.

In some examples, action data 1124 specifies one or more parameters for an action (e.g., each action) of the different actions described above. For example, an action to instruct the user to perform a task includes the parameters OUTPUT_FORMAT (that represents the format, e.g., displayed or spoken, in which to output the instruction) and OUTPUT_CONTENT (that represents the task to perform). As another example, the action to search for information on the Internet includes the parameters SEARCH_SERVICE (that represents the Internet search provider to use for the search) and SEARCH_STRING (that represents the content to search for). As another example, the action to wait for a condition associated with the 3D scene to be satisfied includes the parameters CONDITION_ID (that represents the condition to wait and/or monitor for) and WAIT_TIME (that represents the time for which to wait and/or monitor for the condition to be satisfied).

In some examples, action data 1124 specifies one or more preconditions that are respectively required to perform an action (e.g., each action) of the different actions. A precondition specifies a condition that must be satisfied to successfully perform a respective action (e.g., to successfully execute the corresponding instruction). In some examples, a precondition corresponds to a physical constraint associated with performing a respective action. For example, an action to turn on the flashlight of a device external to computer system 101 can be executed if the flashlight is off. As another example, an action to search the Internet can be executed if computer system 101 is connected to the Internet. In some examples, a precondition for a respective action corresponds to a constraint defined by an operating system of computer system 101 and/or by a setting of computer system 101. For example, an action to perform a certain function using a certain application can be executed if the CPU usage of computer system 101 is below a threshold percentage and/or if the battery level of computer system 101 is above a threshold level. As another example, an action to activate an output device (e.g., a flashlight, a haptic output device, and/or speaker) of computer system 101 can be executed if the physical temperature of computer system 101 is below a threshold temperature. In some examples, some actions do not have any preconditions. By considering the preconditions, planning module 1118 can generate a plan 1120 that includes actions that can be performed given the current (or future) states of various devices and that excludes actions that cannot be performed given the current (or future) states of various devices. In some examples, contextual state information 1113, described above, provides the information (e.g., device state information) that allows planning module 1118 to determine whether an action can be performed.

In some examples, action data 1124 specifies one or more predicted effects that respectively result from performing an action (e.g., each action) of the different actions. The predicted effects can be on the user, on computer system 101, and/or on the 3D scene. As one example, an action to turn on a flashlight of an external device that is proximate to computer system 101 has the predicted effect of the flashlight being turned on. As another example, an action to instruct the user to perform a task (e.g., turning on a handheld flashlight) has the predicted effect of the user performing the task (e.g., turning on the handheld flashlight). As another example, an action to provide information to the user has the predicted effect of the user knowing the information. As another example, an action to perform a certain function using a certain application has a predicted effect of increasing CPU usage by a predicted percentage and/or depleting computer system 101's battery level by a certain amount. By considering the predicted effects, planning module 1118 can generate a plan 1120 in which the effect of performing a previous action does not violate a precondition for performing a later action. Further, as discussed in detail below with respect to state matching module 1130, planning module 1118 can use the predicted effects to determine the different predicted scene states 1140 that respectively result from performing the actions of plan 1120.

Planning unit 370 includes action filtering module 1126. Action filtering module 1126 is configured to filter action data 1124 to determine filtered action data 1125. Filtered action data 1125 includes a selected subset (e.g., portion) of action data 1124, e.g., corresponds to a selected portion of the set of instructions. In some examples, filtered action data 1125 specifies the parameters, preconditions, and/or effects associated with the selected portion of the set of instructions.

In some examples, action filtering module 1126 filters action data 1124 based on scene state 1116 (e.g., that includes scene state information 1108, contextual state information 1113, and/or context information 1110) and/or based on goal data 1122. In some examples, action filtering module 1126 implements an AI model (e.g., an LLM) that is configured to filter action data 1124. The AI model is based on (e.g., is, or is constructed from) a foundation model, as discussed above with respect to FIG. 4. In some examples, action filtering module 1126 generates a prompt for the AI model to select a portion of action data 1124, given scene state 1116 and goal data 1122. An example prompt is “select a portion of these actions [A] that may be relevant to assisting the user with the goal of [X], given that the scene is described by [Y]” where [A] represents action data 1124 (e.g., includes names of the actions performable by the computer system), [X] represents goal data 1122, and [Y] represents scene state 1116. Action filtering module 1126 can allow planning module 1118 to more accurately and efficiently generate plan 1120 by reducing the amount of action data 1124 based upon which plan 1120 can be generated.

Continuing with the power outage example above, filtered action data 1125 includes the following actions that are predicted as relevant to restoring power to the user's home:
Search the Internet.
Search for data that is local to the computer system.
Instruct the user to perform a task.
Output information to the user.
Control a device that is external to the computer system.
Determine whether a condition associated with the 3D scene is satisfied.
Wait for a condition associated with the 3D scene to be satisfied.
Perform an action once a condition associated with the 3D scene is satisfied.
Perform an action once a condition associated with the 3D scene is not satisfied.

Action filtering module 1126 is an optional component of planning unit 370. Thus, in some examples, planning unit 370 does not filter action data 1124 and planning module 1118 generates plan 1120 based on action data 1124 instead of filtered action data 1125.

Constraint data 1132 corresponds to a constraint on a parameter associated with the computer system. Example parameters include battery usage, CPU usage, memory usage, the amount of data transmitted to a service external to computer system 101, number of user inputs (e.g., the amount of user feedback) required to execute plan 1120, and the like. Based on constraint data 1132, planning module 1118 generates plan 1120 that, when executed, satisfies one or more constraints on one or more parameters. Example constraints include to not deplete more than a predetermined amount of battery level, to not exceed a predetermined amount of CPU usage, to not exceed a predetermined amount of memory usage, to not transmit more than a threshold amount of data as part of executing plan 1120, and to not require more than a predetermined number of user inputs to execute the plan. In some examples, a user-configurable setting of computer system 101 specifies constraint data 1132. In some examples, an operating system of computer system 101 specifies constraint data 1132. Constraint data 1132 can therefore enable computer system 101 to generate and execute plan 1120 without consuming excessive system resources and/or without violating predetermined rules/preferences.

Objective function 1134 corresponds to an instruction to optimize (e.g., minimize or maximize) a parameter associated with computer system 101. Example parameters for optimization include the parameters discussed above with respect to constraint data 1132. Based on objective function 1134, planning module 1118 generates plan 1120 that, when executed, optimizes one or more particular parameters (and, optionally, does not optimize other parameter(s)). For example, based on objective function 1134, plan 1120 minimizes the number of user inputs required for execution, despite that execution of such plan 1120 may result in a relatively large amount of CPU usage. In some examples, a user-configurable setting of computer system 101 specifies objective function 1134. In some examples, an operating system of computer system 101 specifies objective function 1134. Objective function 1134 can therefore enable optimization of plan 1120 according to predetermined preferences/requirements.

In some examples, planning unit 370 dynamically adjusts constraint data 1132 and/or objective function 1134 based on a current state of computer system 101. For example, when the battery level of computer system 101 is below a threshold level (e.g., 20% or 10%), constraint data 1132 specifies to not use more than a predetermined amount of battery level and/or objective function 1134 corresponds to an instruction to minimize battery usage. As another example, when the CPU usage of computer system 101 is above a threshold level (e.g., due to the execution of other operations), constraint data 1132 specifies to not exceed more than predetermined amount of CPU usage and/or objective function 1134 corresponds to an instruction to minimize CPU usage.

In some examples, planning module 1118 includes an AI model (e.g., an LLM) that is configured (e.g., trained) to generate plan 1120. The AI model is based on (e.g., is, or is constructed from) a foundation model, as discussed above with respect to FIG. 4. In some examples, planning module 1118 generates plan 1120 by prompting the AI model to solve an automated planning problem. Planning module 1118 generates the automated planning problem based on at least some of scene data 1116 (e.g., scene state information 1108, contextual state information 1113, and/or context information 1110), goal data 1122, action data 1124 (e.g., filtered action data 1125), constraint data 1132, and objective function 1134. Continuing with the power outage example above, an example prompt for a generated automated planning problem is:
Generate a valid computer-executable plan to assist the user with handling a power outage given that the user is in a world described by [X].
The plan is constrained by [Y] and the plan must optimize [Z].
The plan must include computer-executable instructions for performing one or more actions selected from [A] and must specify values for the parameters for the instructions.
[B] specifies the preconditions required to perform each of the actions.
[C] specifies the effect of performing each of the actions.
For an action to be included in the plan, the preconditions for the action must be satisfied.
You must use the specified effect of performing each selected action to ensure than the plan is constrained by [Y], to ensure that the plan optimizes [Z], and to ensure that the effect of a performing previous action in the plan does not violate the precondition for performing a later action in the plan.

where [X] represents scene state 1116, [Y] represents constraint data 1132, [Z] represents objective function 1134, [A] represents the (optionally, filtered) actions of action data 1124 (e.g., the names of different actions), [B] represents the preconditions required to perform the actions, and [C] represents the effects of performing the actions. In some examples, planning module 1118 generates plan 1120 without using context information 1110, contextual state information 1113, filtered action data 1125, the preconditions of the actions, the effects of the actions, constraint data 1132, and/or objective function 1134. Further, while the example prompt is in natural language format, it will be appreciated that the prompt to the AI model can be in another format, or be in a combination of natural language format and other format(s). For example, the prompt includes a combination of natural language and data (e.g., as represented by [X], [Y], [Z], [A], [B], and/or [C]) in a structured format, e.g., JSON or XML.

When the goal is to maintain scene state 1116, plan 1120 corresponds to continuing default operation of computer system 101 (or plan 1120 is not generated). In some examples, planning module 1118 implements a rule specifying that if the goal is to maintain scene state 1116, then the AI model is not used to generate plan 1120.

As illustrated in FIGS. 13A-13B, 14A-14C, and 15A-15B below, computer system 101 is configured to execute plan 1120 by performing at least some of the selected action(s), e.g., by executing the instruction(s) that correspond to at least some of the action(s). Example actions include any of the actions described above with respect to action data 1124, e.g., instructing the user to perform an action, changing a setting of computer system 101, controlling a device external to computer system 101, launching an application, initiating a search for information, etc. In some examples, a provided output instructs the user to perform an action that computer system 101 cannot perform, such as physically moving to another location, obtaining an object, and/or controlling a device that computer system 101 is not configured to control.

Continuing with the power outage example above, planning module 1118 generates plan 1120 to assist the user with restoring power to their home. The plan corresponds to (e.g., includes computer-executable instructions for) performing the following sequence of actions:
Turn on the flashlight of the user's smartphone.
After turning on the flashlight of the user's smartphone, instruct the user to find their handheld flashlight and output the location of the handheld flashlight.
Once the user finds their handheld flashlight, instruct the user to turn the handheld flashlight on.
Once the user turns the handheld flashlight on, output the location of the generator and instruct the user to start the generator.

In some examples, planning unit 370 includes symbolic planning module 1128. Symbolic planning module 1128 is configured to implement planning techniques to validate plan 1120, e.g., to check if generated plan 1120 will transition scene state 1116 to at least one goal state. Symbolic planning module 1128 implements various planning techniques that are known in the art, e.g., FastDownward and/or publicly available planners made available via previous International Planning Competitions (IPCs) (e.g., IPC 2023). In some examples, before plan 1120 is validated, planning module 1118 converts plan 1120, scene data 1116, and goal data 1122 into a format (e.g., symbolic logic) that is interpretable by the planning techniques of symbolic planning module 1128. In some examples, computer system 101 executes plan 1120 if symbolic planning module 1128 validates the plan 1120. In some examples, if symbolic planning module 1128 does not validate plan 1120 (e.g., because plan 1120 is determined not to achieve at least one goal state), symbolic planning module 1128 causes planning module 1118 to re-generate plan 1120, e.g., by repeating the techniques discussed above using the most up-to-date inputs (e.g., sensor data 1102, user attention data 1104, context information 1110, goal data 1122, action data 1124, constraint data 1132, and/or objective function 1134).

In some examples, symbolic planning module 1128 is configured to generate plan 1120. For example, instead of prompting an AI model to generate plan 1120 (as described above), planning module 1118 prompts the AI model to generate a planning problem based on the above-described input data to planning module 1118. Planning module 1118 then provides the planning problem to symbolic planning module 1128 for generation of plan 1120. In some examples, the planning problem and plan 1120 form a problem-solution pair that is used as training data to fine-tune the AI model of planning module 1118. By training the AI model using such generated problem-solution pairs, the AI model can adapt to more accurately generate plans that satisfy the respective goals of different input goal data 1122.

Planning module 1118 is further configured to determine predicted scene state 1140 of a 3D scene. When plan 1120 corresponds to assisting the user with transitioning scene state 1116 to a different goal state, predicted scene state 1140 represents an update to scene state 1116 that results from executing one or more instructions of plan 1120. When plan 1120 corresponds to maintaining scene state 1116 (e.g., when plan 1120 corresponds to continuing default operation of computer system 101), or when plan 1120 is not generated, predicted scene state 1140 is scene state 1116 (e.g., corresponds to a prediction that scene state 1116 will be maintained). Similar to scene state 1116, predicted scene state 1140 includes a description (e.g., a natural language description) of various predicted information associated with the 3D scene.

When plan 1120 corresponds to assisting the user with transitioning scene state 1116 to a different goal state, planning module 1118 determines predicted scene state 1140 based on scene state 1116 and the effects (discussed above) of performing the actions of plan 1120. In some examples, planning module 1118 determines (e.g., updates) each predicted scene state 1140 that respectively results from performance of each action of the plan (e.g., the execution of each respective instruction of the plan). In some examples, planning module 1118 prompts the AI model to determine each predicted scene state 1140 by generating a prompt to simulate the expected results of executing plan 1120, given the initial scene state 1116 and the effect(s) of executing each respective action of plan 1120.

For example, continuing with the power outage example above, the action of turning on the flashlight of the user's smartphone results in predicted scene state 1140 that includes:
The flashlight of the user's smartphone is on.

The next action of instructing the user to find their handheld flashlight and outputting the location of the handheld flashlight results in predicted scene state 1140 that includes:
The user knows the location of the handheld flashlight.
The user is finding the handheld flashlight.

The next action of instructing the user to turn on the handheld flashlight once the user finds the handheld flashlight results in predicted scene state 1140 that includes:
The user has turned on the handheld flashlight.

The next action of outputting the location of the generator and instructing the user to start the generator (once the user turns the handheld flashlight on) results in predicted scene state 1140 that includes:
The user knows where the generator is.
The user is starting the generator.

Planning unit 370 includes state matching module 1130. State matching module 1130 is configured to determine whether a current scene state (e.g., that is determined after execution of an instruction of plan 1120) (e.g., 1116-1 and 1116-2 in FIGS. 11B-11D below) matches predicted scene state 1140 (e.g., that is predicted to result from execution of the instruction). A mismatch between the current scene state and predicted scene state 1140 may indicate that plan 1120 is not executing as predicted/intended to achieve the goal, e.g., due to the user not following plan 1120 and/or due to other events that occur within the 3D scene. As discussed below with respect to FIGS. 11B-11D, 12, 13A-13B, 14A-14C, and 15A-15B, if determined that the current scene state does not match predicted scene state 1140, planning unit 370 may perform one or more actions to attempt to correct the discrepancy and/or re-generate (e.g., update) plan 1120.

Generally, state matching module 1130 determines whether a current scene state matches predicted scene state 1140 based on a mismatch between various values for various parameters (e.g., brightness of the 3D scene, location of the 3D scene, objects present in the 3D scene, an action the user is performing within the 3D scene, audio level within the 3D scene, predicted facts about the 3D scene, and the like) that respectively define the scene states. In some examples, state matching module 1130 implements an AI model (e.g., an LLM) that is configured to determine whether the current scene state matches predicted scene state 1140. The AI model is based on (e.g., is, or is constructed from) a foundation model, as described above with respect to FIG. 4. In some examples, state matching module 1130 prompts the AI model to determine whether the current scene state (that is determined after execution of an instruction of plan 1120) matches predicted scene state 1140 (that is predicted to result from execution of the instruction), given previous scene state 1116 (that was previously determined before execution of the instruction). An example prompt is “provide a yes or no answer about whether the current observed state of the world substantially matches the predicted state of the world, given the last observed state of the world. The current observed state of the world is described by [X], the predicted state of the world is described by [Y], and the last observed state of the world is described by [Z],” where [X] represents the current scene state (e.g., 1116-1 or 1116-2), [Y] represents predicted state 1140, and [Z] represents previous scene state 1116.

In some examples, state matching module 1130 is adjusted (e.g., the AI model is tuned) to control the degree to which the current scene state and predicted scene state 1140 are required to match each other. In some examples, the prompt is modified to control the degree to which the current scene state and predicted scene state 1140 are required to match each other. Thus, in some examples, the current scene state and predicted scene state 1140 are not required to exactly match each other for state matching module 1130 to determine that the two states match each other.

FIGS. 11B-11D illustrate various operations performed by planning unit 370, according to some examples. In FIGS. 11B-11D, the hyphenated reference numbers (e.g., 1102-1, 1102-2, 1104-1, 1104-2, and so on) refer to other instances of the element labeled by the corresponding unhyphenated reference number. For example, elements 1102, 1102-1, and 1102-2 refer to different instances of sensor data, elements 1104, 1104-1, and 1104-2 refer to different instances of user attention data, and so on. It will be appreciated that the above description of an unhyphenated reference number (e.g., 1102, 1104, and so on) applies analogously to the corresponding hyphenated reference number(s) (e.g., 1102-1 and 1102-2, 1104-1 and 1104-2, and so on). FIGS. 11B-11D are now discussed in conjunction with FIG. 12.

FIG. 12 illustrates process 1200 for monitoring and adapting the execution of plan 1120, according to some examples. As described below, process 1200 includes performing various actions when a current scene state does not match predicted scene state 1140. Process 1200 is governed by instructions that are included in planning unit 370 and that are executed by one or more processors of a computer system (e.g., computer system 101). Some operations in process 1200 are, optionally, combined, the orders of some operations are, optionally, changed, and some operations are, optionally, omitted. For example, as detailed below, steps, 1208, 1210, 1212, 1214, and/or 1216 are optionally omitted from process 1200.

At step 1202, a plan (e.g., 1120) is initiated (e.g., at least a portion of the instructions of the plan are executed).

At step, 1204 current scene state 1116-1 (FIG. 11B) is determined. FIG. 11B illustrates that determining current scene state 1116-1 includes repeating the above-described processes for determining scene state 1116, e.g., determining scene state information 1108-1 based on the latest sensor data 1102-1 (and optionally the latest user attention data 1104-1) and optionally, filtering the latest context information 1110-1 to determine contextual state information 1113-1 and combining scene state information 1108-1 with contextual state information 1113-1. In some examples, current scene state 1116-1 is determined (e.g., updated) periodically, e.g., once every 1 second, once every 5 seconds, once every 30 seconds, and/or once every minute. In some examples, current scene state 1116-1 is determined after the performance of an action (e.g., each action) in plan 1120 (e.g., in response to the execution of the instruction corresponding to the action) and before performance of the next action in plan 1120. In some examples, current scene state 1116-1 is determined in response to receiving a natural language input.

At step 1206, it is determined (e.g., by state matching module 1130 in FIG. 11B) whether current scene state 1116-1 matches predicted scene state 1140. If current scene state 1116-1 matches predicted scene state 1140, process 1200 returns to step 1202 and plan 1120 continues to execute. A determination that current scene state 1116-1 matches predicted scene state 1140 can indicate that plan 1120 is executing as predicted/intended to achieve the goal, so plan 1120 can continue to execute if current scene state 1116-1 matches predicted scene state 1140.

If current scene state 1116-1 does not match predicted scene state 1140, at step 1208, a parameter of a sensor device is changed. In some examples, the sensor device is a sensor device using which sensor data 1102-1 is captured (e.g., is a sensor device that captures sensor data that is used to determine current scene state 1116-1). In some examples, the sensor device is a new sensor device (e.g., an image sensor, an audio sensor, or a motion sensor) that was not previously used to capture sensor data 1102-1 (e.g., is a new sensor device whose data was not used to determine current scene state 1116-1). In some examples, changing the parameter of the sensor device includes adjusting (e.g., increasing or decreasing) the sampling rate (e.g., frames per second) of the sensor device. In some examples, changing the parameter of the sensor device includes activating (e.g., turning on) the sensor device so that the sensor device begins to capture sensor data. In some examples, changing the parameter of the sensor device includes changing a duty cycle of the sensor device, e.g., changing the period for which the sensor device is active (e.g., capturing data) and/or changing the period of which the sensor device is inactive (e.g., not capturing data). In some examples, step 1208 includes changing other parameter(s) of the sensor device, e.g., focus, aperture, shutter speed, physical position, physical orientation (e.g., the direction the sensor device faces), sensitivity, and the like.

At step 1210, while the parameter of the sensor device is changed, sensor data 1102-2 (FIG. 11C) is detected (e.g., captured) with at least the sensor device.

At step 1212, updated scene state 1116-2 is determined based on sensor data 1102-2. FIG. 11C illustrates that determining updated scene state 1116-2 includes repeating the above-described processes for determining scene state 1116, e.g., determining scene state information 1108-2 based on the latest sensor data 1102-2 (and optionally the latest user attention data 1104-2) and optionally, filtering the latest context information 1110-2 to determine contextual state information 1113-2 and combining scene state information 1108-2 with contextual state information 1113-2.

At step 1214, it is determined (e.g., by state matching module 1130 in FIG. 11C) whether updated scene state 1116-2 matches predicted scene state 1140. If updated scene state 1116-2 matches predicted scene state 1140, process 1200 proceeds to step 1202 and plan 1120 continues execution. Accordingly, a determination that updated scene state 1116-2 matches predicted scene state 1140 can indicate that the discrepancy between the scene states is due to how the sensor devices capture data that represents the 3D scene (e.g., how computer system 101 perceives the 3D scene), and not necessarily due to a problem with generated plan 1120. As an example, suppose predicted scene state 1140 includes the user holding an object, but image data for current scene state 1116-1 (at step 1204) does not depict the user holding the object. The image data does not depict the user holding the object because the sampling rate of the image sensor is insufficiently fast to capture image data that depicts the user holding the object, e.g., because the user started to hold the object after the last time image data was captured. By increasing the sampling rate of the image sensor, the image data is refreshed to depict the user holding the object. Thus, updated scene state 1116-2 (that is determined based on the refreshed image data) now indicates that the user is holding the object and updated scene state 1116-2 now matches predicted scene state 1140.

If updated scene state 1116-2 does not match predicted scene state 1140, at step 1216, action data 1124 is filtered to determine filtered action data 1125-1 (FIG. 11D). FIG. 11D illustrates that filtering action data 1124 includes repeating the processes discussed above with respect to action filtering module 1126. Specifically, action filtering module 1126 filters action data 1124 based on goal data 1122 and/or updated scene state 1116-2 (e.g., that includes scene state information 1108-2, contextual state information 1113-2, and/or context information 1110-2).

At step 1218, plan 1120-1 (FIG. 11D) is generated. Plan 1120-1 represents an update to previously generated plan 1120. FIG. 11D illustrates that planning module 1118 generates plan 1120-1 according to the techniques discussed above with respect to generating plan 1120. Specifically, planning module 1118 generates plan 1120-1 based on at least some of: updated scene state 1116-2 (e.g., scene state information 1108-2, contextual state information 1113-2, and/or context information 1110-2), goal data 1122, action data 1124 (e.g., optional filtered action data 1125-1 if optional step 1216 is performed), constraint data 1132-1, and objective function 1134-1.

Steps 1216 and 1218 demonstrate that if updated scene state 1116-2 does not match predicted scene state 1140, the discrepancy between the scene states may be due to a problem with generated plan 1120, as opposed to a problem with how computer system 101 perceives the 3D scene. Accordingly, steps 1216 and 1218 are performed to attempt to re-generate a plan 1120-1 that may better assist the user with accomplishing their goal, e.g., transitioning updated scene state 1116-2 to at least one goal state that satisfies the goal.

In some examples, if current scene state 1116-1 does not match predicted scene state 1140 (as determined at step 1206), process 1200 proceeds directly to step 1216 and omits steps 1208, 1210, 1212, and 1214. In some examples, process 1200 proceeds directly to step 1216 when it is unlikely that the discrepancy between the scene states is due to how the computer system perceives the 3D scene. For example, process 1200 proceeds directly to step 1216 if all available sensors of the computer system are active (e.g., capturing data) and/or if an image sensor is capturing image data with a maximum sampling rate. As another example, process 1200 proceeds directly to step 1216 if current scene state 1116-1 is based on a natural language input that indicates an error in plan 1120, e.g., “this does not help me.”

Planning unit 370 can use the steps of process 1200 to monitor and/or adapt the execution of plan 1120 in various different manners. In one example, planning unit 370 implements an online planning approach. Specifically, plan 1120 executes one or more steps at a time (e.g., potentially without executing the entire plan 1120) and step 1204 (and the following steps of FIG. 12) are performed in response to the performance of each action in plan 1120 (and before performance of the subsequent action). In this manner, planning unit 370 can combine planning and plan execution by monitoring the execution of plan 1120 and by advancing plan 1120 to a next step based on a determination that a previous step was successful (e.g., a positive determination at step 1206 and/or 1214). Further, the determination of a plan failure event (e.g., due to a scene state discrepancy determined at step 1206 and/or 1214, due to receiving user input that indicates an error in plan 1120, and/or due to the failure to perform an action) results in the performance of various corrective actions, as discussed above with respect to FIG. 12. In another example, planning unit 370 implements an offline planning approach. Specifically, planning and plan execution are separated, so plan 1120 executes until a plan completion event is determined (e.g., until the final action of the plan is performed, until a determined scene state matches a final predicted scene state, and/or until computer system 101 receives a user input that indicates completion of plan 1120) or until a plan failure event is determined (e.g., until a negative determination is made at step 1206 and/or 1214, until an action of plan 1120 fails to be performed, and/or until computer system 101 receives user input that indicates an error). When a plan failure event is determined, planning unit 370 re-plans (e.g., by performing optional step 1216 and by performing step 1218) to generate plan 1120-1 based on the most current input data.

FIGS. 13A-13B, 14A-14C, and 15A-15B illustrate the execution of various different plans that are generated to assist a user with respect to a 3D scene, according to some examples. FIGS. 13A-13B, 14A-14C, and 15A-15B are used to illustrate the principles discussed above with respect to FIGS. 11A-11D and 12.

FIGS. 13A-13B, 14A-14C, and 15A-15B illustrate a user's view of respective 3D scenes. In some examples, device 1300 provides at least a portion of the scenes of FIGS. 13A-13B, 14A-14C, and 15A-15B. For example, the scenes are XR scenes that include at least some virtual elements generated by device 1300. In other examples, the scenes are physical scenes.

Device 1300 implements at least some of the components of computer system 101. For example, device 1300 includes one or more sensors configured to detect data (e.g., image data, audio data, and/or motion data) corresponding to the respective scenes. In some examples, device 1300 is an HMD (e.g., an XR headset or smart glasses) and FIGS. 13A-13B, 14A-14C, and 15A-15B illustrate the user's view of the respective scenes via the HMD. For example, FIGS. 13A-13B, 14A-14C, and 15A-15B illustrate physical scenes viewed via pass-through video, physical scenes viewed via direct optical see-through, or virtual scenes viewed via one or more displays of the HMD. In other examples, device 1300 is another type of device, such as a smart watch, a smart phone, a pair of headphones or earbuds, a tablet device, a laptop computer, or a projection-based device.

The examples of FIGS. 13A-13B, 14A-14C, and 15A-15B illustrate that the user and device 1300 are present within the respective scenes. For example, the scenes are physical or extended reality scenes and the user and device 1300 are physically present within the scenes. In other examples, an avatar of the user is present within the scenes. For example, when the scenes are virtual reality scenes, the avatar of the user is present within the virtual reality scenes.

In FIG. 13A, a power outage event has occurred and device 1300 is executing the above-described plan 1120 to assist the user with the power outage event (e.g., step 1202 of FIG. 12). As described above, plan 1120 corresponds to the actions of:
Turning on the flashlight of the user's smartphone.
After turning on the flashlight of the user's smartphone, instruct the user to find their handheld flashlight and output the location of the handheld flashlight.
Once the user finds their handheld flashlight, instruct the user to turn the handheld flashlight on.
Once the user turns the handheld flashlight on, output the location of the generator and instruct the user to start the generator.

In FIG. 13A, device 1300 has performed the first and second actions of plan 1120 by turning on the flashlight of the user's smartphone (not illustrated) and by instructing the user to find their handheld flashlight (not illustrated). Accordingly, in FIG. 13A, the user holds handheld flashlight 1302 in their hand and device 1300 performs the third action of plan 1120 by providing audio output 1304 “now turn the flashlight on.” Performing the third action of plan 1120 results in predicted scene state 1140 that includes:
The user has turned on their handheld flashlight.

In FIG. 13B, the user has turned on handheld flashlight 1302, as indicated by light 1308. Device 1300 captures sensor data 1102-1 (e.g., image data) for the scene of FIG. 13B. Based on sensor data 1102-1 and context information 1110-1, combination module 1114 determines current scene state 1116-1 (e.g., step 1204 of FIG. 12). Current scene state 1116-1 includes:
It is 10:31 PM.
The user is holding a handheld flashlight.
The handheld flashlight is on.
The user typically keeps a gas lamp in their garage.
The user typically keeps a generator in their basement.
The user was previously instructed to turn on their handheld flashlight.

In FIG. 13B, state matching module 1130 determines that current scene state 1116-1 matches predicted scene state 1140 (e.g., step 1206 of FIG. 12), e.g., as handheld flashlight 1302 is turned on. As a result, plan 1120 continues execution (e.g., step 1202 of FIG. 12) and in FIG. 13B, device 1300 executes the final step of plan 1120 by providing audio output 1306 “Now let's turn on your generator. It was last seen in your basement.”

As an alternative to the above description of FIG. 13B, consider that in FIG. 13B, the user has turned handheld flashlight 1302 on. However, the sampling rate of the image sensor of device 1300 is insufficiently fast, so sensor data 1102-1 does not depict that handheld flashlight 1302 is turned on. Instead, sensor data 1102-1 depicts a previous state of the 3D scene, e.g., depicts that the handheld flashlight is in a drawer and is turned off. Accordingly, based on sensor data 1102-1 and context information 1110-1, combination module 1114 determines current scene state 1116-1 (e.g., step 1204 of FIG. 12) to include:
It is 10:31 PM.
The handheld flashlight is in a drawer
The handheld flashlight is off.
The user typically keeps a gas lamp in their garage.
The user typically keeps a generator in their basement.
The user was previously instructed to turn on their handheld flashlight.

State matching module 1130 further determines that current scene state 1116-1 does not match predicted scene state 1140 (e.g., step 1206 of FIG. 12), e.g., as handheld flashlight 1302 is perceived to be turned off.

Because current scene state 1116-1 is determined to not match predicted scene state 1140, device 1300 increases the sampling rate of the image sensor (e.g., from 1 frame every minute to 1 frame every second) (e.g., step 1208 of FIG. 12). While the sampling rate of the image sensor is increased, device 1300 captures sensor data 1102-2 using the image sensor (e.g., step 1210) of FIG. 12. Newly captured sensor data 1102-2 now accurately depicts the scene of FIG. 13B, e.g., depicts that the user holds handheld flashlight 1302 and that handheld flashlight 1302 is turned on. Based on newly captured sensor data 1102-2 and context information 1110-2, combination module 1114 determines updated scene state 1116-2 (e.g., step 1212 of FIG. 12) to include:
It is 10:32 PM.
The user is holding a handheld flashlight.
The handheld flashlight is on.
The user typically keeps a gas lamp in their garage.
The user typically keeps a generator in their basement.
The user was previously instructed to turn on their handheld flashlight.

State matching module 1130 determines that updated scene state 1116-2 matches predicted scene state 1140 (e.g., step 1214 of FIG. 12), e.g., as handheld flashlight 1302 is turned on. As a result, plan 1120 continues execution (e.g., step 1202 of FIG. 12) and in FIG. 13B, device 1300 executes the final step of plan 1120 by providing audio output 1306 “Now let's turn on your generator. It was last seen in your basement.”

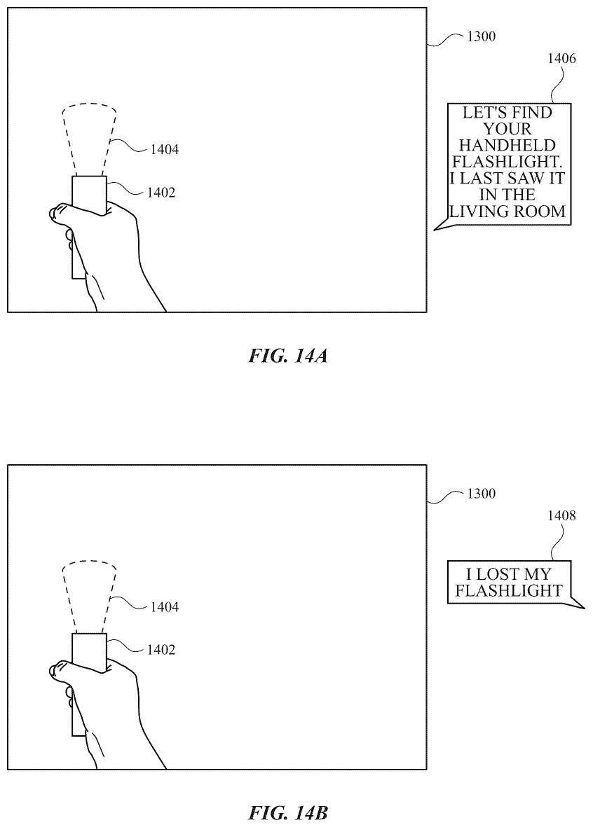

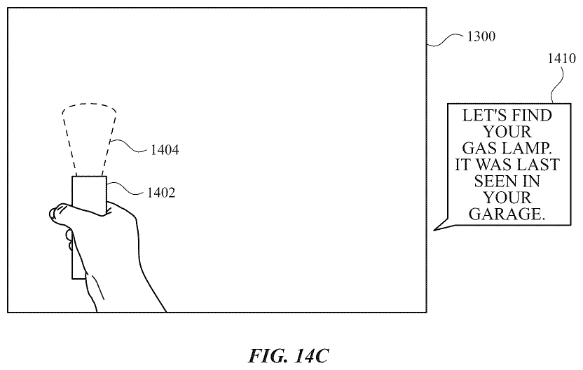

In FIG. 14A, similar to FIG. 13A, a power outage event has occurred and device 1300 is executing the same above-described plan 1120 to assist the user with the power outage event (e.g., step 1202 of FIG. 12). As described above, plan 1120 corresponds to the actions of:
Turning on the flashlight of the user's smartphone.
After turning on the flashlight of the user's smartphone, instruct the user to find their handheld flashlight and output the location of the handheld flashlight.
Once the user finds their handheld flashlight, instruct the user to turn the handheld flashlight on.
Once the user turns the handheld flashlight on, output the location of the generator and instruct the user to start the generator.

In FIG. 14A, device 1300 has performed the first action of plan 1120 by turning on the flashlight of the user's smartphone 1402, as indicated by light 1404. In FIG. 14A, device 1300 performs the second action of plan 1120 by providing audio output 1406 “Let's find your handheld flashlight. Your handheld flashlight was last seen in a drawer in your dining room.” Performing the second action of plan 1120 results in predicted scene state 1140 that includes:
The user knows the location of the handheld flashlight.
The user is finding their handheld flashlight.

In FIG. 14B, after device 1300 provides audio output 1406, device 1300 detects sensor data 1102-1 that includes the user's speech input 1408 “I lost my handheld flashlight.” Based on sensor data 1102-1 and context information 1110-1, combination module 1114 determines current scene state 1116-1 (e.g., step 1204 of FIG. 12) to include:
It is 10:31 PM
The user lost their handheld flashlight
The user was previously instructed to find their handheld flashlight.
The user typically keeps a gas lamp in their garage.
The user typically keeps a generator in their basement.

State matching module 1130 determines that current scene state 1116-1 does not match predicted scene state 1140 (e.g., step 1206 of FIG. 12), e.g., as the user was predicted to be finding their handheld flashlight, but the user lost their handheld flashlight. As a result, action filtering module 1126 filters action data 1124 based on current scene state 1116-1 and/or goal data 1122 to determine filtered action data 1125-1 (e.g., step 1206 of FIG. 12 proceeds directly to step 1216 of FIG. 12). Filtered action data 1125-1 corresponds to selected actions that are predicted to be relevant to assisting the user with the power outage. Planning module 1118 further generates plan 1120-1 (e.g., an update to plan 1120) (e.g., step 1218 of FIG. 12) to assist the user with the power outage based on at least current scene state 1116-1, filtered action data 1125-1, and goal data 1122. Plan 1120-1 corresponds to the actions of:
Instruct the user to find their gas lamp and output the location of the gas lamp.
Once the user finds their gas lamp, instruct the user to turn on their gas lamp.
Once the user turns on their gas lamp, output the location of the generator and instruct the user to start the generator.

In FIG. 14C, device 1300 executes newly generated plan 1120-1 by providing audio output 1410 “Let's find your gas lamp. It was last seen in your garage.” FIGS. 14A-14C demonstrate that device 1300 can adapt to resolve problems with original plan 1120 by generating a new plan 1120-1 (e.g., that corresponds to turning on a gas lamp instead of a handheld flashlight) that may better assist the user with accomplishing their goal.

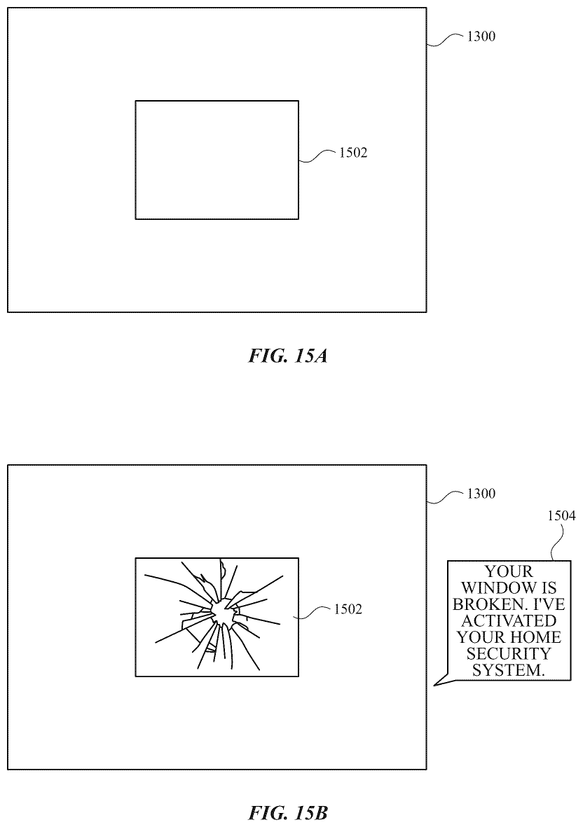

In FIG. 15A, the scene includes a user who is sitting relatively still in a quiet living room with window 1502. The image sensor(s) of device 1300 are deactivated (e.g., not capturing image data) and the motion sensor(s) and the audio sensor(s) of device 1300 are activated (e.g., capturing data). Device 1300 captures sensor data 1102 with the activated sensors and perception module 1106 determines scene state 1116 to include the following:
The user sitting or standing still.
The environment is quiet.

Further, based on sensor data 1102, event detection module 508 does not detect any event that is sufficiently relevant to assist the user with. Thus, plan 1120 corresponds to instructions for device 1300 to continue default operation (e.g., step 1202 of FIGS. 12) and predicted scene state 1140 is that scene state 1116 will be maintained. Accordingly, predicted state 1140 also includes:
The user sitting or standing still.
The environment is quiet.

In FIG. 15B, window 1502 breaks, resulting in a loud noise and the user starting to move about. Device 1300 captures sensor data 1102-1 with the activated motion sensor(s) and the activated audio sensor(s). Based on sensor data 1102-1, perception module 1106 determines current scene state 1116-1 (e.g., step 1204 of FIG. 12) to include the following:
The user is moving about.
A loud noise was detected.

After current scene state 1116-1 is determined, state matching module 1130 determines that current scene state 1116-1 does not match predicted scene state 1140 (e.g., step 1206 of FIG. 12). As a result, device 1300 activates the image sensor(s) (e.g., step 1208 of FIG. 12) and device 1300 captures sensor data 1102-2 with the newly activated image sensor(s), the previously activated motion sensor(s), and the previously activated audio sensor(s) (e.g., step 1210 of FIG. 12). Based on sensor data 1102-2, perception module 1106 determines updated scene state 1116-2 to include the following:
The user is moving about.
A loud noise was detected.
A window is broken.

Further, based on sensor data 1102-2, event detection module 508 detects the event of a broken window and planning unit 370 determines goal data 1122. Goal data 1122 represents the goal of assisting the user with broken window 1502.

State matching module 1130 determines that updated scene state 1116-2 does not match predicted scene state 1140 (e.g., step 1214 of FIG. 12). Thus, action filtering module 1126 filters action data 1124 (e.g., step 1216 of FIG. 12) to determine filtered action data 1125-1 based on goal data 1122 and/or updated scene state 1116-2, e.g., to select actions that are predicted to be relevant to assisting the user with broken window 1502. Then, planning module 1118 generates plan 1120-1 to assist the user with broken window 1502 (e.g., step 1218 of FIG. 12) based on at least some of goal data 1122, updated scene state 1116-2, and filtered action data 1125-1. Plan 1120-1 corresponds to the actions of:
Inform the user that their window is broken.
Activate a home security system.
After activating the home security system, inform the user that the home security system has been activated.

In FIG. 15B, device 1300 executes plan 1120-1 by triggering the user's home security system and by providing audio output 1504 “Your window is broken. I've activated your home security system.”

Additional descriptions regarding FIGS. 11A-11D, 12, 13A-13B, 14A-14C, and 15A-15B are provided below in reference to method 1600 described with respect to FIG. 16 and method 1700 described with respect to FIG. 17.

FIG. 16 is a flow diagram of a method 1600 for executing a plan to assist a user with respect to a 3D scene, according to some examples. In some examples, method 1600 is performed at a computer system (e.g., computer system 101 in FIG. 1) that is in communication with one or more sensor devices (e.g., image sensors, light sensors, depth sensors, tactile sensors, orientation sensors, proximity sensors, temperature sensors, location sensors, motion sensors, velocity sensors, audio sensors, and/or biometric sensors). In some examples, method 1600 is governed by instructions that are stored in a non-transitory (or transitory) computer-readable storage medium and that are executed by one or more processors of a computer system, such as the one or more processors 302 of computer system 101 (e.g., controller 110 in FIG. 1). In some examples, the operations of method 1600 are distributed across multiple computer systems, e.g., a computer system and a separate server system. Some operations in method 1600 are, optionally, combined, the orders of some operations are, optionally, changed, and some operations are, optionally, omitted.

At block 1602, first data (e.g., 1102) is detected (e.g., received or captured) via the one or more sensor devices.

At block 1606, in response to (1604) detecting, via the one or more sensor devices, the first data and after (1604) a state of a three-dimensional (3D) scene (e.g., 1116 and/or 1108) associated with the computer system is determined based on the first data: it is determined (e.g., by planning module 1118) whether a computer-executable plan (e.g., 1120) is generated and whether the computer-executable plan satisfies a first set of criteria. In some examples, the first set of criteria include a criterion that is satisfied when the computer-executable plan is a top ranked computer-executable plan. In some examples, the first set of criteria include a criterion that is satisfied when the computer-executable plan has a confidence score that exceeds a threshold. In some examples, the first set of criteria include a criterion that is satisfied when the computer-executable plan is generated by an AI model (e.g., as discussed with respect to planning module 1118). The computer executable plan (e.g., 1120) is generated based on: the state of the 3D scene (e.g., 1116 and/or 1108); first action data (e.g., 1124 or 1125) that corresponds to a first set of instructions that are executable by the computer system; and goal data (e.g., 1122) that represents a goal state of the 3D scene. The computer executable plan corresponds to a selected subset of (e.g., portion of) the first set of instructions that are executable by the computer system.

At block 1608, in accordance with a determination that a computer-executable plan is not generated (e.g., no computer-executable plan is generated) and/or in accordance with a determination that the computer-executable plan does not satisfy the first set of criteria, the computer system forgoes executing the computer-executable plan (e.g., forgoes executing any computer-executable plan that is generated by planning module 1118).

At block 1610, in accordance with a determination that the computer-executable plan is generated and in accordance with a determination that the computer-executable plan satisfies the first set of criteria, the computer system executes the computer-executable plan (e.g., as illustrated in FIGS. 13A-13B and 14A). Executing the computer-executable plan includes executing at least a portion of the selected subset of the first set of instructions that are executable by the computer system.

In some examples, method 1600 includes: after executing at least the portion of the selected subset of the first set of instructions (e.g., after the scene of FIG. 14A): detecting, via the one or more sensor devices, second data (e.g., 1102-1) different from the first data; and in response to detecting, via the one or more sensor devices, the second data and after an updated state of the 3D scene (e.g., 1116-1 and/or 1108-1) (e.g., the 3D scene of FIG. 14B) is determined (e.g., step 1204 of FIG. 12) based on the second data: in accordance with a determination that a second computer-executable plan (e.g., 1120-1) is generated and in accordance with a determination that the second computer-executable plan satisfies a second set of criteria, wherein the second computer-executable plan is based on the updated state of the 3D scene (e.g., 1116-1) and the goal data (e.g., 1122), executing at least a portion of the second computer executable plan (e.g., as illustrated in FIG. 14C). In some examples, the second computer executable plan (e.g., 1120-1) (e.g., as described with respect to FIGS. 14A-14C) corresponds to an update to the computer-executable plan (e.g., 1120) (e.g., as described with respect to FIGS. 14A-14C). In some examples, the second set of criteria include the same criteria as the first set of criteria. In some examples, the second computer-executable plan is generated further in accordance with a determination that the updated state of the 3D scene (e.g., 1116-1) does not match a predicted state of the 3D scene (e.g., 1140) (e.g., step 1206 of FIG. 12) (e.g., as described with respect to FIG. 14B).

In some examples, the one or more sensor devices include one or more image sensors; the first data (e.g., 1102) includes image data detected via the one or more image sensors; and the state of the 3D scene (e.g., 1116) is determined based on performing (e.g., by perception module 1106) a computer vision task on the image data.

In some examples, the one or more sensor devices include one or more audio sensors; the first data (e.g., 1102) includes audio data detected via the one or more audio sensors; and the state of the 3D scene (e.g., 1116) is determined based on performing (e.g., by perception module 1106) natural language processing on the audio data.

In some examples, the one or more sensor devices include one or more motion sensors; the first data (e.g., 1102) includes motion data detected via the one or more motion sensors; and the state of the 3D scene (e.g., 1116) is determined based on predicting (e.g., by perception module 1106), based on the motion data, a type of an activity that is performed by a user of the computer system.

In some examples, the goal state of the 3D scene corresponds to assisting a user of the computer system with an event that is detected (e.g., by event detection module 508) within the 3D scene.

In some examples, the state of the 3D scene (e.g., 1116) includes a natural language description of the 3D scene.

In some examples, the one or more sensor devices are a first set of one or more sensor devices, the computer system is in communication with a second set of one or more sensor devices (e.g., gaze sensors, position sensors, and/or orientation sensors), and method 1600 includes detecting, via the second set of one or more sensor devices, attention data (e.g., 1104) that represents an attention of a user of the computer system, wherein the state of the 3D scene (e.g., 1116 and/or 1108) is determined based on the attention data.

In some examples, the state of the 3D scene (e.g., 1116) includes a first set of context information (e.g., 1113 or 1110).

In some examples, the first set of context information (e.g., 1113 or 1110) includes information that is personal to a user of the computer system.

In some examples, the first set of context information (e.g., 1113 or 1110) includes information about a state of an electronic device (e.g., 101, 1300, and/or 1402).

In some examples, the state of the 3D scene (e.g., 1116) includes first state information (e.g., 1108) that is determined based on the first data (e.g., 1102) and the first set of context information (e.g., 1113) is selected (e.g., by context filtering module 1112) from a second set of context information (e.g., 1110) based on the first state information (e.g., 1108) and/or the goal data (e.g., 1122).

In some examples, the first action data (e.g., 1125) is selected (e.g., by action filtering module 1126) from second action data (e.g., 1124) that corresponds to a second set of instructions that are executable by the computer system and the first action data is selected from the second action data based on the state of the 3D scene (e.g., 1108 and/or 1116) and/or the goal data (e.g., 1122).

In some examples, the first action data (e.g., 1124 or 1125) specifies one or more preconditions respectively required to execute a first instruction of the first set of instructions that are executable by the computer system.

In some examples, the first action data (e.g., 1124 or 1125) specifies one or more predicted effects that respectively result from executing a second instruction of the first set of instructions that are executable by the computer system.

In some examples, the computer-executable plan (e.g., 1120) is generated based on an objective function (e.g., 1134) that corresponds to a computer-executable instruction to optimize a first parameter associated with the computer system.

In some examples, the computer-executable plan is generated based on a constraint (e.g., as represented by constraint data 1132) on a second parameter associated with the computer system.

In some examples, the computer-executable plan is generated (e.g., by planning module 1118) by prompting a large language model to solve an automated planning problem, wherein the automated planning problem is generated based on the state of the 3D scene (e.g., 1116 or 1108), the first action data (e.g., 1124 or 1125), and the goal data (e.g., 1122).

In some examples, the first set of criteria is satisfied when a determination is made (e.g., by symbolic planning module 1128) that the computer-executable plan (e.g., 1120) is valid with respect to achieving the goal state of the 3D scene.

In some examples, executing the computer-executable plan includes providing an output (e.g., 1304, 1306, and/or 1406) to a user of the computer system, wherein the output corresponds to an instruction to perform an action that the computer system cannot perform.

In some examples, executing the computer-executable plan includes causing an output (e.g., 1304, 1306, 1404, and/or 1406) to be provided to a user of the computer system.

In some examples, the computer-executable plan is executed without receiving a user request (e.g., a natural language input and/or another input received via a user interface of the computer system) that explicitly requests for assistance from the computer system.

FIG. 17 is a flow diagram of a method 1700 for changing a parameter of a sensor device, according to some examples. In some examples, method 1700 is performed at a computer system (e.g., computer system 101 in FIG. 1) that is in communication with one or more sensor devices (e.g., image sensors, light sensors, depth sensors, tactile sensors, orientation sensors, proximity sensors, temperature sensors, location sensors, motion sensors, velocity sensors, audio sensors, and/or biometric sensors). In some examples, method 1700 is governed by instructions that are stored in a non-transitory (or transitory) computer-readable storage medium and that are executed by one or more processors of a computer system, such as the one or more processors 302 of computer system 101 (e.g., controller 110 in FIG. 1). In some examples, the operations of method 1700 are distributed across multiple computer systems, e.g., a computer system and a separate server system. Some operations in method 1700 are, optionally, combined, the orders of some operations are, optionally, changed, and some operations are, optionally, omitted.

At block 1702, first data (e.g., 1102-1) is detected via the one or more sensor devices.

At block 1706, in response to (1704) detecting, via the one or more sensor devices, the first data and after (1704) a first state of a three-dimensional (3D) scene associated with the computer system (e.g., 1116-1 or 1108-1) is determined (e.g., step 1204 of FIG. 12) based on the first data: it is determined (e.g., by state matching module 1130) (e.g., step 1206 of FIG. 12) whether first state of the 3D scene (e.g., 1116-1 or 1108-1) matches a predicted state (e.g., 1140) of the 3D scene.

At block 1708, in accordance with a determination that the first state of the 3D scene matches the predicted state of the 3D scene, the computer system forgoes changing a parameter of a sensor device (e.g., any sensor device) that is in communication with the computer system.

At block 1710, in accordance with a determination that the first state of the 3D scene (e.g., 1116-1 or 1108-1) does not match the predicted state of the 3D scene (e.g., 1140), the computer system changes a parameter of a sensor device that is in communication with the computer system (e.g., step 1208 of FIG. 12) (e.g., as described with respect to FIG. 13B and 15B).

In some examples, changing the parameter of the sensor device that is in communication with the computer system includes changing a sampling rate of the sensor device that is in communication with the computer system.

In some examples, changing the parameter of the sensor device that is in communication with the computer system includes changing the sensor device from an inactive state to an active state, wherein the sensor device is not included in the one or more sensor devices.

In some examples, the sensor device is included in the one or more sensor devices.

In some examples, the one or more sensor devices include an audio sensor.

In some examples, the one or more sensor devices include a motion sensor.

In some examples, the one or more sensor devices include an image sensor.

In some examples, method 1700 further includes: while the parameter of the sensor device that is in communication with the computer system is changed, detecting, via at least the sensor device that is in communication with the computer system, second data (e.g., 1102-2) different from the first data (e.g., 1102-1) (e.g., step 1210 of FIG. 12), wherein a second state of the 3D scene (e.g., 1116-2 or 1108-2) is determined (e.g., step 1212 of FIG. 12) based on the second data (e.g., as described with respect to FIGS. 13B and 15B).

In some examples, the predicted state of the 3D scene (e.g., 1140) is based on execution, by the computer system, of an instruction.

In some examples, the instruction is included in a first computer-executable plan (e.g., 1120) (e.g., plan 1120 as described with respect to FIG. 13A or 15A); and the first computer-executable plan is generated based on: a third state of the 3D scene (e.g., 1116), wherein the third state of the 3D scene is determined before the first state of the 3D scene (e.g., 1116-1); goal data (e.g., 1122) that represents a goal state for the 3D scene; and first action data (e.g., 1124 or 1125) that corresponds to a first set of instructions that are executable by the computer system.

In some examples, the third state of the 3D scene (e.g., 1116) includes a first set of context information (e.g., 1110 or 1113).

In some examples, the first set of context information (e.g., 1113) is selected (e.g., by context filtering module 1112) from a second set of context information (e.g., 1110) (e.g., the most recent context information) and the second state of the 3D scene (e.g., 1116-2) is determined based on selecting (e.g., by context filtering module 1112) a third set of context information (e.g., 1113-2) from the second set of context information (e.g., 1110, 1110-1, or 1110-2) (e.g., step 1212 of FIG. 12B).

In some examples, the first action data (e.g., 1125) is selected (e.g., by action filtering module 1126) from second action data (e.g., 1124) that corresponds to a second set of instructions that are executable by the computer system; and in accordance with the determination that the second state of the 3D scene (e.g., 1116-2 or 1108-2) does not match the predicted state of the 3D scene (e.g., 1140) (e.g., step 1214 of FIG. 12), third action data (e.g., 1125-1) is selected (e.g., by action filtering module 1126) from the second action data (e.g., 1124) (e.g., step 1216 of FIG. 12), wherein the third action data corresponds to a third set of instructions that are executable by the computer system.

In some examples, in accordance with a determination that the second state of the 3D scene (e.g., 1116-2 or 1108-2) does not match the predicted state of the 3D scene (e.g., 1140) (e.g., step 1214 of FIG. 12), a second computer-executable plan (e.g., 1120-1 as described with respect to FIG. 15B) is generated (e.g., by planning module 1118) (e.g., step 1218 of FIG. 12) based on: the second state of the 3D scene (e.g., 1116-2 or 1108-2); the goal data (e.g., 1122); and fourth action data (e.g., 1124 or 1125-1) that corresponds to a fourth set of instructions that are executable by the computer system.

In some examples, the predicted state of the 3D scene (e.g., 1140) corresponds to a prediction that a previous state of the 3D scene (e.g., 1116) will be maintained (e.g., as described with respect to FIG. 15A).

In some examples, the first state of the 3D scene (e.g., 1116-1) includes a first natural language description of the 3D scene and the predicted state of the 3D scene (e.g., 1140) includes a second natural language description of the 3D scene.

In some examples, the first state of the 3D scene (e.g., 1116-1) is defined by a first set of one or more respective values for one or more parameters of the 3D scene; the predicted state of the 3D scene (e.g., 1140) is defined by a second set of one or more respective values for the one or more parameters of the 3D scene; and the determination (e.g., by state matching module 1130) (e.g., step 1206 of FIG. 12) that the first state of the 3D scene does not match the predicted state of the 3D scene includes a determination that the first set of one or more respective values does not match the second set of one or more respective values.

In some examples, a large language model is prompted to make the determination (e.g., by state matching module 1130) (e.g., step 1206 of FIG. 12) that the first state of the 3D scene (e.g., 1116-1) does not match the predicted state of the 3D scene (e.g., 1140).

In some examples, aspects/operations of methods 1600 and 1700 may be interchanged, substituted, and/or added between these methods. For example, the predicted state of the 3D scene (e.g., 1140) of method 1700 can result from the execution of the computer-executable plan (e.g., 1120) (e.g., 1610) of method 1600. For brevity, further details are not repeated here.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from various sources to provide assistance with events that occur in three-dimensional scenes. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to provide suggestions and/or instructions to assist the user. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of providing assistance with events that occur in three-dimensional scenes, the present technology can be configured to allow users to select to “opt in” or “opt out” of participation in the collection of personal information data during registration for services or anytime thereafter. In another example, users can select not to provide data based on which events are detected and/or based on which assistive actions are determined. In yet another example, users can select to limit the length of time for which such data is maintained. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, assistance can be provided based on non-personal information data or a bare minimum amount of personal information, such as the content being requested by the device associated with a user, other non-personal information available to the service, or publicly available information.

What is claimed is:

1. A computer system configured to communicate with one or more sensor devices, the computer system comprising:
one or more processors; and
memory storing one or more programs configured to be executed by the one or more processors, the one or more programs including instructions for:
while the computer system is present within a first scene, detecting a first gaze of a user of the computer system;
after a determination of semantic information about the first scene based on the detected first gaze of the user and while the computer system is present within a second scene, detecting, via the one or more sensor devices, data corresponding to the second scene; and
in response to detecting, via the one or more sensor devices, the data corresponding to the second scene:
in accordance with a determination that an event that occurs in the second scene is detected based on the data corresponding to the second scene and that the event satisfies a set of one or more event criteria, performing a set of one or more actions that correspond to assisting the user with the event, wherein a first action of the set of one or more actions is based on the semantic information about the first scene.

2. The computer system of claim 1, wherein the first scene and the second scene are at a same location.

3. The computer system of claim 1, wherein the first scene is different from the second scene.

4. The computer system of claim 1, wherein the semantic information about the first scene includes a description of the first scene, an identity of a first object that is present in the first scene, a state of the first object, and/or a location of the first object.

5. The computer system of claim 1, wherein the set of one or more event criteria include a first criterion that is satisfied when the data corresponding to the second scene indicate a threshold amount of change to the second scene.

6. The computer system of claim 1, wherein the set of one or more event criteria include a second criterion that is satisfied when a task corresponding to the event is new to the user of the computer system.

7. The computer system of claim 1, wherein:
the one or more sensor devices include an image sensor;
the data corresponding to the second scene include image data detected via the image sensor; and
the event that occurs in the second scene is detected based on information corresponding to understanding of the second scene that is determined based on the image data detected via the image sensor.

8. The computer system of claim 7, wherein:
detecting, via the one or more sensor devices, the data corresponding to the second scene includes detecting a second gaze of the user; and
the information corresponding to understanding of the second scene is further determined based on the detected second gaze of the user.

9. The computer system of claim 1, wherein:
the one or more sensor devices include an audio sensor;
the data corresponding to the second scene include audio data detected via the audio sensor; and
the event that occurs in the second scene is detected based on the audio data.

10. The computer system of claim 1, wherein the event that occurs in the second scene is further detected based on context information associated with the second scene.

11. The computer system of claim 10, wherein the context information associated with the second scene includes information that indicates a state of a first device external to the computer system.

12. The computer system of claim 10, wherein the context information associated with the second scene includes information that is received from a second device external to the computer system and/or information that is received from a service external to the computer system.

13. The computer system of claim 1, wherein the context information associated with the second scene includes personal information of the user of the computer system.

14. The computer system of claim 1, wherein the event that occurs in the second scene is detected by:
processing the data corresponding to the second scene to obtain a semantic description of the second scene; and
inputting a representation of the semantic description of the second scene into a large language model, wherein the large language model outputs a representation of the event based on the representation of the semantic description of the second scene.

15. The computer system of claim 1, wherein:
the event that occurs in the second scene is detected without requiring the computer system to receive natural language input that describes the event; and
the set of one or more actions is performed without requiring the computer system to receive the natural language input that describes the event.

16. The computer system of claim 1, wherein performing the set of one or more actions that correspond to assisting the user with the event includes controlling a third device external to the computer system.

17. The computer system of claim 1, wherein performing the set of one or more actions that correspond to assisting the user with the event includes providing a first suggestion related to the event.

18. The computer system of claim 1, wherein the one or more programs further include instructions for:
while the computer system is present within a third scene:
detecting, via the one or more sensor devices, image data corresponding to the third scene;
detecting a third gaze of the user; and
providing a second suggestion related to the event, wherein the second suggestion is determined based on the image data corresponding to the third scene and the third gaze of the user.

19. The computer system of claim 18, wherein the second suggestion related to the event corresponds to a first step for assisting the user with the event, and wherein the one or more programs further include instructions for:
in accordance with a determination, based on the image data corresponding to the third scene, that the user has completed the first step, providing a third suggestion related to the event, wherein the third suggestion corresponds to a next step for assisting the user with the event; and
in accordance with a determination, based on the image data corresponding to the third scene, that the user has not completed the first step, forgoing providing the third suggestion related to the event.

20. The computer system of claim 1, wherein the one or more programs further include instructions for:
after the event that satisfies the set of one or more event criteria is detected, detecting, via the one or more sensor devices, data corresponding to an action performed by the user of the computer system; and
in accordance with a determination that the action performed by the user of the computer system is incorrect with respect to the event, providing a fourth suggestion that corresponds to a correction of the action performed by the user of the computer system.

21. The computer system of claim 1, wherein performing the set of one or more actions that correspond to assisting the user with the event includes providing a notification associated with the event.

22. The computer system of claim 1, wherein:
performing the set of one or more actions that correspond to assisting the user with the event includes monitoring a status of a second object that is present within the second scene.

23. The computer system of claim 1, wherein performing the first action includes providing an output that indicates the location of a third object, wherein the semantic information about the first scene identifies the third object.

24. The computer system of claim 1, wherein the one or more programs further include instructions for:
before the occurrence of the event that satisfies the set of one or more event criteria in the second scene:
initiating a semantic information enrollment process, wherein the semantic information about the first scene is obtained during the semantic information enrollment process.

25. The computer system of claim 1, wherein:
before the event that occurs in the second scene and that satisfies the set of one or more event criteria is detected, an artificial intelligence system configured to generate the set of one or more actions that correspond to assisting the user with the event has first state; and
in accordance with a determination that the event that occurs in the second scene is detected based on the data corresponding to the second scene and that the event satisfies the set of one or more event criteria, the artificial intelligence system changes to have a second state that represents the event, wherein the second state is different from the first state.

26. The computer system of claim 25, wherein the one or more programs further include instructions for:
after the event that occurs in the second scene and that satisfies the set of one or more event criteria is detected:
while the computer system is present within a fourth scene, detecting, via the one or more sensor devices, data corresponding to the fourth scene; and
in response to detecting, via the one or more sensor devices, the data corresponding to the fourth scene:
in accordance with a determination that a sub-event of the event is detected based on the data corresponding to the fourth scene and that the sub-event satisfies a set of one or more sub-event criteria, performing a set of one or more actions that correspond to assisting the user with the sub-event.

27. The computer system of claim 26, wherein:
before the sub-event that satisfies the set of one or more sub-event criteria is detected, the artificial intelligence system has the second state that represents the event; and
in accordance with a determination that the sub-event is detected based on the data corresponding to the fourth scene and that the sub-event satisfies the set of one or more sub-event criteria, the artificial intelligence system changes to have a third state that represents the event and the sub-event, wherein the third state is different from the first state and the second state.

28. The computer system of claim 1, wherein the event that occurs in the second scene and that satisfies the set of one or more event criteria includes an emergency event.

29. The computer system of claim 1, wherein the event that occurs in the second scene and that satisfies the set of one or more event criteria corresponds to assistance with a physical task.

30. A non-transitory computer-readable storage medium storing one or more programs configured to be executed by one or more processors of a computer system that is in communication with one or more sensor devices, the one or more programs including instructions for:
while the computer system is present within a first scene, detecting a first gaze of a user of the computer system;
after a determination of semantic information about the first scene based on the detected first gaze of the user and while the computer system is present within a second scene, detecting, via the one or more sensor devices, data corresponding to the second scene; and
in response to detecting, via the one or more sensor devices, the data corresponding to the second scene:
in accordance with a determination that an event that occurs in the second scene is detected based on the data corresponding to the second scene and that the event satisfies a set of one or more event criteria, performing a set of one or more actions that correspond to assisting the user with the event, wherein a first action of the set of one or more actions is based on the semantic information about the first scene.

31. A method, comprising:
at a computer system that is in communication with one or more sensor devices:
while the computer system is present within a first scene, detecting a first gaze of a user of the computer system;
after a determination of semantic information about the first scene based on the detected first gaze of the user and while the computer system is present within a second scene, detecting, via the one or more sensor devices, data corresponding to the second scene; and
in response to detecting, via the one or more sensor devices, the data corresponding to the second scene:
in accordance with a determination that an event that occurs in the second scene is detected based on the data corresponding to the second scene and that the event satisfies a set of one or more event criteria, performing a set of one or more actions that correspond to assisting the user with the event, wherein a first action of the set of one or more actions is based on the semantic information about the first scene.
